(19) United States
(12) Patent Application Publication
(10) Pub. No.: US 2025/0025005 A1
(43) Pub. Date: Jan. 23, 2025

(54) SURFACE CLEANING APPARATUS

(71) Applicant: Omachron Intellectual Property Inc., Hampton (CA)

(72) Inventor: WAYNE ERNEST CONRAD, Hampton (CA)

(21) Appl. No.: 18/907,017

(22) Filed: Oct. 4, 2024

Related U.S. Application Data
(63) Continuation-in-part of application No. 18/084,740, filed on Dec. 20, 2022.
(63) Continuation-in-part of application No. 18/372,999, filed on Sep. 26, 2023.
Application No. 18/372,999 is a continuation-in-part of application No. 17/988,866, filed on Nov. 17, 2022.
Application No. 17/988,866 is a continuation of application No. 16/818,438, filed on Mar. 13, 2020, now Pat. No. 11,529,033.
(60) Provisional application No. 63/532,614, filed on Aug. 14, 2023.
(60) Provisional application No. 62/825,148, filed on Mar. 28, 2019.
(60) Provisional application No. 62/818,856, filed on Mar. 15, 2019.

(51) Int. Cl. A47L 9/14; A47L 5/24; A47L 9/12; A47L 9/16; A47L 9/20

(52) U.S. Cl. CPC A47L 9/149; A47L 5/24; A47L 9/12; A47L 9/1608; A47L 9/20

(57) ABSTRACT

A surface cleaning apparatus is operable in a surface cleaning mode and an evacuation mode. A valve assembly is operable to adjust the air flow between a surface cleaning mode air flow path and an evacuation air flow path. The surface cleaning apparatus is operable in a surface cleaning mode wherein air travels from a dirty air inlet, through a downstream port to a clean air outlet and, when the surface cleaning apparatus is docked at a docking station, the surface cleaning apparatus is also operable in an evacuation mode wherein air enters through an ambient air inlet port, travels through the docking station and subsequently enters the surface cleaning apparatus through a docking station return air inlet port.

### CROSS REFERENCE TO RELATED APPLICATIONS

This application is a continuation-in-part of U.S. patent application Ser. No. 18/084,740, filed Dec. 20, 2022. This application is also a continuation-in-part of U.S. patent application Ser. No. 18/372,999, filed Sep. 26, 2023, which itself is a continuation in part of U.S. patent application Ser. No. 17/988,866, filed Nov. 17, 2022, which itself is a continuation of U.S. patent application Ser. No. 16/818,438, filed Mar. 13, 2020 and issued as U.S. Pat. No. 11,529,033 on Dec. 20, 2022, which itself claims the benefit of United States Provisional Patent Application No. 62/825,148, filed Mar. 28, 2019. The disclosures of which are hereby incorporated by reference in their entirety.

### FIELD

This disclosure relates generally to surface cleaning apparatus. In a preferred embodiment, the surface cleaning apparatus comprises a portable surface cleaning apparatus, such as a hand vacuum cleaner.

### INTRODUCTION

The following is not an admission that anything discussed below is part of the prior art or part of the common general knowledge of a person skilled in the art.

Various types of surface cleaning apparatus are known, including upright surface cleaning apparatus, canister surface cleaning apparatus, stick surface cleaning apparatus, central vacuum systems, and hand carriable surface cleaning apparatus such as hand vacuum cleaners. Further, various designs for cyclonic surface cleaning apparatus, including battery operated cyclonic hand vacuum cleaners are known in the art.

### SUMMARY

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

A surface cleaning apparatus includes a cleaning air flow path between a dirty air inlet and a clean air outlet. An air moving member, e.g., a motor and fan assembly or a PL turbine, is arranged in the cleaning air flow path to move air through the air flow path. An air treatment member, which comprises an air treatment chamber, is provided in the cleaning air flow path. An air outlet from an air treatment chamber may include a porous member, e.g., a screen, through which the cleaning air flow path extends. A dirt collection region, comprising a region within the air treatment chamber and/or a discrete dirt collection chamber, is also provided.

The surface cleaning apparatus may include an evacuation air flow path between an evacuation air inlet and an evacuation air outlet. The dirt collection region is provided in the evacuation air flow path to be evacuated by an air flow through the evacuation air flow path. The evacuation air flow path may be a reversed direction along the entire length of the cleaning air flow path. Alternatively, the evacuation air flow path may extend along one or more portions of the cleaning air flow path (e.g., through the air treatment chamber) and may include at least in part a different air flow direction, with one or more other portions of the cleaning air flow path bypassed. Alternatively, the evacuation air flow path may be discrete from the cleaning air flow path.

A dock may be provided for the surface cleaning apparatus. The dock includes a dock air flow path extending between a dock air inlet and a dock air outlet. The evacuation air flow path may include the dock air flow path. An air treatment member is provided in the dock air flow path. A dirt collection region, comprising a region within the air treatment chamber of the dock and/or a discrete dirt collection chamber, is also provided in the dock. In use, the surface cleaning apparatus is placed in the dock for evacuation. Optionally, on board energy storage members of the surface cleaning apparatus may also be charged when placed in the dock.

During an emptying mode of operation when the surface cleaning apparatus is placed in the dock, the evacuation air outlet of the surface cleaning apparatus is in air flow communication with the dock air inlet, optionally in direct air flow communication with the dock air inlet (e.g., with the evacuation air outlet directly adjacent or inserted into the dock air inlet). Optionally, the connection between the surface cleaning apparatus and the dock is a closed connection (e.g., an air-tight or substantially air-tight connection). In some examples, the air moving member of the surface cleaning apparatus can be used to move air through the evacuation air flow path of the surface cleaning apparatus. The air moving member of the surface cleaning apparatus may be, e.g., the fan may be rotating in a reverse direction or rotation compared to the direction of rotation of the fan during a cleaning mode of operation or the fan may be rotating in the same direction as during the cleaning mode of operation but with one or more portions of the air flow path in the surface cleaning apparatus reconfigured from the cleaning mode configuration to reverse the air flow direction through an air treatment member. Alternatively, or additionally, the dock may include an air moving member to move air through the evacuation air flow path of the surface cleaning apparatus by drawing air from the dock air flow path while the evacuation air flow path of the surface cleaning apparatus is in air flow communication with the dock air flow path.

In accordance with an aspect of this disclosure, which may be used alone or in combination with any one or more other aspects, the surface cleaning apparatus includes a filter, e.g., a pre-motor filter. The filter includes a body of filter media extending between a first end and a second end along a filter axis. The body of filter media surrounds a central cavity (e.g., an annular or donut filter). The body of filter media may be, e.g., a cylindrical or frusto-conical body of filter media surrounding the central cavity. The filter media may be supported by a filter media holder. The filter media holder is shaped such that it does not overly the filter media in a direction of airflow through the filter media (e.g., radially inwardly or radially outwardly). The media holder or a portion thereof may be at one or both ends of the filter media with the filter media extending generally axially from the media support or portion thereof, with an airflow direction generally transverse to the axis along which the media extends. In some embodiments, the filter is a donut filter and the direction of airflow through the filter media is a radial direction, and the filter media is radially open (e.g., the radial inner centre is open and functions as an air inlet or air outlet of the filter media. The media holder may support one or both ends of the donut filter without radially overlying the filter media at one or both ends.

In accordance with this aspect, there is provided a surface cleaning apparatus comprising:
(a) an air flow path extending from a dirty air inlet to a clean air outlet with a suction motor and an air treatment member provided in the air flow path; and,
(b) a filter housing which, in operation of the surface cleaning apparatus, houses a filter, wherein the filter comprises a pleated porous filter media having a first end located at a first end member and a second axially opposed end at a second end member, the pleated filter media extends axially inwardly from the first end member towards the second end member and the pleated filter media also extends axially inwardly from the second end member towards the first end member, the radial outer surface of the pleated porous filter media has a plurality of generally axially extending recesses positioned between opposed generally axially extending sidewalls and, at the position of the first end member, the generally axially extending recesses are radially open.

In accordance with another aspect of this disclosure, which may be used alone or in combination with any one or more other aspects, the filter is a donut filter received in a filter housing during a surface cleaning use. The filter housing provided to house the donut filter is shaped to provide a minimum radial clearance between the radially outer face of the filter media of the donut filter and a directly overlying wall of the housing at the end nearest to a filter axial opening. A minimum radial clearance at the end nearest the filter axial opening encourages an evacuation (reverse) air flow through the end nearest to the filter axial opening by reducing backpressure on the downstream side of the filter.

In accordance with another aspect of this disclosure, which may be used alone or in combination with any one or more other aspects, the air treatment chamber air outlet comprises a porous member that is selectively openable to allow air to bypass the porous member during part or all of an evacuation mode of operation. The selectively openable outlet is closed in one mode of operation to force air to pass through the porous member, and opened in another mode of operation to reduce backpressure on airflow by allowing the air to bypass the porous member. The selectively openable outlet may be closed in a surface cleaning mode and open during part or all of an evacuation mode. For example, the selectively openable outlet may be closed in a surface cleaning mode, closed in a first evacuation mode (e.g., to force air backwards through the porous member), and open in a second evacuation mode to enable some or all of the air to bypass the porous member. The second evacuation mode may follow a time delay and/or include different air flow characteristics (e.g., velocity) from the first evacuation mode.

In accordance with this aspect, there is provided a surface cleaning apparatus comprising:
(a) an air flow path extending from a dirty air inlet to a clean air outlet with a suction motor provided in the air flow path; and,
(b) an air treatment member provided in the air flow path, the air treatment member comprising an air treatment chamber having an air treatment chamber air inlet and an air treatment chamber air outlet, the air treatment chamber air outlet comprising a porous member having an openable portion,
wherein the surface cleaning apparatus is operable in a surface cleaning mode in which air is drawn into the air treatment chamber through the air treatment chamber air inlet and air exits the air treatment chamber through the air treatment chamber air outlet, and
wherein the surface cleaning apparatus is operable in an evacuation mode in which air is drawn into the air treatment chamber through the air treatment chamber air outlet and dirt is evacuated from the air treatment chamber through an evacuation door, and
wherein, in the surface cleaning mode, the openable portion of the porous member is in a closed position and, in the evacuation mode, the air flow entering the air treatment chamber through the porous member moves the openable portion to an open position.

In accordance with this aspect, there is also provided a surface cleaning apparatus comprising:
(a) an air flow path extending from a dirty air inlet to a clean air outlet with a suction motor provided in the air flow path; and,
(b) an air treatment member provided in the air flow path, the air treatment member comprising an air treatment chamber having an air treatment chamber air inlet and an air treatment chamber air outlet, the air treatment chamber air outlet comprising a porous member having an openable portion,
wherein the surface cleaning apparatus is operable in a surface cleaning mode in which air is drawn into the air treatment chamber through the air treatment chamber air inlet and air exits the air treatment chamber through the air treatment chamber air outlet, and
wherein the surface cleaning apparatus is operable in an evacuation mode in which air is drawn into the air treatment chamber through the air treatment chamber air outlet and dirt is evacuated from the air treatment chamber through an evacuation door, and
wherein, in the surface cleaning mode, the openable portion of the porous member is in a closed position and, in the evacuation mode, the openable portion is in an open position.

In accordance with another aspect of this disclosure, which may be used alone or in combination with any one or more other aspects, the filter (or an outlet screen of an air treatment chamber, such as a vortex finder with a screen covering the inlet of the vortex finder) includes a central cavity and is configured such that during an evacuation mode of operation, air is directed towards part or all of the downstream surface (in a cleaning mode of operation) of the filter media that surrounds the central cavity. Optionally, some or all of the air travelling, e.g., from the motor to or towards the open end of the central cavity (which is the air outlet end of the central cavity in the cleaning mode of operation) is directed towards a portion of the upstream surface of the filter media or screen. Accordingly, if the filter media has an axial length, air travelling to or towards the open end of the central cavity is directed towards a portion of the filter media that comprises 25%, 35% or 50% of the axial length measured from the open end. Accordingly, in an evacuation mode of operation, a directing member may be located partially or fully in the central cavity. The directing member encourages an evacuation air flow out the end of the body of filter media nearest the open end of the filter. The directing member may be supported by one or both of a first end cap or a second end cap, which may be located at axially opposed ends of the filter media. The directing member may include one or more baffles and/or vanes. The directing member may restrict or direct air flow through some or all of the central cavity thereby directing or encouraging air to flow radially outwardly to and through the filter media. Optionally, the directing member restricts the axial air flow area through the central cavity at, e.g., a choke point between the first end and the second axially opposed end of the filter media to encourage some or all of the air flow during an evacuation mode of operation to exit the internal cavity through the filter media upstream of the choke point. Optionally, the directing member includes a transverse wall blocking the internal cavity between the first end and the second end to require the evacuation air to exit the internal cavity upstream of the transverse wall. Optionally, the directing member includes an angled surface angled relative to the filter axis and arranged between the first and second ends to direct the evacuation air flow along a cyclonic path within the internal cavity downstream of the angled surface. Optionally, the directing member in the central cavity includes an obstruction body in the internal cavity occupying a volume of the internal cavity to reduce the free volume of the internal cavity available for evacuation air flow. The obstruction body occupies a first volume of a first segment of the internal cavity and a second, lesser, volume of a second segment of the internal cavity spaced from the first segment towards the second end, to reduce the cross-sectional air flow area in a direction transverse to the axial direction of the central cavity in the first segment relative to the second segment to direct or encourage air to exit the internal cavity through the filter media upstream of the first segment. Optionally, the obstruction body is secured to the first end cap and extends into the internal cavity from the first end.

In accordance with this aspect, there is provided a surface cleaning apparatus comprising:
(a) an air flow path extending from a dirty air inlet to a clean air outlet with a suction motor provided in the air flow path;
(b) an air treatment member provided in the air flow path, the air treatment member comprising an air treatment chamber having an air treatment chamber air inlet and an air treatment chamber air outlet, the air treatment chamber air outlet comprising a porous member; and,
(c) in operation, a pre-motor filter media having an open interior,
wherein the surface cleaning apparatus is operable in a surface cleaning mode in which air is drawn into the air treatment chamber through the air treatment chamber air inlet, air exits the air treatment chamber through the air treatment chamber air outlet and then air passes generally inwardly through the filter media to the open interior of the filter media and then generally axially out a radial inner opening of the filter media, and
wherein the surface cleaning apparatus is operable in an evacuation mode in which air is drawn into the air treatment chamber through the air treatment chamber air outlet and dirt is evacuated from the air treatment chamber through an evacuation door, and wherein, in the evacuation mode, a directing member directs at least some of the air flow entering the open interior of the filter media outwardly through the filter media.

In accordance with another aspect of this disclosure, which may be used alone or in combination with any one or more other aspects, a horizontally extending member with a generally radially directed dirt bearing surface is rotatable. The horizontally extending member may be, e.g., the porous member of the air treatment chamber air outlet and/or a filter (e.g., a donut filter). The horizontally extending member is rotatable about a generally horizontal axis during part or all of an evacuation operation. Rotating the porous member ensures that all surfaces of the porous member which form upstream surfaces during a cleaning operation (i.e., outside surfaces) are downward facing at some point during the evacuation operation to allow a gravitational assist to remove dirt from the surfaces.

In accordance with this aspect, there is provided a surface cleaning apparatus comprising:
(a) an air flow path extending from a dirty air inlet to a clean air outlet with a suction motor provided in the air flow path; and,
(b) an air treatment member provided in the air flow path, the air treatment member comprising an air treatment chamber having a first end, a second end, an air treatment chamber axis that extends through a central portion of the air treatment chamber from the first end to the second end, an air treatment chamber air inlet and an air treatment chamber air outlet at an outlet end of the air treatment member, the air treatment chamber air outlet comprising a porous member that extends axially into the air treatment chamber from the outlet end of the air treatment member,
wherein the surface cleaning apparatus is operable in a surface cleaning mode in which air is drawn into the air treatment chamber through the air treatment chamber air inlet, air exits the air treatment chamber through the air treatment chamber air outlet, and
wherein the surface cleaning apparatus is operable in an evacuation mode in which air is drawn into the air treatment chamber through the air treatment chamber air outlet and dirt is evacuated from the air treatment chamber through an evacuation door, and
   wherein, during at least a portion of the evacuation mode, the porous member is rotated about the air treatment chamber axis.

In accordance with this aspect, there is also provided a surface cleaning apparatus comprising:
(a) an air flow path extending from a dirty air inlet to a clean air outlet with a suction motor provided in the air flow path; and,
(b) comprising an air treatment chamber having a first end, a second end, an air treatment chamber axis that extends through a central portion of the air treatment chamber from the first end to the second end, an air treatment chamber air inlet and an air treatment chamber air outlet at an outlet end of the air treatment member, the air treatment chamber air outlet comprising a porous member that extends axially into the air treatment chamber from the outlet end of the air treatment member; and,
(c) in operation, a pre-motor filter media having an open interior,
wherein the surface cleaning apparatus is operable in a surface cleaning mode in which air is drawn into the air treatment chamber through the air treatment chamber air inlet, air exits the air treatment chamber through the air treatment chamber air outlet and then air passes generally inwardly through the filter media to the open interior of the filter media and then generally axially out a radial inner opening of the filter media, and
wherein the surface cleaning apparatus is operable in an evacuation mode in which air is drawn into the air treatment chamber through the air treatment chamber air outlet and dirt is evacuated from the air treatment chamber through an evacuation door, and
wherein, during at least a portion of the evacuation mode, the pre-motor filter is rotated about the air treatment chamber axis. In accordance with another aspect of this disclosure, which may be used alone or in combination with any one or more other aspects, the surface cleaning apparatus is selectively operable in a plurality of modes wherein different volume levels of air flow per unit time or velocity of air flow may be desired, e.g., hard floor, low pile carpet, high pile carpet, above floor cleaning with a wand or a wand and hose and the surface cleaning apparatus includes a bleed valve responsive to the mode selection. For example, the bleed may allow bleed air or more bleed air into the air flow path through the surface cleaning apparatus when the surface cleaning apparatus, e.g., a surface cleaning head, is used to clean carpet than when used to clean hard floor, and may allow in more bleed air when used to clean high pile carpet than when used to clean low pile carpet. The bleed valve is moveable between a plurality of positions including a first position when the surface cleaning operation is in a first mode and a second position when the surface cleaning operation is in a second mode, the second position is more open than the first position to allow in more bleed air. Optionally, the first position is a closed position and the second position is an open position. Alternatively, the first position is a first open position and the second position is a second open position, which is more open than the first open position. Optionally, the bleed valve includes a first position (e.g., a position in which is fully open or open the most) for a hard floor mode, a second position (e.g., in which it is partially open but not as open as in the first mode) for a low pile carpet mode, and a third position (e.g., in which it is partially open but not as open as in the second mode or closed) for a high pile carpet mode. Optionally, the bleed valve is in the nozzle of the surface cleaning apparatus. Adjusting the bleed between modes may reduce the need to adjust the suction motor between modes. Optionally, the suction motor is not adjusted between modes. Accordingly, as the surface being cleaned may partially block the dirty air inlet, e.g., in a surface cleaning head, (e.g., a carpet may cover or being drawn into the dirty air inlet) the load on the suction motor to maintain the same airflow may be increased. This may cause the motor to overheat. Allowing in bleed air will increase the air flow through the suction motor thereby reducing the load on the suction motor.

In accordance with this aspect, there is provided a surface cleaning apparatus comprising:
(a) an air flow path extending from a dirty air inlet to a clean air outlet with a motor and fan assembly and an air treatment member provided in the air flow path;
(b) a surface cleaning head having an air flow path extending from a dirty air inlet to a surface cleaning head air outlet with a brush associated with the dirty air inlet; and,
(c) a bleed valve having a bleed valve air inlet and a bleed valve air outlet,
wherein, in operation, the bleed valve is automatically adjusted between a first low flow mode and a high flow mode based on the type of surface being cleaned.

In accordance with another aspect of this disclosure, which may be used alone or in combination with any one or more other aspects, the air flow path of the surface cleaning apparatus is reconfigurable between a cleaning mode and an evacuation mode. In the cleaning mode, the cleaning air flow path is open between the air treatment member and the air moving member (a motor and fan assembly such as a suction motor) through the surface cleaning apparatus. In the cleaning mode, the cleaning air flow path extends through the surface cleaning apparatus from the dirty air inlet through the air treatment member and the air moving member to the clean air outlet. In the evacuation mode, the cleaning air flow path is closed between the air treatment member and the air moving member within the surface cleaning apparatus, and the evacuation air flow path includes a first portion extending from an evacuation air flow path air inlet, through the air treatment chamber to a docking station air inlet and a second portion extending from an outlet of the docking station to an evacuation air flow path return air inlet, through the air moving member to, e.g., the clean air outlet of the surface cleaning apparatus. In use, in the evacuation mode, the surface cleaning apparatus is in the dock and the dock air flow path joins the evacuation air flow path and the suction air flow path such that the air moving member can move air through the first portion of the evacuation air flow path and then to the second portion to and through the air moving member. A valve is operable to selectively open and close the evacuation air flow path air inlet and the evacuation air flow path return air inlet. Optionally, a single valve member may be used or a linking member may be coupled to each of the evacuation air flow path air inlet and the evacuation air flow path return air inlet wherein when one of the evacuation air flow path air inlet and the evacuation air flow path return air inlet moves from an open to a closed portion, the other concurrently moves from the closed to the open position.

In accordance with this aspect, there is provided a surface cleaning apparatus comprising:
(a) a surface cleaning mode air flow path extending from a dirty air inlet to a clean air outlet with a suction motor and an air treatment member provided in the air flow path, wherein the surface cleaning mode air flow path comprises a downstream portion that extends from the air treatment member to the suction motor, the downstream portion including a downstream port;
(b) an evacuation air flow path comprising a first portion extending from an ambient air inlet port to an evacuation air outlet and a second portion extending from a docking station return air inlet port to the clean air outlet; and,
(c) a valve assembly operable to concurrently open the ambient air inlet port and the docking station return air inlet port and also concurrently close the downstream port, the valve assembly comprising a first valve member that is moveable between a first valve member surface cleaning mode position in which the first valve member closes the docking station return air inlet port and the downstream port is open and a first valve member evacuation mode position in which the first valve member closes the downstream port and the docking station return air inlet port is open,
wherein the surface cleaning apparatus is operable in a surface cleaning mode wherein air travels from the dirty air inlet, through the downstream port to the clean air outlet, and,
wherein, when the surface cleaning apparatus is docked at a docking station, the surface cleaning apparatus is operable in an evacuation mode wherein air enters through the ambient air inlet port, travels through the docking station and subsequently enters the surface cleaning apparatus through the docking station return air inlet port.

In accordance with this aspect, there is also provided a surface cleaning apparatus comprising:
(a) a surface cleaning mode air flow path extending from a dirty air inlet to a clean air outlet with a suction motor and an air treatment member provided in the air flow path, wherein the surface cleaning mode air flow path comprises a downstream portion that extends from the air treatment member to the suction motor;
(b) an evacuation air flow path comprising a first portion extending from an ambient air inlet port to an evacuation air outlet and a second portion extending from a docking station return air inlet port to the clean air outlet; and,
(c) a valve assembly operable to concurrently open an ambient air inlet port and a docking station return air inlet port, the valve assembly comprising:
(i) a first valve member the is moveable between a surface cleaning mode position in which the docking station return air inlet port is closed and an evacuation mode position in which the docking station return air inlet port is open; and,
(ii) a second valve member that is moveable between a surface cleaning mode position in which the ambient air inlet port is closed and an evacuation mode position in which the ambient air inlet port is open,
wherein, in operation, when the ambient air inlet port is closed and the docking station return air inlet port is closed and air is travelling through a section of the downstream portion which includes the valve assembly, air flows in a direction through the section and a plane that is transverse to the direction extends through the first valve member and the second valve member.

In accordance with this aspect, there is also provided a surface cleaning apparatus comprising:
(a) a surface cleaning mode air flow path extending from a dirty air inlet to a clean air outlet with a suction motor and an air treatment member provided in the air flow path, wherein the surface cleaning mode air flow path comprises a downstream portion that extends from the air treatment member to the suction motor;
(b) an evacuation air flow path comprising a first portion extending from an ambient air inlet port to an evacuation air outlet and a second portion extending from a docking station return air inlet port to the clean air outlet; and,
(c) a valve assembly operable to concurrently open an ambient air inlet port and a docking station return air inlet port, the valve assembly comprising:
(i) a first valve member that is moveable between a surface cleaning mode position in which the docking station return air inlet port is closed and an evacuation mode position in which the docking station return air inlet port is open; and,
(ii) a second valve member that is moveable between a surface cleaning mode position in which the ambient air inlet port is closed and an evacuation mode position in which the ambient air inlet port is open,
wherein each of the first and second valve members is pivotally mounted to the surface cleaning apparatus, the first valve member pivots in an opening direction when the first valve member moves from the first valve member surface cleaning mode position to the first valve member evacuation mode position, and the second valve member moves in a direction common with the opening direction when the second valve member moves from the second valve member surface cleaning mode position to the second valve member evacuation mode position.

In accordance with another aspect of this disclosure, which may be used alone or in combination with any one or more other aspects, an evacuation outlet (e.g., door) of the surface cleaning apparatus is held closed by a lock which is moved from the locked position to the unlocked position by a portion of the dock impinging on an actuator when the surface cleaning apparatus is docked. The dock moves the actuator rearwardly when the surface cleaning apparatus is docked. The actuator may be operably coupled to a locking member via a mechanical linkage which moves rearwardly between the locked and unlocked positions. The actuator may be on a side of the surface cleaning apparatus which is different to a side of the surface cleaning apparatus which has the evacuation outlet is provided. Accordingly, the actuator may move in an axial direction and the mechanical linkage may move at an angle to the axial direction of movement of the actuator, such as in a direction transverse thereto.

In accordance with this aspect, there is provided a hand vacuum cleaner having an upper end, a lower end, a front end and a rear end, the hand vacuum cleaner comprising:
(a) an air flow passage extending from a dirty air inlet provided on the front end of the hand vacuum cleaner to a clean air outlet positioned rearward of the dirty air inlet, wherein a suction motor is provided in the air flow passage; and,
(b) an air treatment assembly provided in the air flow passage, the air treatment assembly comprising an air treatment chamber, a dirt collection region and an openable portion which is moveable between a closed position in which the surface cleaning apparatus is operable to clean a surface and an open position in which the dirt collection region is emptyable; and,
(c) a lock assembly operable between a locked position in which the openable portion is secured in the closed position and an unlocked position in which the openable portion is openable, the lock assembly comprising first and second engagement members and an actuator, wherein the actuator is provided on a forward facing portion of the front end.

In accordance with another aspect of this disclosure, which may be used alone or in combination with any one or more other aspects, evacuating the surface cleaning apparatus includes increasing the pressure in the surface cleaning apparatus, such as in the air treatment chamber prior to enabling air to travel through the dock to an air outlet of the dock, such as be opening an evacuation outlet of the surface cleaning apparatus. Alternately, or in addition, airflow through the dock to the air outlet of the dock may be temporarily terminated during an evacuation operation to allow pressure to build up in the surface cleaning apparatus, such as in the air treatment chamber, and then air flow may be recommenced, e.g., by opening the evacuation outlet. Accordingly, during an evacuation operation, air flow may be pulsed one or more times to assist in removing dirt from the air treatment assembly. Accordingly, for example, an evacuation operation may include a pre-evacuation step during which opening of the evacuation outlet of the docked apparatus is delayed allowing a pressure differential to built across the dirt outlet. For example, pressure may be reduced in the dock and/or increased in the dirt collection region before the evacuation air flow path of the surface cleaning apparatus is opened. This results in a pressure burst when the evacuation air flow path is opened. In some examples, the dumping door of the surface cleaning apparatus includes a delayed and/or multi-step release latch. The release latch of the door may open after a predetermined pressure differential is achieved and/or a predetermined time delay has elapsed from a triggering event such as a docking of the surface cleaning apparatus or an initiation of an evacuation operation. The release latch of the door may include a first latch that is released when the surface cleaning apparatus is docked (e.g., physically released by an actuator on the dock) and a second latch that is that unlocks when a minimum runtime is achieved and/or a minimum pressure differential across the door is achieved. Alternately, or in addition, a motor or solenoid may be used to operate the latch and/or to open and/or close the evacuation outlet.

In accordance with this aspect, there is provided a surface cleaning apparatus comprising:
(a) an air flow path extending from a dirty air inlet to a clean air outlet with a motor and fan assembly provided in the air flow path;
(b) an air treatment member provided in the air flow path, the air treatment member comprising a dirt collection region having an openable portion;
(c) a first lock comprising an actuator which is operable to move the first lock from a locked position of the first lock to an unlocked position of the first lock; and,
(d) a second lock operable between a locked position of the second lock and an unlocked position of the second lock;
wherein, when the first lock is in the unlocked position of the first lock, and when the second lock is in the locked position of the second lock, the openable portion is maintained in a closed position, and
wherein the openable portion is moveable to an open position when the first lock is in the unlocked position of the first lock and when the second lock is in the unlocked position of the second lock, and
wherein the second lock is moveable to the unlocked position of the second lock upon occurrence of an event that occurs subsequent to the first lock moving to the unlocked position of the first lock.

In accordance with this aspect, there is also provided a method of evacuating a dirt collection region of a surface cleaning apparatus, the surface cleaning apparatus having a first lock and a second lock and the dirt collection region having an openable portion, the method comprises:
(a) docking the dirt collection region at a docking station whereupon a first lock is moved to an unlocked position of the first lock and the openable portion is maintained in a closed position by the second lock; and,
(b) operating a motor and fan assembly until an event occurs whereupon a second lock is moved to an unlocked position of the second lock, whereupon the openable portion is moved to an open position.

In accordance with another aspect of this disclosure, which may be used alone or in combination with any one or more other aspects, the transverse air flow area of the air flow path from the dirt collection region of the surface cleaning apparatus to the air treatment member of the dock is restricted to increase air flow speed. The restriction may be accomplished by, e.g., one or more of using a smaller inlet to the air treatment chamber than the evacuation outlet during an evacuation operation, a smaller evacuation outlet during an evacuation operation than an air inlet of the dock, a smaller duct upstream of the air treatment chamber which is used during an evacuation operation to provide air to the air treatment chamber being evacuated, using a duct that tapers smaller from upstream to downstream ends. In some examples, the transverse air flow area of the evacuation air flow outlet of the surface cleaning apparatus is smaller than part or all of the transverse air flow area of the evacuation air flow path within the dirt collection region of the surface cleaning apparatus. In some examples, the transverse air flow area of the air inlet of the dock air flow path is smaller than the average transverse air flow area of the evacuation air flow path within the dirt collection region of the surface cleaning apparatus. In some examples, the dock air flow path extends through a duct between the dock air flow inlet and the dock air treatment member air inlet, and the duct transverse air flow area decreases (e.g., tapering or step-wise) from an upstream end to a downstream end. In some examples, the transverse air flow area of the evacuation outlet is smaller than the transverse air flow area of the air treatment chamber and the transverse air flow area of the air flow path in the dock to the air treatment member in the dock may be the same as or smaller than the transverse air flow area of the evacuation outlet.

In accordance with this aspect, there is provided an assembly comprising:
(a) a surface cleaning apparatus comprising:
(i) an air flow path extending from a dirty air inlet to a clean air outlet with a motor and fan assembly provided in the air flow path; and,
(ii) an air treatment member provided in the air flow path, the air treatment member comprising a dirt collection region having an openable portion;
(b) a docking station for the surface cleaning apparatus, the docking station comprising:
(i) a docking station air flow path extending from a docking station air inlet to a docking station air outlet; and,
(ii) a docking station air treatment member provided in the docking station air flow path,
wherein a first portion of the docking station air flow path upstream of the docking station air treatment member has a first cross-sectional area in a first plane transverse to a direction of flow through the first portion, and
wherein a second portion of the docking station air flow path upstream of the docking station air treatment member and downstream of the first portion has a second cross-sectional area in a second plane transverse to a direction of flow through the second portion and the second cross-sectional area is less than the first cross-sectional area.

In accordance with another aspect of this disclosure, which may be used alone or in combination with any one or more other aspects, the surface cleaning apparatus includes first and second stage air treatment members with first and second stage dirt collection regions, respectively, and the second stage dirt collection region has an evacuation outlet (e.g., door) discrete from the evacuation outlet (e.g., door) for the first stage dirt collection region. Where the surface cleaning apparatus is used with a dock, the dock air flow path may include separate inlet end branches for the first and second stage evacuation doors of the surface cleaning apparatus. One branch may merge into the other. The branches may lead to a common air treatment member of the dock. Optionally, the dock may include discrete air flow paths for the first and second stage evacuation doors of the surface cleaning apparatus, each with its own air treatment member to treat air flow from the first and second stage dirt collection regions of the surface cleaning apparatus separately. Alternately, a single dock inlet may overlie both evacuation doors.

In accordance with this aspect, there is provided a surface cleaning apparatus comprising:
(a) an air flow path extending from a dirty air inlet to a clean air outlet with a suction motor provided in the air flow path; and,
(b) a first stage air treatment member provided in the air flow path, the first stage air treatment member comprising a first stage dirt collection region and a first stage openable portion moveable between a closed position in which the first stage dirt collection region is closed and an open position in which the first stage dirt collection region is emptyable; and,
(c) a second stage air treatment member provided in the air flow path downstream of the first stage air treatment member, the second stage air treatment member comprising a second stage dirt collection region and a second stage openable portion moveable between a closed position in which the second stage dirt collection region is closed and an open position in which the second stage dirt collection region is emptyable.

In accordance with this aspect, there is also provided an assembly comprising:
(a) a surface cleaning apparatus comprising:
(i) an air flow path extending from a dirty air inlet to a clean air outlet with a suction motor provided in the air flow path; and,
(ii) a first stage air treatment member provided in the air flow path, the first stage air treatment member comprising a first stage dirt collection region and a first stage openable portion moveable between a closed position in which the first stage dirt collection region is closed and an open position in which the first stage dirt collection region is emptyable; and,
(iii) a second stage air treatment member provided in the air flow path downstream of the first stage air treatment member, the second stage air treatment member comprising a second stage dirt collection region and a second stage openable portion moveable between a closed position in which the second stage dirt collection region is closed and an open position in which the second stage dirt collection region is emptyable
(b) a docking station for the surface cleaning apparatus, the docking station comprising:
(i) a docking station air flow path extending from a docking station air inlet to a docking station air outlet; and,
(ii) a docking station air treatment member provided in the docking station air flow path.

In accordance with another aspect of this disclosure, which may be used alone or in combination with any one or more other aspects, the surface cleaning apparatus includes a front end and an opposite rear end with an air treatment member between the front and rear ends having a dirt collection region that extends rearwardly of an air treatment chamber past part or all of (e.g., a rear end or a front end and a rear end) of a pre-motor filter. Accordingly, the dirt collection region may extend rearwardly above the pre-motor filter. Alternately or in addition, the dirt collection region may extend rearwardly past part or all of (e.g., a rear end or a front end and a rear end) of a motor and fan assembly. The dirt collection region may extend rearwardly above the pre-motor filter and/or the motor and fan assembly.

In accordance with this aspect, there is provided a hand vacuum cleaner having a front end and a rear end and a longitudinal axis extending between the front and rear ends, the hand vacuum cleaner comprising:
(a) an air flow passage extending from a dirty air inlet to a clean air outlet wherein a suction motor is provided in the air flow passage;
(b) an air treatment chamber provided in the air flow path, the air treatment chamber having an air treatment chamber air inlet, an air treatment chamber air outlet and a dirt outlet, and
(c) a dirt collection chamber exterior to the air treatment chamber and the dirt outlet connects the air treatment chamber in communication with the dirt collection chamber,
wherein the dirt collection chamber extends rearwardly from the air treatment chamber.

In accordance with another aspect of this disclosure, which may be used alone or in combination with any one or more other aspects, the air treatment member includes a dirt collection chamber that is in communication with an air treatment chamber by a dirt outlet which has a variable size. For example, the air treatment member may be reconfigurable between a cleaning or treatment configuration in which the dirt outlet has a first size and an emptying or evacuation configuration in which the dirt outlet has a second, larger size. The first size may have a smaller transverse cross sectional area in a direction dirt travels therethrough and/or a smaller minimum dimension than the second size. For example, the dirt outlet may be a slot with a narrow dimension that increases from the treatment configuration to the evacuation configuration. Optionally, one or more of the walls forming the dirt outlet may be flexible. The flexible wall(s) may be stretched to open the dirt outlet in the evacuation configuration. Optionally, the air treatment member includes a dual wall structure between the air treatment chamber and the dirt collection chamber in the treatment configuration (e.g. with a joint between the walls at the dirt outlet), and the dual wall is unfolded in the evacuation configuration to open the dirt outlet.

In accordance with this aspect, there is provided a surface cleaning apparatus comprising:
(a) an air flow passage extending from a dirty air inlet to a clean air outlet wherein a suction motor is provided in the air flow passage; and,
(b) an air treatment assembly comprising an air treatment chamber and dirt collection chamber exterior to the air treatment chamber, the air treatment chamber is provided in the air flow path and comprises an air treatment chamber air inlet, an air treatment chamber air outlet at an outlet end of the air treatment chamber and a dirt outlet, wherein the dirt outlet connects the air treatment chamber in communication with the dirt collection chamber,
wherein, the air treatment assembly comprises an openable portion that is moveable between a closed position in which the surface cleaning apparatus is useable to clean a surface and an open position in which the air treatment assembly is emptyable, and wherein at least a portion of a wall defining a portion of the dirt outlet is made of flexible material, and
wherein, in operation to clean a surface, dirt travels through the dirt outlet from the air treatment chamber to the dirt collection chamber in a direction, and when the openable portion is moved to the open position, a cross-sectional area of the dirt outlet in a plane transverse to the direction is increased.

In accordance with this aspect, there is also provided a surface cleaning apparatus comprising:
(a) an air flow passage extending from a dirty air inlet to a clean air outlet wherein a suction motor is provided in the air flow passage; and,
(b) an air treatment assembly comprising an air treatment chamber and dirt collection chamber exterior to the air treatment chamber, the air treatment chamber is provided in the air flow path and comprises an air treatment chamber air inlet, an air treatment chamber air outlet at an outlet end of the air treatment chamber and a dirt outlet, wherein the dirt outlet connects the air treatment chamber in communication with the dirt collection chamber,
wherein, the air treatment assembly comprises an openable portion that is moveable between a closed position in which the surface cleaning apparatus is useable to clean a surface and an open position in which the air treatment assembly is emptyable, and
wherein, in operation to clean a surface, dirt travels through the dirt outlet from the air treatment chamber to the dirt collection chamber in a direction, and at least a portion of a wall defining a portion of the dirt outlet is made of a dual wall structure having first and second wall portions that overlie each other and a plane that is parallel to the direction extends through the first and second wall portions, and
wherein, when the openable portion is moved to the open position, part of the first wall portion is moved away from part of the second wall portion.

In accordance with another aspect of this disclosure, which may be used alone or in combination with any one or more other aspects, the evacuation outlet (e.g., door or dumping door) of the surface cleaning apparatus includes a portion of the sidewall of the air treatment chamber which opens (e.g., rotates) to a first opened position, and the porous member of the treatment chamber air outlet opens subsequently or concurrently with the dumping door to a second opened position displaced (e.g., rotated) less than the first opened position. Moving the porous member may release dirt that may be collected between the porous member and the remainder (e.g., stationary portion) of the sidewall of the air treatment chamber that is not part of the dumping door. Displacing the dumping door further than the porous member results in an increased gap between the porous member and the dumping door which may release dirt that may be collected between the porous member and the dumping door. Alternately, the increased gap may enable a user to more easily remove material (e.g., hair) that has built up around the porous member. Optionally, the dumping door and the porous member pivot open (optionally around a common pivot axis), and the dumping door pivots a first angular extent while the porous member pivots a second angular extent which is less than the first angular extent.

In accordance with this aspect, there is provided a hand vacuum cleaner comprising:
(a) an air flow passage extending from a dirty air inlet provided on the front end of the hand vacuum cleaner to a clean air outlet positioned rearward of the dirty air inlet, wherein a suction motor is provided in the air flow passage;
(b) an air treatment assembly comprising an air treatment chamber, the air treatment chamber comprising a front end, a rear end comprising a rear end wall, an air treatment chamber air inlet, an air treatment chamber air outlet provided at the rear end of the air treatment chamber in the rear end wall, and an air treatment chamber axis extending between the front and rear ends of the air treatment chamber, wherein the air treatment chamber air outlet comprises a porous member that extends into the air treatment chamber from the rear end wall;
wherein the air treatment assembly comprises an openable portion that is moveable between a closed position in which the hand vacuum cleaner is operable to clean a surface and an open position in which a dirt collection region of the air treatment assembly is emptyable, and
wherein the porous member is moveable between an operating position in which the openable portion is closed and the hand vacuum cleaner is operable to clean a surface and a porous member cleaning position in the porous member is moved from its operating position, and
wherein the openable portion moves a greater distance as it moves to its open position than a distance that the porous member travels as it moves to the porous member cleaning position.

In accordance with this aspect, there is also provided a hand vacuum cleaner comprising:
(a) an air flow passage extending from a dirty air inlet to a clean air outlet wherein a suction motor is provided in the air flow passage;
(b) an air treatment assembly comprising an air treatment chamber, the air treatment chamber comprising a first end, an axially opposed second end comprising a second end wall, an air treatment chamber air inlet, an air treatment chamber air outlet provided at the second end of the air treatment chamber in the second end wall, and an air treatment chamber axis extending between the first and second ends of the air treatment chamber, wherein the air treatment chamber air outlet comprises a porous member that extends into the air treatment chamber from the second end wall;
wherein the air treatment assembly comprises an openable portion that is moveable between a closed position in which the surface cleaning apparatus is operable to clean a surface and an open position in which a dirt collection region of the air treatment assembly is emptyable, and
wherein the porous member is moveable between an operating position in which the openable portion is closed and the surface cleaning apparatus is operable to clean a surface and a porous member cleaning position in which the porous member is moved from its operating position, and
wherein the openable portion moves a greater distance as it moves to its open position than a distance that the porous member travels as it moves to the porous member cleaning position.

In accordance with another aspect of this disclosure, which may be used alone or in combination with any one or more other aspects, the dock includes a support to hold the dirt collection region of the dock above a support surface, e.g., a floor, on which the dock rests, for easier user access to the dirt collection region. The dock may be configured to support a lower end of the dirt collection region of the dock at least 1 foot or at least 2 feet above the support surface on which the dock rests. Optionally, the dock includes an arm supporting a main body of the dock above a base. The base is provided to rest on the support surface, and is secured to a lower end of the arm. The main body includes the dock air flow path and the dirt collection region, and is secured to an upper end of the arm. The arm may have a length of at least 1 foot or at least 2 feet.

In accordance with another aspect of this disclosure, which may be used alone or in combination with any one or more other aspects, the surface cleaning apparatus includes a cyclone chamber with a cyclone axis and a donut filter extending along a filter axis extending generally transverse to the cyclone axis. The pre-motor filter may be rearward of the cyclone chamber. The air moving member may be rearward of the premotor filter. Optionally, the filter axis is perpendicular to the cyclone axis. Optionally, when a hand vacuum cleaner axis that extends between a front end of the hand vacuum cleaner having the dirty air inlet and a rear end of the hand vacuum cleaner is oriented horizontally, the cyclone axis is oriented generally horizontal and the filter axis is oriented generally vertical.

It will be appreciated by a person skilled in the art that an apparatus or method disclosed herein may embody any one or more of the features contained herein and that the features may be used in any particular combination or sub-combination.

These and other aspects and features of various embodiments will be described in greater detail below.

### BRIEF DESCRIPTION OF THE DRAWINGS

For a better understanding of the described embodiments and to show more clearly how they may be carried into effect, reference will now be made, by way of example, to the accompanying drawings in which:

FIG. 1 is front perspective view of a surface cleaning apparatus;

FIG. 2 is a side cross sectional view of the surface cleaning apparatus of FIG. 1 in a surface cleaning mode;

FIG. 3 is a side perspective view of view of the surface cleaning apparatus of FIG. 1 mounted to a base so as to be a stick vacuum cleaner;

FIG. 4 is a bottom perspective view of the surface cleaning apparatus of FIG. 1 with an air treatment assembly and premotor filter removed;

FIG. 5 is a front perspective view of the surface cleaning apparatus of FIG. 1 docked with a dock;

FIG. 6 is a rear perspective view of the surface cleaning apparatus and dock of FIG. 5;

FIG. 7 is a side cross sectional view of the surface cleaning apparatus of FIG. 1 in a first evacuation mode;

FIG. 8 is a side cross sectional view of the surface cleaning apparatus of FIG. 1 in a second evacuation mode;

FIG. 9 is a front perspective cross sectional view of a valve of another surface cleaning apparatus in a surface cleaning mode;

FIG. 10 is a front perspective cross sectional view of the valve of the surface cleaning apparatus of FIG. 9 is an evacuation mode;

FIG. 11 is a front perspective view of another surface cleaning apparatus;

FIG. 12 is a front perspective cross sectional view of the surface cleaning apparatus of FIG. 11 in a surface cleaning mode;

FIG. 13 is a front perspective view of an air moving member and valve assembly of the surface cleaning apparatus of FIG. 11, in the surface cleaning mode;

FIG. 14 is a front perspective cross sectional view of the surface cleaning apparatus of FIG. 11 adjacent a docking station;

FIG. 15 is a front perspective cross sectional view of the surface cleaning apparatus of FIG. 11 docked with the docking station of FIG. 14;

FIG. 16 is a front perspective cross sectional view of the surface cleaning apparatus of FIG. 11 docked with the docking station of FIG. 14 and in an evacuation mode;

FIG. 17 is a front perspective view of the air moving member and valve assembly of the surface cleaning apparatus of FIG. 11 in the evacuation mode;

FIG. 18 is a front perspective cross sectional view of the air moving member and valve assembly of the surface cleaning apparatus of FIG. 11 in the evacuation mode;

FIG. 19 is a vertical cross sectional view of the surface cleaning apparatus and dock of FIG. 5 with an evacuation opening of the surface cleaning apparatus closed;

FIG. 20 is a vertical cross sectional view of the surface cleaning apparatus and dock of FIG. 5 with the evacuation opening of the surface cleaning apparatus open;

FIG. 21 is an enlarged side cross sectional view of an air treatment chamber air outlet and premotor filter of another surface cleaning apparatus;

FIG. 22 is an enlarged side cross sectional view of an air treatment chamber air outlet and premotor filter of another surface cleaning apparatus;

FIG. 23 is an enlarged side cross sectional view of an air treatment chamber air outlet and premotor filter of another surface cleaning apparatus;

FIG. 24 is an enlarged side cross sectional view of an air treatment chamber air outlet and premotor filter of another surface cleaning apparatus;

FIG. 25 is an end cross sectional view of the premotor filter of FIG. 16;

FIG. 26 is an enlarged side cross sectional view of an air treatment chamber air outlet and premotor filter of another surface cleaning apparatus;

FIG. 27 is an enlarged side cross sectional view of an air treatment chamber air outlet and premotor filter of another surface cleaning apparatus;

FIG. 28 is an enlarged side cross sectional view of an air treatment chamber air outlet and pre-motor filter of another surface cleaning apparatus;

FIG. 29 is a top perspective view of another surface cleaning apparatus;

FIG. 30 is an enlarged side perspective cross sectional view of a portion of a front end of the surface cleaning apparatus of FIG. 29;

FIG. 31 is an enlarged front perspective cross sectional view of another portion of the front end of the surface cleaning apparatus of FIG. 29;

FIG. 32 is a side cross sectional view of the surface cleaning apparatus of FIG. 29;

FIG. 33 is a bottom perspective view of the surface cleaning apparatus of FIG. 20 with an air treatment assembly and premotor filter removed;

FIG. 34 is a top perspective view of the surface cleaning apparatus of FIG. 29 mounted to a base so as to be a stick vacuum cleaner;

FIG. 35 is a top perspective view of a dock for the surface cleaning apparatus of FIG. 29;

FIG. 36 is an enlarged top perspective view of the upper end of the dock of FIG. 35;

FIG. 37 is a front perspective view of the surface cleaning apparatus of FIG. 29 and the dock of FIG. 35;

FIG. 38 is a rear perspective view of the surface cleaning apparatus and dock of FIG. 37;

FIG. 39 is a vertical cross sectional view of the surface cleaning apparatus and dock of FIG. 37 with an evacuation outlet of the surface cleaning apparatus closed;

FIG. 40 is a vertical cross sectional view of the surface cleaning apparatus and dock of FIG. 37 with an evacuation outlet of the surface cleaning apparatus open;

FIG. 41 is a top perspective view of another surface cleaning apparatus;

FIG. 42 is bottom perspective view of the surface cleaning apparatus of FIG. 41;

FIG. 43 is a side cross sectional view of the surface cleaning apparatus of FIG. 41;

FIG. 44 is a top perspective view of the surface cleaning apparatus of FIG. 41 with an air treatment assembly in an open position;

FIG. 45 is a top perspective view of the surface cleaning apparatus of FIG. 41 with the air treatment assembly in an open position and a premotor filter removed;

FIG. 46 is a top perspective view of the surface cleaning apparatus of FIG. 41 with the air treatment assembly in an open position and a post motor filter removed;

FIG. 47 is a top perspective view of another surface cleaning apparatus;

FIG. 48 is a bottom perspective view of the surface cleaning apparatus of FIG. 27;

FIG. 49 is a side cross sectional view of the surface cleaning apparatus of FIG. 27;

FIG. 50 is a side cross sectional view of another surface cleaning apparatus;

FIG. 51 is a front perspective view of the surface cleaning apparatus of FIG. 27 with the air treatment assembly open;

FIG. 52 is a front perspective view of the surface cleaning apparatus of FIG. 27 with an air treatment assembly removed from a main body and the premotor filter removed from the air treatment assembly;

FIG. 53 is a top perspective view of the surface cleaning apparatus of FIG. 27 with a post-motor filter housing open and a post-motor filter removed;

FIG. 54 is a front perspective view of another surface cleaning apparatus;

FIG. 55 is a rear perspective view of the surface cleaning apparatus of FIG. 54;

FIG. 56 is a side cross sectional view of the surface cleaning apparatus of FIG. 54;

FIG. 57 is a front cross sectional view of the surface cleaning apparatus of FIG. 54;

FIG. 58 is a front perspective view of the surface cleaning apparatus of FIG. 54 with an evacuation outlet open;

FIG. 59 is a front perspective view of the surface cleaning apparatus of FIG. 54 with an air treatment assembly removed from a main body, a premotor filter housing open, and a premotor filter removed from the main body;

FIG. 60 is a front perspective view of the surface cleaning apparatus of FIG. 54 with a post-motor filter housing open and a post-motor filter removed;

FIG. 61 is a front perspective view of the surface cleaning apparatus of FIG. 54 docked with a dock;

FIG. 62 is a rear perspective view of the surface cleaning apparatus and dock of FIG. 61;

FIG. 63 is an enlarged view of the surface cleaning apparatus and dock of FIG. 61 with the surface cleaning apparatus in a first position partially separated from the dock prior to docking;

FIG. 64 is an enlarged side cross sectional view of the surface cleaning apparatus and dock of FIG. 61 with the surface cleaning apparatus in a second position in which the surface cleaning apparatus first reaches the dock when docking;

FIG. 65 is an enlarged top perspective view of the surface cleaning apparatus and dock of FIG. 61 with the surface cleaning apparatus in a third position partially inserted into the dock;

FIG. 66 is an enlarged top perspective cut-away view of the third position of FIG. 65;

FIG. 67 is a front cross sectional view of the third position of FIG. 65;

FIG. 68 is an enlarged top perspective view of the surface cleaning apparatus and dock of FIG. 61 with the surface cleaning apparatus in a fourth position partially inserted into the dock further than the third position;

FIG. 69 is an enlarged top perspective cut-away view of the fourth position of FIG. 68; and,

FIG. 70 is a front cross sectional view of the fourth position of FIG. 68.

The drawings included herewith are for illustrating various examples of articles, methods, and apparatuses of the teaching of the present specification and are not intended to limit the scope of what is taught in any way.

### DESCRIPTION OF EXAMPLE EMBODIMENTS

Various apparatuses, methods and compositions are described below to provide an example of an embodiment of each claimed invention. No embodiment described below limits any claimed invention and any claimed invention may cover apparatuses and methods that differ from those described below. The claimed inventions are not limited to apparatuses, methods and compositions having all of the features of any one apparatus, method or composition described below or to features common to multiple or all of the apparatuses, methods or compositions described below. It is possible that an apparatus, method or composition described below is not an embodiment of any claimed invention. Any invention disclosed in an apparatus, method or composition described below that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, or “directly fastened” where the parts are connected in physical contact with each other. None of the terms “coupled”, “connected”, “attached”, and “fastened” distinguish the manner in which two or more parts are joined together.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

### General Description of a Surface Cleaning Apparatus

The following is a general description intended to provide a basis for understanding several of the features that are discussed herein. As discussed in detail subsequently, each of the features may be used alone, or in combination.

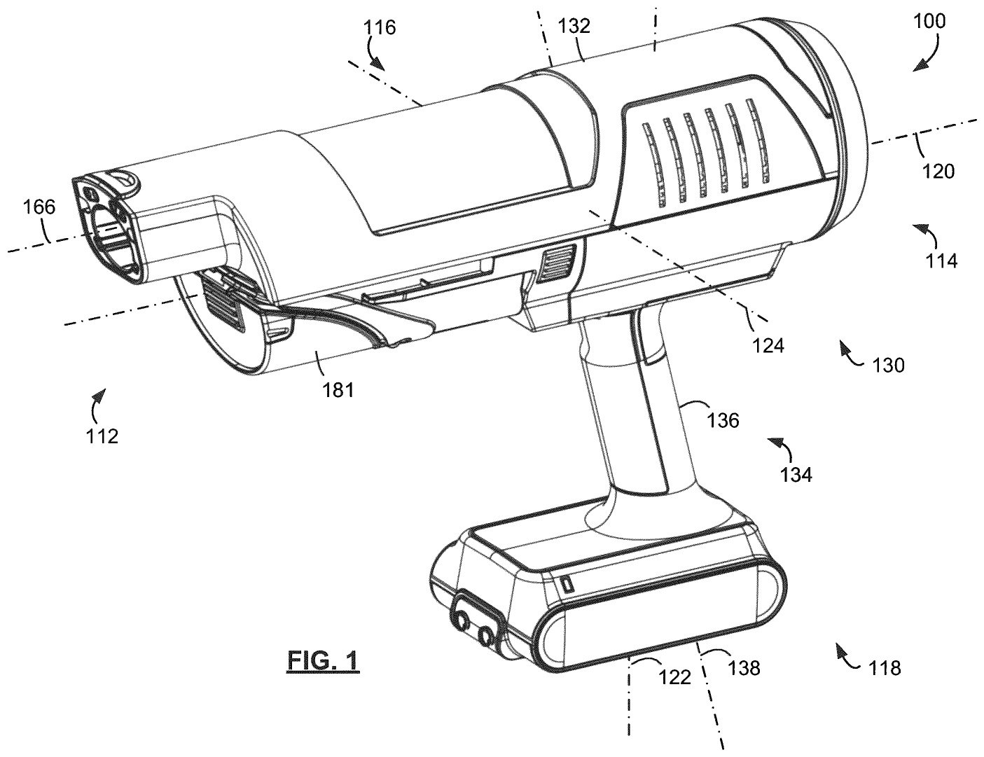

Referring to FIG. 1, an exemplary embodiment of a surface cleaning apparatus is shown generally as 100.

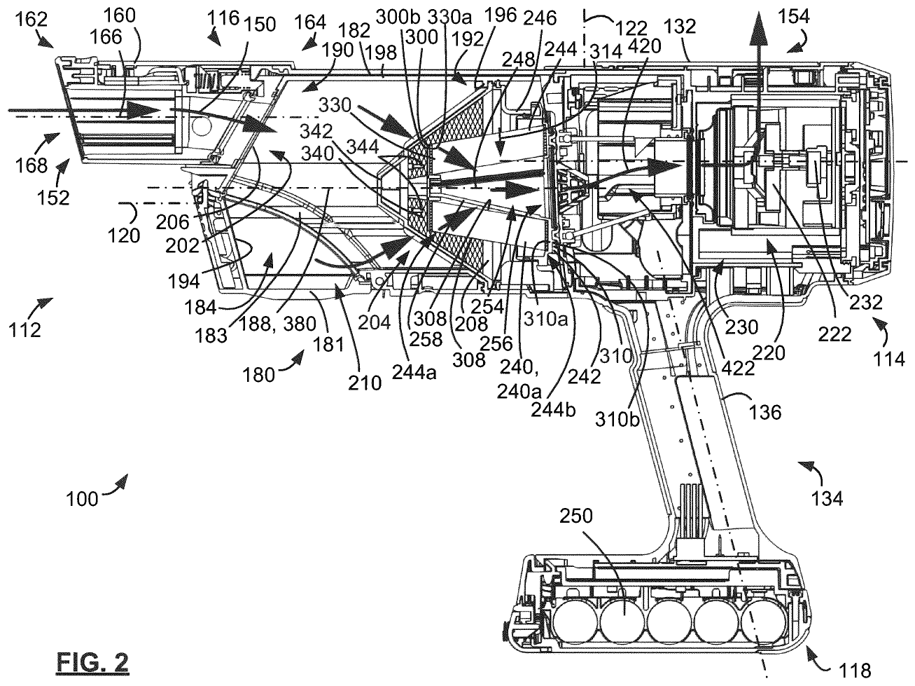

The exemplary surface cleaning apparatus 100 of FIGS. 1 and 2 is a hand-held surface cleaning apparatus, which is commonly referred to as a “hand vacuum cleaner” or a “handvac”. As used herein, a hand-held surface cleaning apparatus or hand vacuum cleaner or handvac is a vacuum cleaner that can be operated generally one-handedly to clean a surface while its weight is held by the same one hand. For example, the carry handle and a clean air inlet may be rigidly coupled to each other (directly or indirectly) so as to move as one while maintaining a constant orientation relative to each other. This is contrasted with upright and canister surface cleaning apparatus, the weight of which is supported by a surface (e.g., a floor below) during use.

It will be appreciated that any one or more of the features of the surface cleaning apparatus 100 set out herein may also or alternately be used in any type of surface cleaning apparatus, such as an upright surface cleaning apparatus, a stick vac, an extractor, a wet-dry vacuum, or the like, or in a docking station for a surface cleaning apparatus. It will also be appreciated that a surface cleaning apparatus or docking station may use any configuration of the operating components and the airflow paths exemplified herein.

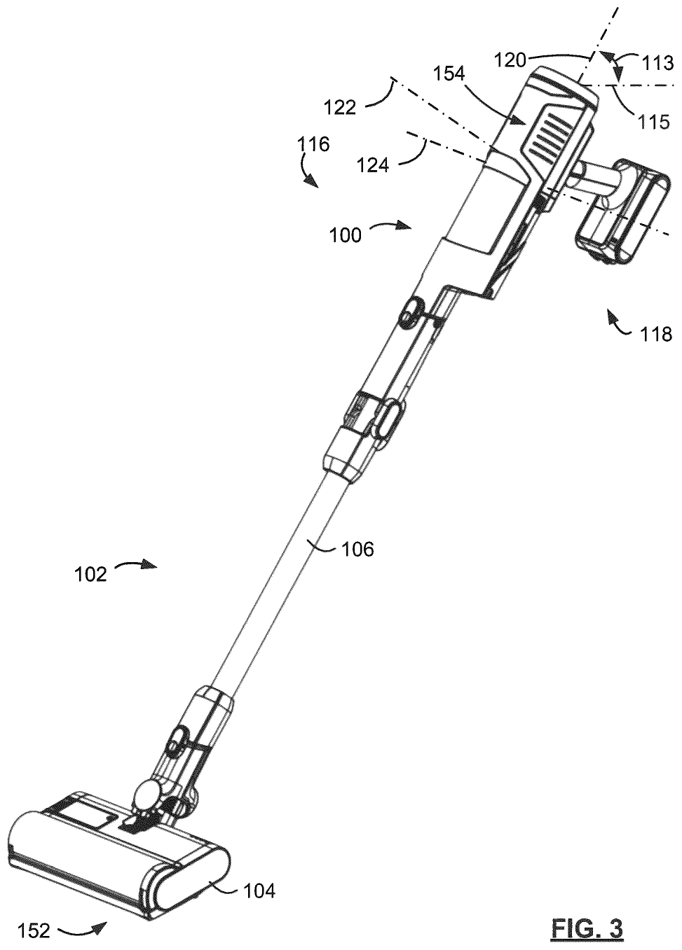

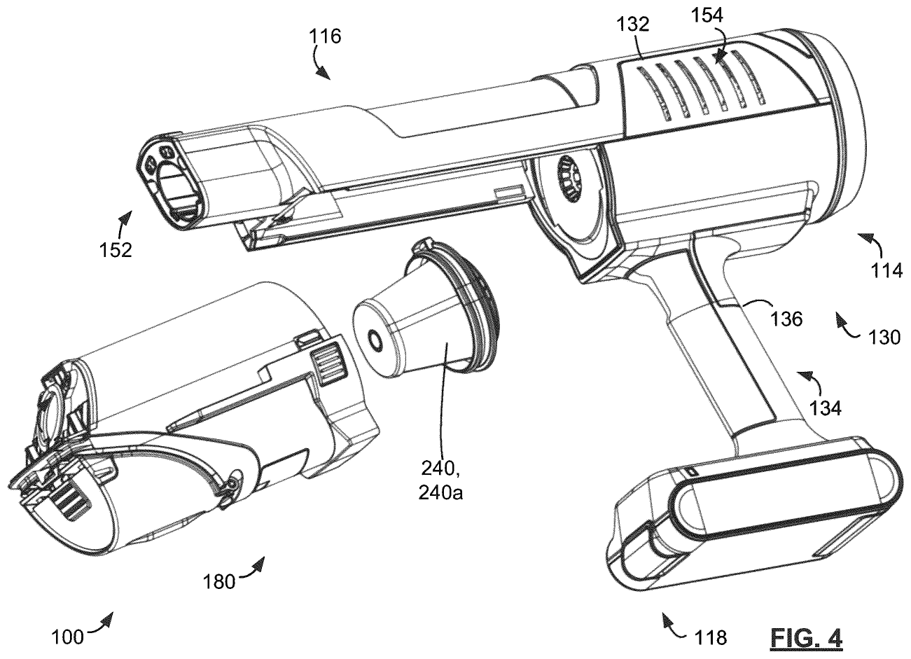

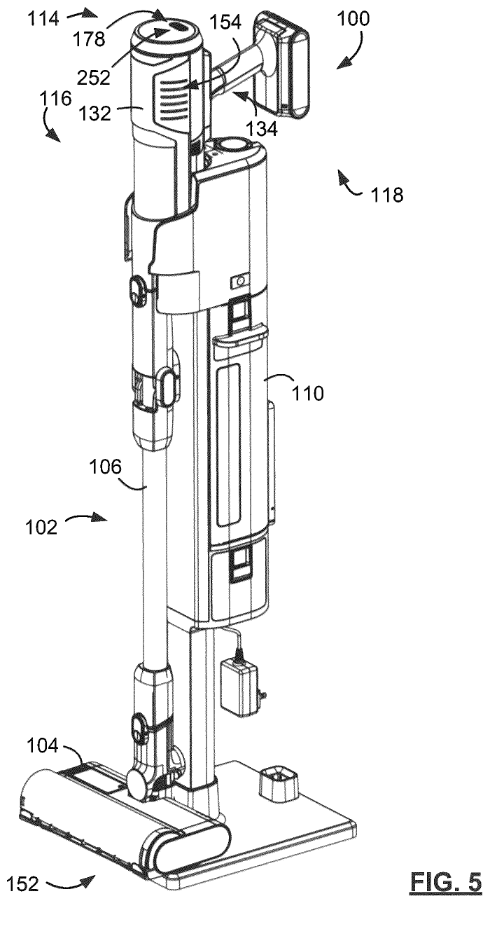

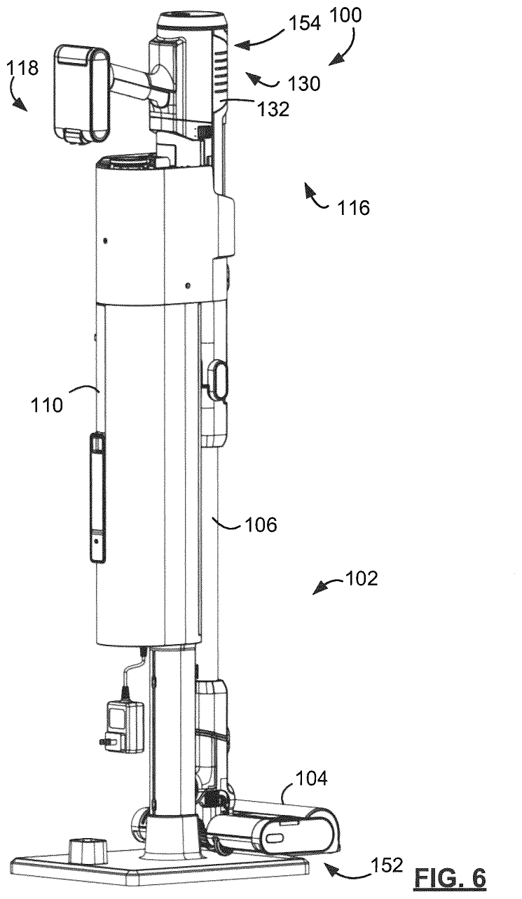

Optionally, a hand surface cleaning apparatus 100 may be removably mountable on a base 102 so as to form, for example, an upright vacuum cleaner, a canister vacuum cleaner, a stick vacuum cleaner or stick vac, a wet-dry vacuum cleaner and the like. For example, the exemplary surface cleaning apparatus of FIG. 3 is a stick vacuum cleaner. The stick vacuum includes a surface cleaning head 104 and an elongated wand 106 that can optionally be removably connectable to the surface cleaning apparatus 100 and the hand surface cleaning apparatus 100. In some examples, a surface cleaning apparatus 100 that includes a base with a floor cleaning head 104 is moveable between an upright storage position (e.g., FIG. 5, with or without a dock 110) and a reclined operating or in-use position (e.g., FIG. 3).

Referring again to FIG. 1, the surface cleaning apparatus 100 has an apparatus front end 112, an apparatus rear end 114, an apparatus upper end 116 and an apparatus lower end 118. An apparatus longitudinal axis 120 extends between the apparatus front end 112 and the apparatus rear end 114 in a forward/rearward direction. An apparatus vertical axis 122 extends between the apparatus upper end 106 and apparatus lower end 118 in an upward/downward direction. The apparatus vertical axis 122 is perpendicular to the apparatus longitudinal axis 120. An apparatus transverse axis 124 is perpendicular to each of the apparatus vertical axis 122 and the apparatus longitudinal axis 120 and extends laterally through right and left lateral sides of apparatus 100.

In an in-use position for cleaning a surface such as a floor, the upper end 116 is generally above the lower end 118. In some examples, the transverse axis 124 extends generally horizontally in the in-use position. In some examples, the longitudinal axis 120 extends generally horizontally in the in-use position (e.g., for a robot vacuum or a canister vacuum). Referring to FIG. 3, in the in-use position of FIG. 3 the transverse axis 124 of the exemplary surface cleaning apparatus 100 extends generally horizontally, the upper end 116 is generally at an elevation above the lower end 118, and the longitudinal axis 120 extends at an angle 113 (i.e., a reclined in-use position) to the horizontal 115 (e.g., a floor or other generally horizontal surface to be cleaned). Angle 113 may be generally smaller (e.g., approaching 0 degrees in some uses) when the apparatus 100 is in-use without the base 102 (e.g., used as a hand vacuum).

Referring again to FIG. 1, the surface cleaning apparatus 100 includes a main body 130. The main body 130 includes a main body housing 132 and optionally a carry or driving handle 134. The main body housing 132 may be any suitable main body housing. The main body housing 132 may house one or more of a pre-motor filter, an air moving member (e.g., a suction motor), and a post motor filter. The main body housing 132 may be selectively openable to provide access to one or more housed components.

The handle 134 is configured to for use in moving the apparatus 100. In some examples, handle 134 is a drive handle drivingly (e.g., rigidly) connected to a nozzle or floor cleaning head to move the nozzle or floor cleaning head to clean a surface. In some examples, a handle is a carry handle to carry the apparatus 100, such as during a cleaning operation or to and from a storage location. The handle 134 may be any suitable handle such as a recessed handle formed by providing a recess in a surface of the main body housing 132 or a projecting handle extending out from the main body housing 132, such as a pistol grip handle as exemplified.

Referring to FIG. 1, one or both ends of handle 134 of the main body 130 may be secured to the main body housing 132, directly or indirectly (e.g., via struts extending from the hand grip 136). The exemplary handle 134 of FIG. 1 is secured to the main body housing 132 at one end (the upper end). The handle 134 includes a hand grip portion 136 extending generally along a hand grip axis 138 that extends centrally through the hand grip portion from a lower end of the hand grip portion to an upper end of the hand grip portion. The hand grip axis 138 may extend in any suitable direction in use, such as generally vertically (i.e., generally along the vertical axis 122) or generally horizontally (e.g., an under-hand carry handle). the pistol grip axis 138 may form an acute forward or rearward angle from vertical. The angle can be any suitable angle, such as between about 5° and 75° (e.g., between 5° and 60°, or between 5° and) 45°. For example, in the embodiments illustrated, the pistol grip axis 138 of the pistol grip portion 136 forms a forward angle of about 15° from the vertical. Any angle of the pistol grip axis 138 may be possible.

As exemplified in FIG. 1, the handle 134 (the upper end of the hand grip portion 136) may be secured to the lower end 118 of the apparatus 100. Arranging the handle 134 below a heavy and/or bulky component of the surface cleaning apparatus 100 may result in a more desirable hand-feel of the surface cleaning apparatus 100.

It will be appreciated that the main body housing 132 and/or carry handle 134 may be in other configurations, shapes, and/or positions in other embodiments.

Referring now to FIG. 2, a surface cleaning mode air flow path 150 extends from an apparatus dirty air inlet 152 to an apparatus clean air outlet 154.

As exemplified in FIG. 1, the dirty air inlet 152 may be provided forward of the clean air outlet 154. The dirty air inlet 152 may be provided at the apparatus front end 112. Arranging the dirty air inlet at the front end 112 may help with using the dirty air inlet as a surface cleaning nozzle. The dirty air inlet 154 may be located at an upper end 116 of the apparatus 100. Optionally, the dirty air inlet 154 may be located generally above the handle 134. Alternatively, the dirty air inlet 154 may be located at a lower end 118 of the apparatus 100. It will be appreciated that the dirty air inlet 152 may be located anywhere known in the vacuum cleaner art. The inlet may be directed in any suitable direction, such as generally downwardly or generally forwardly or upwardly.

The apparatus dirty air inlet 152 may be provided at an inlet end of an apparatus inlet conduit 160. The apparatus inlet conduit 160 extends from an apparatus inlet conduit inlet end 162 to an apparatus inlet conduit outlet end 164. The apparatus inlet conduit outlet end 164 may open into an internal chamber of the surface cleaning apparatus 100 (e.g., an air treatment chamber). As exemplified in FIG. 2 the apparatus inlet conduit 160 has an inlet conduit longitudinal axis 166 along a longest dimension of the inlet conduit 160 and extending between the apparatus inlet conduit inlet end 162 and the apparatus inlet conduit outlet end 164. Optionally, the inlet conduit 160 is a generally horizontally extending conduit, as exemplified in FIG. 2. In the exemplary embodiment of FIG. 2, the inlet conduit longitudinal axis 166 extends between the apparatus front end 112 and the apparatus rear end 114, and, as exemplified, may be generally horizonal when the apparatus upper end 116 is above the apparatus lower end 118. The inlet conduit longitudinal axis 166 may be generally parallel to the apparatus longitudinal axis 120.

As exemplified in FIG. 2, the apparatus inlet conduit 160 may form a nozzle 168 of the surface cleaning apparatus 100 (e.g., a nozzle for a hand vac). Alternatively, or additionally, the inlet conduit 160 may be connectable or directly connectable to an accessory, such as the wand 106 illustrated in FIG. 3, a flexible conduit (e.g., a wet/dry vacuum hose with or without a rigid conduit at an upstream end thereof), a crevice tool, a mini brush, and the like. The accessory may be coupled to the surface cleaning apparatus 100 such that the accessory is in air flow communication with the apparatus dirty air inlet 152 (e.g., in air flow communication with the apparatus inlet conduit 160). For example, the accessory may be or include a conduit (e.g., wand 106), and the conduit of the accessory may be received within the apparatus inlet conduit 160 or may receive the apparatus inlet conduit 160 within the accessory conduit. Optionally, one or more releasable fasteners may be used to releasably couple the accessory to the surface cleaning apparatus 100, such as clips or magnets. Alternatively, or additionally, the accessory may be held in air flow communication with the dirty air inlet via a friction fit (e.g., between an outer diameter of an accessory conduit and an inner diameter of the apparatus inlet conduit 160, or vice versa). Alternately, it will be understood that the apparatus inlet conduit 160 may be slidably receivable in an accessory conduit.

It will also be appreciated that, in some embodiments, the surface cleaning apparatus 100 may not include an apparatus inlet conduit 160, and the apparatus dirty air inlet 152 may instead open directly into a downstream chamber (e.g., an air treatment chamber) rather than being at an upstream end of a conduit. However, an apparatus inlet conduit 160 allows, e.g., a nozzle 168 to be formed for application to a surface that is to be cleaned (e.g., projecting outward for application to the surface), provides directionality to an air flow entering the surface cleaning apparatus 100, and/or provides a convenient attachment interface for an accessory. Accordingly, any inlet conduit may be used.

The apparatus clean air outlet 154 may be provided at any location, such as at the apparatus upper end 116 (see FIG. 2) or the lower end. The apparatus clean air outlet 154 may be provided rearward of the clean air inlet 152. The apparatus clean air outlet 154 may be provided at the rear end 114. The apparatus clean air outlet 154 may be provided at the opposite end of the surface cleaning apparatus 100 from the apparatus dirty air inlet 152.

It will be appreciated that the apparatus dirty air inlet 152 and/or the apparatus clean air outlet 154 may each be provided at different locations and/or be of different configurations.

The surface cleaning apparatus 100 includes an air treatment assembly 180. The apparatus air flow path 150 extends through the air treatment assembly 180. The air treatment assembly 180 is configured to treat the airflow (e.g., remove dirt and/or liquid from the airflow).

The air treatment assembly 180 may be removably mounted to the main body 130 and/or incorporated as part of the main body 130. For example, the air treatment assembly 180 or a portion thereof may be removably mounted to the main body housing 132. The air treatment assembly 180 may be openable when mounted to the main body housing 130 and/or when removed therefrom. It will be appreciated that the air treatment assembly 180 or the portion thereof may be removeable from the main body housing 132 in any suitable way, such as translationally or rotationally. It will be appreciated that the air treatment assembly 180 or the portion thereof may be removeable from the main body housing 132 in any direction, such as upwardly, downwardly, forwardly, rearwardly, or laterally. It will be appreciated that the air treatment assembly 180 or the portion thereof may be secured to the main body 130 in any suitable way, such as by releasable fasteners such as clasps or magnets, which may be releasable or overcome by a predetermined force to be applied by a user. In some embodiments, the air treatment assembly 180 or a part thereof is released by a user action, such as by a user interaction with a button or other toggle of a user interface, which may be drivingly connected to a clasp or the like.

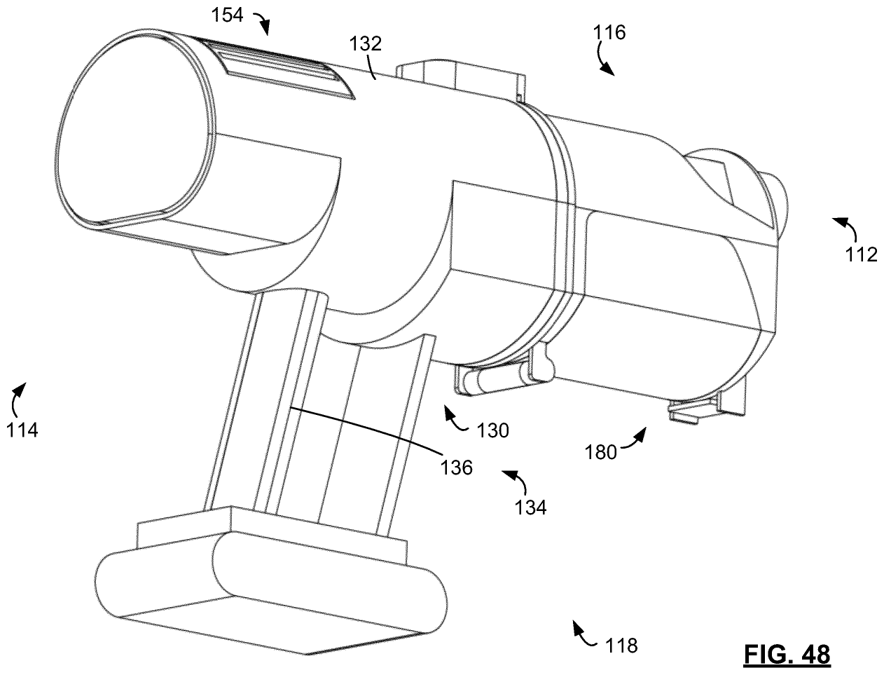

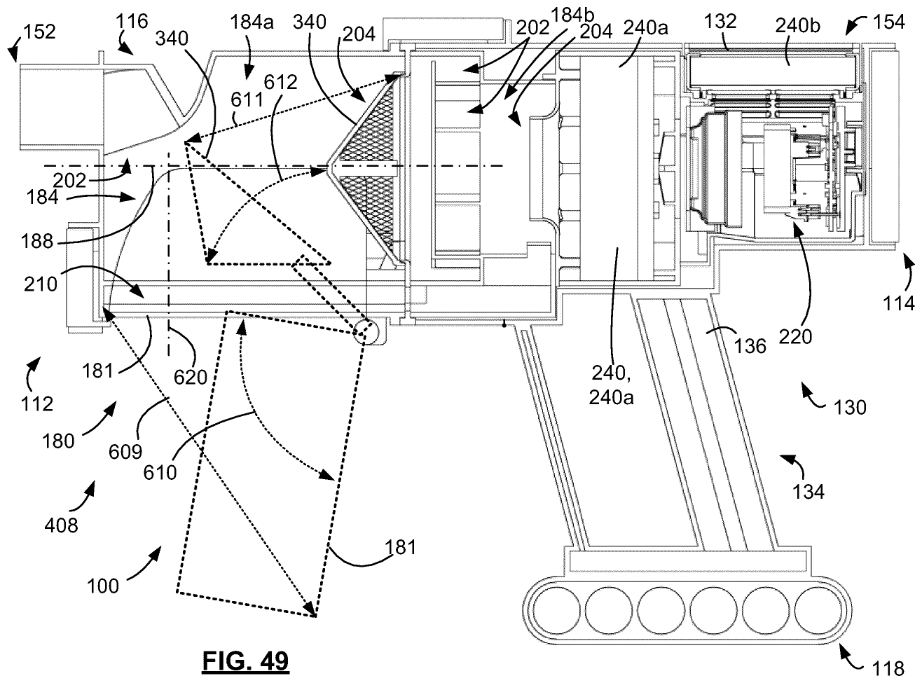

The air treatment assembly 180 includes one or more air treatment members 182 in one or more treatment stages. The exemplary assembly 180 of FIG. 2 includes one air treatment member 182. The exemplary assembly 180 of FIG. 49 includes a first air treatment member 182a in a first stage and a second air treatment member 182b in a second stage. Any air treatment member or members known in the art may be used. For example, an air treatment stage of the surface cleaning apparatus may use one or more air treatment stage, each of which uses or comprises an air treatment chamber 184 or a plurality of air treatment chamber 184 in parallel. Each air treatment chamber may have a generally open air flow path extending therethrough. Each air treatment chamber 184 may be a cyclone or a non-cyclonic momentum separator.

For example, the air treatment chamber 184 of a non-cyclonic treatment stage may be a non-cyclonic momentum separator. Within the air treatment chamber 184 of a non-cyclonic momentum separator, the airflow path may include one or more significant directional changes (e.g., of 45°, 90° or more) whereby dirt particles with higher momentum than the air are separated (e.g., thrown) from the airflow during each directional change.

Optionally, the air flow path 150 passes through a porous member (e.g., a screen) which may be provided in the air treatment chamber and define a location at which air exits the air treatment chamber 184 to travel downstream. In addition, as discussed subsequently, a physical filter media (e.g., foam, felt, HEPA) or the like may be provided downstream from any or all air treatment chambers 184 and upstream and/or downstream of a suction motor and fan assembly. The air treatment member 182 may be provided upstream or downstream from the suction motor and fan assembly. A pre-motor physical filter media may be partially or fully nested in the porous member (e.g., a screen).

It will be appreciated that any suitable shape of chamber 184 may be used, such as a generally rectangular chamber or a generally cylindrical chamber. In some examples, the air treatment chamber 184 includes a longitudinal axis 188 extending between a first end 190 and a second end 192 opposite the first end 190. The air treatment chamber may be an upwardly-downwardly extending chamber (i.e., the long dimension of the chamber). Alternatively, the air treatment chamber may be a forwardly-rearwardly extending chamber (i.e., the long dimension of the chamber). In some examples, as exemplified in FIG. 2, the first end 190 is a front end and the second end 192 is a rear end when the apparatus upper end 116 is above the apparatus lower end 118. Alternatively, in some examples the first end 190 is an upper end and the second end 192 is a lower end (i.e., the axis 188 is generally vertical when the top end 116 is above the bottom end 118).

Referring still to FIG. 2, in some examples the chamber 184 includes a first end wall 194 (e.g., a front wall) at the first end 190 (e.g., a front end) and a second end wall (e.g., a rear wall) 196 at the second end 192 (e.g., a rear end). The second end wall 196 may face the first end wall 194 across the chamber 184. In some examples, a sidewall 198 extends between the first and second ends 190, 192, and may extend between the first and second end walls 194, 196. The sidewall 198 may be a generally cylindrical wall and the longitudinal axis 188 may be a cyclone axis of rotation of, e.g., a cyclone chamber. However, it will be appreciated that the air treatment member 182 may not be a cyclone. In some examples, the air treatment member 182 is a non-cyclonic momentum separator.

The air treatment chamber 184 includes a chamber air inlet 202 and a chamber air outlet 204. The exemplary chamber air inlet 202 of FIG. 2 includes an inlet port opening 206 into the chamber 184. Similarly, the exemplary chamber air outlet 204 of FIG. 2 includes an outlet port 208 opening from the chamber 184. It will be appreciated that the chamber air inlet 202 and the chamber air outlet 204 may each be any suitable inlet or outlet (e.g., a tangential inlet for a cyclone), and may be at any particular location on the air treatment chamber 184.

In some examples, the chamber air inlet 202 and/or the chamber air outlet 204 are arranged at the first and/or second ends 190, 192 of the chamber 184. Referring to FIG. 2, the exemplary air inlet 202 is provided at the first end 190 (front end) and the exemplary air outlet 204 is provided spaced from the first end (e.g., rearward), e.g., at the second end 192. Alternatively, the air outlet 204 and air inlet 202 may be provide at a common end, e.g., an upper end or a lower end of a vertically extending chamber or the front end or the rear end of a horizontally extending chamber.

The air treatment assembly 180 includes a dirt collection region 210. It will be understood that the air treatment member 182 and dirt collection region 210 may be of any configuration suitable for separating dirt (i.e., dust and/or liquid) from an air stream and collecting the dirt and/or liquid. In accordance with this disclosure, a surface cleaning apparatus may use one or more of the different aspects of an air treatment member 182 and a dirt collection region 210 discussed herein.

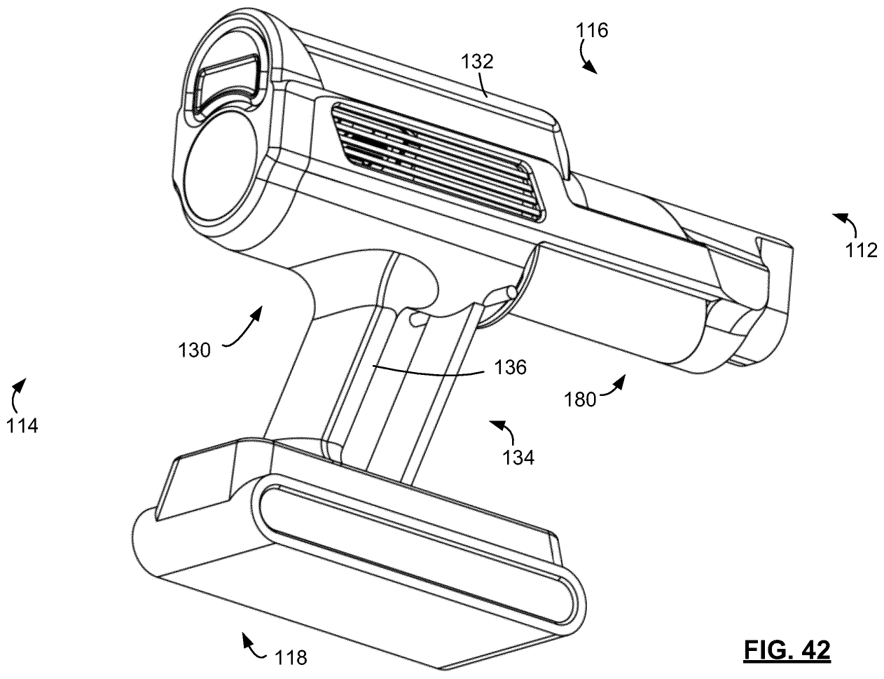

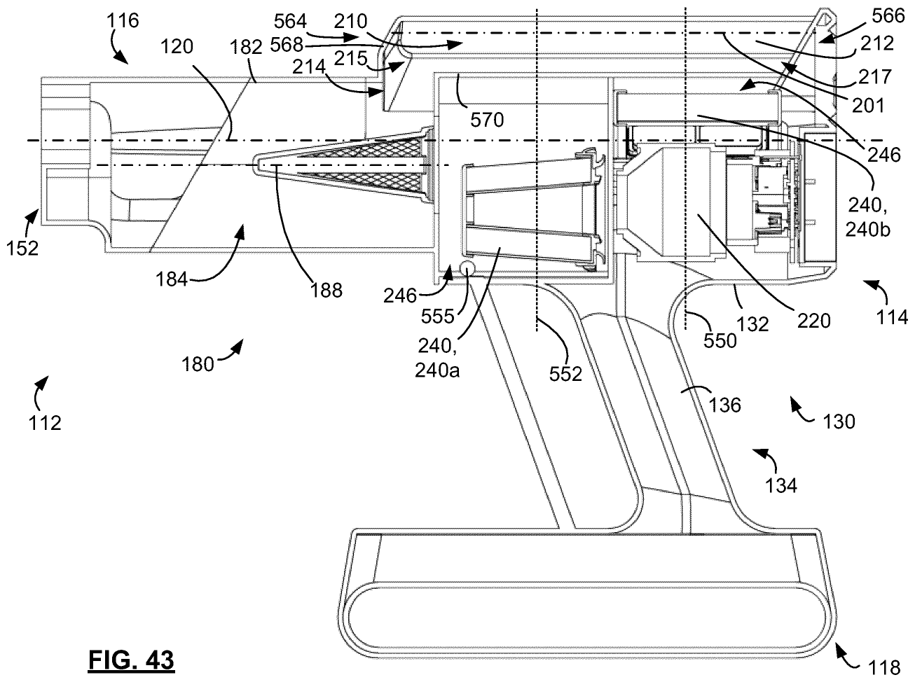

As exemplified in FIG. 2, a dirt collection region 210 may be an internal region of an air treatment chamber 184. The dirt collection region 210 may be at the bottom end of the air treatment chamber 184. Alternatively, as exemplified by the air treatment members 210 of FIGS. 43 and 58, a dirt collection region 210 may be a dirt collection chamber 212 that is external to an air treatment chamber. If the dirt collection chamber 212 and the air treatment chamber 184 are discrete chambers, the dirt collection chamber 212 communicates with the air treatment chamber 184 via one or more dirt outlets 214 (e.g., an opening in a wall of the air treatment chamber or a gap between walls of the air treatment chamber).

It will be appreciated that a dirt outlet 214 may be at various locations, depending, inter alia, on the location of the air inlet and/or air outlet of the chamber 184. The dirt collection chamber 212 may be above the air treatment chamber 184 (e.g., as shown in FIG. 43). Alternatively, the dirt collection chamber 212 may be below the air treatment chamber 184 (e.g., as shown in FIG. 58). The dirt outlet 214 may be at a lower end of the dirt collection chamber 212 (e.g., as shown in FIG. 43). Alternatively, the dirt outlet 214 may be at an upper end of the dirt collection chamber (e.g., as shown in FIG. 58). The dirt outlet 214 may be at a lower end of the air treatment chamber 184 (e.g., as shown in FIG. 58). Alternatively, the dirt outlet 214 may be at an upper end of the air treatment chamber 184 (e.g., as shown in FIG. 43).

The dirt collection chamber 212 may be of any suitable shape, such as generally cuboid or generally cylindrical or generally annular (partially annular or fully annular). The exemplary dirt collection chamber 212 has a long dimension extending along a longitudinal axis 201. The longitudinal axis 201 extended between a first end 215 and a second end 217 opposite the first end 215. The dirt collection chamber 212 may be an upwardly-downwardly extending chamber (i.e., the long dimension of the chamber). Alternatively, the dirt collection chamber 2012 may be a forwardly-rearwardly extending chamber. In some examples, as exemplified by the orientation of FIG. 43, the first end 215 is a forward end and the second end 217 is a rearward end when the apparatus upper end 116 is above the apparatus lower end 118. The longitudinal axis 201 may be generally parallel to the treatment chamber axis 188.

The dirt collection chamber 212 may be of any suitable construction. The dirt collection chamber is formed by a set of dirt chamber walls. The dirt chamber walls 216 may be flexible and/or rigid as discussed elsewhere herein in accordance with an aspect of this disclosure. The exemplary dirt collection chamber 212 of FIG. 43 includes a rigid container. The exemplary container of FIG. 58 includes one or more flexible wall portions.

It will be appreciated that the air treatment assembly 180 may include any suitable number of dirt collection regions 210, such as a dirt collection region 210 for each air treatment chamber 184 if a plurality of air treatment chambers 184 are included, or for each air treatment stage if a plurality of air treatment stages are included, e.g., a single dirt collection chamber that is external to one or more air treatment chambers of an air treatment stage. It will be appreciated that, in some examples, multiple air treatment chambers may share a dirt collection region (e.g., two cyclones each with a dirt outlet opening into a common dirt collection chamber), and/or an air treatment chamber may be in communication with two or more discrete dirt collection regions by a plurality of dirt outlets. Accordingly, the air treatment assembly 180 and/or an air treatment chamber thereof may include separate collection regions for different types of dirt (e.g., fine dust, coarse debris, and/or liquid), and/or separate dirt outlets to a common dirt collection chamber for different types of dirt.

The treatment assembly 180 may be openable and/or removeable from the main body, e.g., to allow for collected material to be removed. Opening the assembly 180 may involve opening one or more of an air treatment chamber 184, a dirt collection region 210, and a dirt collection chamber 212, concurrently or sequentially. A chamber or region may be opened by any means known in the vacuum cleaner art. For example, a first part of a wall defining the chamber may be moveable relative to a remainder of the wall which defines the chamber and it may be removable therefrom. Alternatively, the assembly or a chamber thereof may be moveable relative to a main body of the apparatus 100, the movement opening an end or port of the assembly or chamber.

As exemplified in FIGS. 2 and 7, an openable air treatment chamber 184 includes an openable portion 181 of a wall of the chamber (which may be generally planar such as a door). One or both of the member end walls (e.g., forward and/or rear walls), or a portion of one or each of the member end walls, may be openable. Opening an end of the chamber may facilitate access to the member air inlet and/or air outlet. Alternatively, or additionally, the member sidewall or a portion thereof may be openable. Referring to FIG. 2, the exemplary air treatment member 182 includes an openable portion 181 moveable between a closed position (FIG. 2) in which a dumping or evacuation port 183 is closed and an open position (FIG. 7) opening the dumping or evacuation port 183. The openable portion 181 may be removeable and/or moveable (e.g., pivotable or rotatable about a hinge, translatable, etc.) between a closed and an open position. As exemplified in FIG. 2, the openable portion 181 may be joined (mounted) to a wall of the air treatment assembly 180 (e.g., to the sidewall 198) by a hinge about which it moves between the open and closed positions. As exemplified by the air treatment member 182 in FIG. 2, openable portion 181 may include at least a portion of the air treatment member end wall (e.g., the first end wall 194). It will be appreciated that the member end wall may be secured to the member sidewall in any suitable way, such as via a friction fit or a releasable fastener (e.g., a clasp) and it may be removable and/or rotationally (e.g., pivotally) openable.

Additionally, or alternatively, the air treatment assembly as a whole may move relative to the main body between a closed in-use position (e.g., FIG. 43) and an open emptying position (e.g., FIG. 44). Any suitable emptying position may be used. The air treatment assembly 180 may move about a hinge or other connection point connected to the main body 132 when moving between the open and closed positions, e.g., with the assembly 180 remaining attached to the main body 132 in the open position with an openable portion or end of the assembly 180 opened by movement relative to the main body 132. Alternatively, the air treatment assembly may be removed from the main body 132 to the open position.

The air treatment chamber 184 and the dirt collection region 210 or a dirt collection chamber may be accessed through a common selectively openable doorway or they may be separately openable, such that one may be opened while the other remains closed. In some examples only one of the dirt collection chamber 212 and the air treatment chamber 184 is openable, and in some examples the other is emptiable into (e.g., selectively openable to) the openable one.

Referring again to FIG. 2, the surface cleaning apparatus 100 also includes an air moving member 220. The air moving member 220 is positioned in the apparatus air flow path 150. The air moving member 220 is provided to generate air flow (e.g., vacuum suction) through the air flow path 150. The air moving member 220 may include a suction motor and fan assembly 222. As exemplified in FIG. 2, the motor and fan assembly is a suction motor and fan assembly 222 that includes a motor and at least one fan. At least one of the fan(s) is positioned in the apparatus air flow path 150. Any suitable assembly 222 may be used. For example, the suction motor and fan assembly 222 may be a bypass assembly, in which the motor is sealed apart from the air flow path, e.g., to reduce the risk of exposure to liquid carried in the air flow path.

The air moving member 220 may be contained within a moving member housing 230. The moving member housing 230 may form part of the outer surface of the main body housing 132, or may be internal thereto. The moving member housing 230 may be of any suitable construction, including any of those exemplified herein.

The air moving member 220 in the illustrated example is positioned downstream from the air treatment assembly 180, although it will be appreciated that the air moving member 220 may be positioned upstream of the air treatment assembly 180 or an air treatment member thereof (e.g., a dirty air motor) in alternative embodiments. Accordingly, the air moving member may be a clean or dirty air motor and fan assembly.

As exemplified, in some embodiments the air moving member 220 rotates about a moving member axis of rotation 232 (e.g., a suction motor axis of rotation). In some examples, when the apparatus upper end 116 is positioned above the apparatus lower end 118, the moving member axis of rotation 232 is oriented generally horizontally and extends between the apparatus forward end 112 and the apparatus rear end 114. The moving member axis of rotation 232 may be generally parallel to the apparatus longitudinal axis 120. In some examples, the moving member axis 232 is generally parallel to the axis of rotation of at least one air treatment chamber. In other examples, however, the moving member axis of rotation 232 may extend at any angle to the horizontal, or it may extend vertically. Accordingly, the air moving member 220 may be oriented in any direction within the surface cleaning apparatus 100.

As noted previously, the surface cleaning apparatus 100 may also include one or more filters 240 in the air flow path of the surface cleaning apparatus 100. The filter 240 may have any suitable shape (e.g., donut, planar, arcuate, etc.), including the examples disclosed herein. In some embodiments, a filter 240 includes or consists of a body of filter media 244. A filter 240 may be one or more of a foam filter, felt filter, HEPA filter, other physical filter media, electrostatic filter, and the like. Optionally, a filter 240 includes a series of screens, and, optionally, each downstream screen of the filter has finer pores than the preceding upstream screen. The filter 240 may be formed from any suitable physical, porous filter media.

Referring to FIG. 2, in some embodiments the filter 240 also includes a media holder 242 supporting the filter media and/or guiding airflow through the body of filter media 244. Any suitable media holder 242 may be used. The media holder 242 may be formed of a generally rigid material, such as a hard plastic or a metal. The media holder 242 may touch the media 244 along an edge, end, and/or face of the media, and may optionally be secured to the media in one or more places. In some embodiments, the body of filter media extends between a first end 244a and second end 244b along a filter axis 248 (e.g., an axis extending along a longest dimension). The media holder 242 may be attached to one or both axial ends 244a, 244b of the filter media 244. Attaching the media holder to one or both axial ends may, e.g., support the ends and/or close the ends to direct air through the filter in a direction generally transverse to the axis.

A filter with a media and holder may be of any suitable shape, such as a generally planar filter media supported along edges thereof or an arcuate filter with the media held in an arcuate shape by the filter holder. In some examples, the filter 240 may be a donut filter with a body of filter media surrounding a central cavity 254. The axis 248 of a donut filter may be a central axis extending through the central cavity 254. The body of filter media surrounding the central cavity 254 may be, e.g., a cylindrical or frusto-conical body of filter media. The media holder 242 may close one end of the donut filter 240 while leaving an airflow opening 256 through the opposite end, e.g., to direct airflow radially in through the filter media 244 into the internal cavity 254 and out through the opening 256 or vise versa. It will be appreciated that in some embodiment a filter 240 does not include a media holder, and a desired shape of the filter may be achieved by, e.g., the shape of the filter media itself and/or the shape of the filter housing in which the media is housed in use.

The surface cleaning apparatus 100 may include a pre-moving member (pre-motor) filter upstream of the moving member 220 (e.g., the exemplary filter 240 of FIG. 2) and/or a post-moving member (post-motor) filter downstream of the moving member. A pre-moving member filter may remove dirt (e.g., fine dust) that could otherwise damage the moving member 220, such as by accumulating on fan blades or interfering with motor movement. A post-moving member filter removes dirt (e.g., carbon dust from the motor) that would otherwise be released by the surface cleaning apparatus 100. It will be appreciated that the surface cleaning apparatus 100 may have any suitable number of filters 240.

A filter 240 may be provided in a filter housing 246. The filter housing 246 may be of any suitable construction, including any of those exemplified herein. The filter housing 246 may be openable or accessible to allow the filter 240 to be cleaned and/or replaced. As exemplified, the moving member axis of rotation 232 may intersect the volume defined by one or more filter housings 246. In some embodiments, the moving member axis of rotation 232 intersects the volume defined by at least one filter housing 246 of a pre-moving member filter 240 received in the main air flow path 150. A filter housing 246 (e.g., of a post-motor filter) may form part of the outer surface of the main body housing 132. A post-moving member filter may be located radially outwards of the moving member 220, as exemplified by the post-moving member filter 240b illustrated in FIG. 43.

Referring to FIG. 2, in some embodiments, a filter (e.g., pre-motor filter 240a) is nested fully or partially in an air outlet 204 (e.g., vortex finder, screen) of an air treatment chamber. The nested filter may be an axially extending filter, extending generally parallel to the air treatment chamber axis 188. Air flow in a surface cleaning mode may enter the nested filter generally radially. The nested filter may be partially or fully nested in a porous member (e.g., a screen) of the air outlet. Air flow through the porous member of the air outlet may also be generally radial during a surface cleaning operation. The porous member 340 may form part of the housing of the nested filter.

A pre-moving member filter 240a and/or a post-moving member filter 240b may come in any suitable shape and be at any suitable location.

Referring again to FIG. 2, power may be supplied to the surface cleaning apparatus 100 (e.g., to components or elements such as the air moving member 220) in any suitable way. Power may be supplied from an external source. For example, the surface cleaning apparatus 100 may include a power cord that is connectable to household mains. Optionally, the power cord may enter the main body housing 132 at a rear end 114 of the housing. However, it will be appreciated that the power cord may be provided at any location in the surface cleaning apparatus 100. Referring to FIG. 2, it will be appreciated that the power source may alternatively, or additionally, include one or more on-board energy storage member(s) 250 (e.g., a battery, a capacitor, optionally a plurality which may be provided in a pack such as a removable pack).

An actuator is provided to turn the surface cleaning apparatus on and off. As exemplified in FIG. 5, it will be appreciated that the surface cleaning apparatus 100 may include a user interface 178. The user interface 178 may be part of a main control system 252 of the surface cleaning apparatus 100. The main control system 252 controls operation of the air moving member. As exemplified, the user interface 178 may be single power on/off button. Alternately, it may be a touch screen interface and/or include a display screen. The main control system 252 may include a circuit joining the power on/off button to the air moving member 220 to control operation of the air moving member 220. However, it will be appreciated that any suitable control system 252 may be used. For example, a control system may include a more complex user interface with multiple buttons, switches, and/or screens (e.g., one or more soft buttons provided on a touchscreen). As another example, the control system may include one or more onboard processors communicatively coupled to one or more on board data storage systems storing instructions, such as to respond to a user selection from between two or more operational modes (e.g., a carpet mode and a hard floor mode or a low pile carpet mode, a high pile carpet mode, and a hard floor mode, which may determine a motor rotation speed, brush roll rotation speed, and/or brush roll positioning) or to respond to sensor input from an onboard sensor (e.g., responding by changing the speed of rotation of the air moving member 220).

As exemplified, the user interface 178 may be provided at the apparatus rear end 114. Optionally, the user interface 178 is provided on a rearwardly facing surface of the main body housing 132. The user interface may face rearwardly (i.e., visible when looking forward at the surface cleaning apparatus 100 when the apparatus is in use). A user interface at the apparatus rear end 114 is more readily accessible to a user than a user interface at the apparatus front end 112. As exemplified, the user interface may be provided adjacent the carry handle 134, and optionally on the carry handle 134. A user interface adjacent the carry handle may be readily accessible to a user that is already interacting with the carry handle. However, it will be appreciated that the user interface 178 may be provide at any position on the surface cleaning apparatus 100.

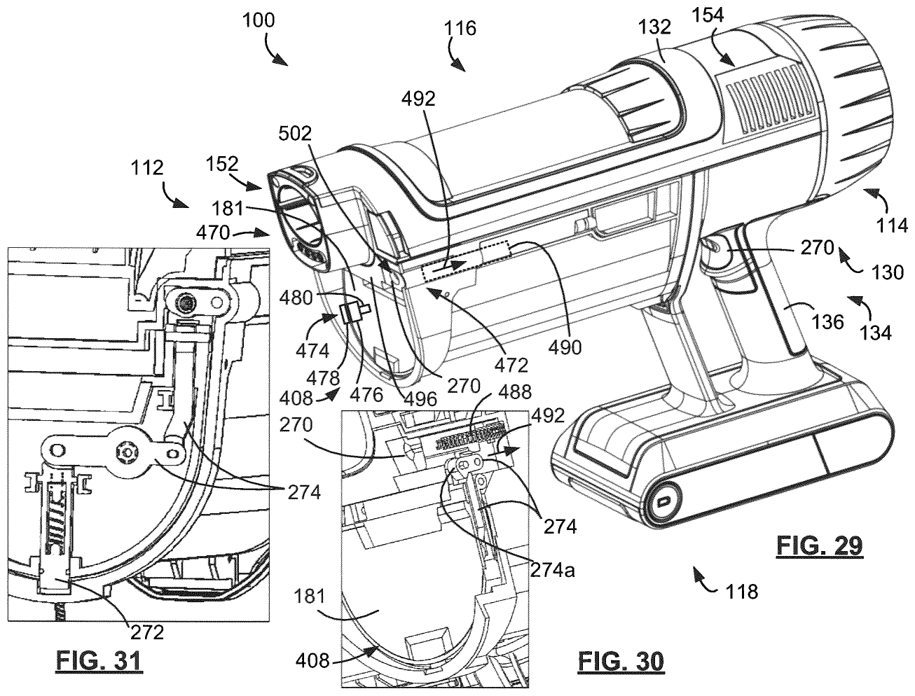

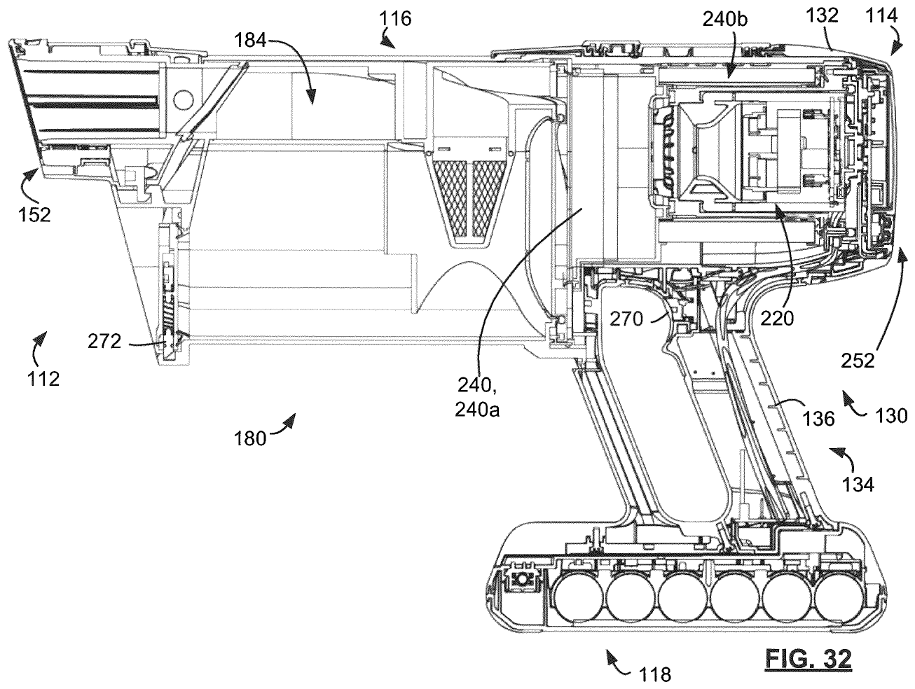

Referring now to FIGS. 29-31, the surface cleaning apparatus 100 may include one or more actuators 270. As exemplified in FIGS. 29 and 31, an actuator 270 is drivingly connected to an operated device 272 (e.g., a lock member, an openable portion, a flap, etc. as discussed elsewhere herein) of the surface cleaning apparatus 100 to operate the operated device 272. Any moveable component of the surface cleaning apparatus 100 may be an operated device operated by an actuator. The actuator 270 may be drivingly connected to the operated device 272 in any suitable way, e.g., mechanically drivingly connected (i.e., via a mechanical linkage or mechanical driving member 274), pneumatically drivingly connected (e.g., via an air flow path, such as an air flow path within a piston chamber pressurised by movement of a piston), magnetically drivingly connected or electromechanically connected, e.g., a solenoid.

An actuator 270 may be an automatic actuator responsive to a sensed condition (e.g., a pressure of the air flow path 150 or a predetermined programmed condition such as a period of time elapsed since the air moving member was powered on), or the actuator may be a user-controlled actuator responsive to a user action (e.g., a button press, lever movement, accessory attachment or removal, or vacuum mode selection such a selection between a bag-in cleaning mode and a no-bag cleaning mode). The actuator 270 may be a powered actuator receiving power from a power source of the surface cleaning apparatus 100. The actuator may be a condition-responsive actuator responsive directly to a change in a condition, such as a flexible diaphragm adjacent the air flow path 150 responding directly to pressure changes in the air flow path. The actuator 270 may be a manual actuator, such as moved by a lever or button that is operated by being slid or pushed by a user.

The actuator 270 may be communicatively coupled to the main control system 252 to send and/or receive information. The actuator may receive instructions and/or power from the main control system 252. Alternatively, the actuator may be controlled by a discrete control system separate from the main control system 252, such as a simple circuit. A simple circuit may not include a processor or a data storage device, such as a circuit with a toggle (e.g., a switch, slider, or button) that closes the circuit when activated and breaks the circuit when deactivated. For example, an actuator may itself close a circuit to actuate a solenoid (e.g., a conductive member moved into position closing the circuit and biased out of position).

It will be appreciated that the apparatus 100 may also be used in an evacuation mode in which the air flow direction through one or more components of the apparatus 100 (e.g., the filter, the air treatment assembly, the air treatment chamber, and/or the dirt collection region) is reversed. An evacuation air flow may be driven by the air moving member 220 of the apparatus 100 (e.g., operated in reverse or after reconfiguring the air flow path) or by an external air moving member. In an evacuation mode, air flows through the air treatment member from, e.g., the air outlet 204 to an evacuation outlet from the apparatus 100. The evacuation outlet 408 includes an evacuation door. The evacuation door may be the air inlet 202, or a separate evacuation door (e.g., evacuation port 183) or the openable portion. The evacuation door may be selectively openable, opened during an evacuation mode, e.g., to carry the evacuation air flow out of the air treatment chamber bypassing the chamber air inlet. The chamber air inlet may be closed while the evacuation air outlet is open. A separate evacuation air outlet allows the air flow characteristics of evacuation air flow exiting the air treatment chamber to be adjusted separately from the air flow characteristics of surface cleaning air entering the air treatment chamber. An evacuation air flow may be steady and/or variable (e.g., pulsed in a regular pattern or pulsed irregularly).

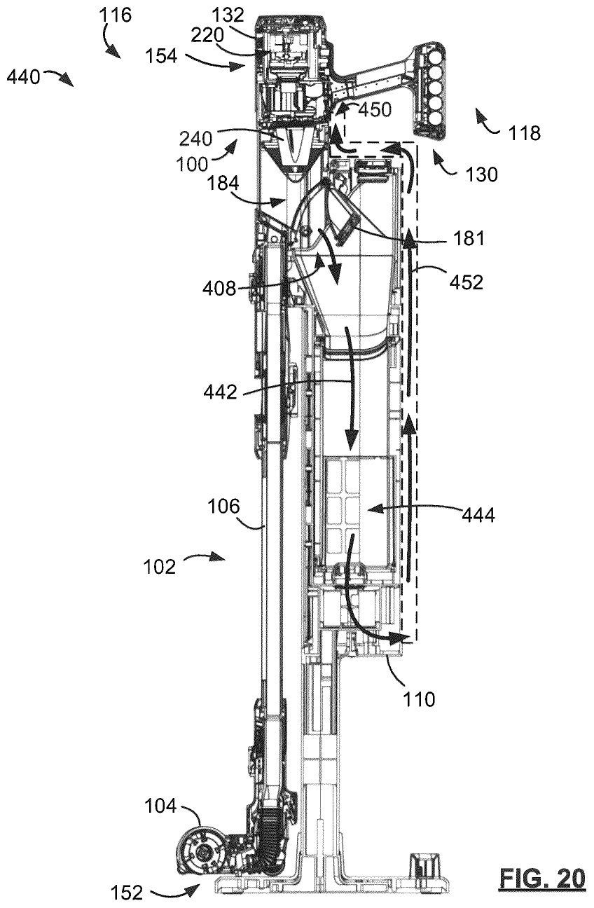

The apparatus 100 may be part of a system 440 which also includes a cooperating docking station 110. Referring to FIG. 19, the docking station 110 has a docking station air flow path 442 extending through an air treatment member 444. Optionally, the docking station 110 has an air moving member 446. Alternatively, the air moving member 220 of the apparatus 100 is used to move air through the docking station air flow path 442 (e.g., by reversing the direction of rotation of the air moving member 220 and/or reconfiguring the air flow path within the apparatus 100). The docking station air flow path 442 extends from a docking station inlet 448 to a docking station outlet 450. The docking station inlet cooperates with the evacuation outlet 408 of the surface cleaning apparatus 100 to receive airflow from the apparatus 100. The docking station outlet 450 may be to ambient or back to the apparatus 100. Referring to FIG. 20, in some embodiments the docking station air flow path 442 has a return air portion 452 leading back to the surface cleaning apparatus 100. The docking station air flow path 442 may return air to the apparatus 100 to be outlet to ambient from the apparatus 100. Optionally, the air flow path within the apparatus 100 is reconfigured in an evacuation mode so that the air moving member 220 is downstream of the return portion 452, such as described elsewhere herein.

### Detailed Discussion of Particular Features

The foregoing general description is intended to provide a basis for understanding several of the aspects that are discussed herein. It will be appreciated that any embodiment, such as the example embodiments described herein, may use any one or more of the aspects as described in the general description. Similarly, any embodiment may use any one or more of those features as described in greater detail in the following detailed discussion of particular configurations.

The following is a discussion of a number of aspects, including a media holder which does not overlie the media in an air flow direction, a filter holder with sidewalls radially spaced from a donut filter media, a selectively bypassed porous member, an air directing structure in a filter internal cavity, concentrated evacuation air stream on a dirt bearing member, a mode-dependent bleed upstream of a brush motor, a dock evacuation air flow which returns through a docked surface cleaning apparatus, unlocking by docking, an evacuation burst, a small air flow path into the dock, a dirt transfer section between a docked surface cleaning apparatus dirt collection chamber and a dock treatment member of decreasing size along an air flow direction, a second stage collection region evacuation door, a rearwardly extending dirt collection, an expandable dirt outlet, a separately movable porous member and door, a dock dirt collection region supported above a floor, and a horizontal treatment chamber with a vertical pre-motor filter, which are disclosed herein. Each aspect may be used by itself or in combination with one or more of the other aspects disclosed herein.

Media Holder does not Overlie the Media in an Air Flow Direction

A hand vacuum cleaner using any one or more aspects discussed herein, including one or more of the other aspects set out herein in the general description and/or the detailed discussion, may have a filter media holder of a filter which is shaped such that it does not overly the filter media in a direction of airflow through the filter media. The media holder or a portion thereof may be at an end of the filter media with the filter media extending generally axially from the media support or portion thereof, with an airflow direction generally transverse to the axis along which the media extends. In some embodiments, the filter is a donut filter and the direction of airflow through the filter media is a radial direction, and the filter media is radially open. The media holder may support one or both ends of the donut filter without radially overlying the filter media at one or both ends.

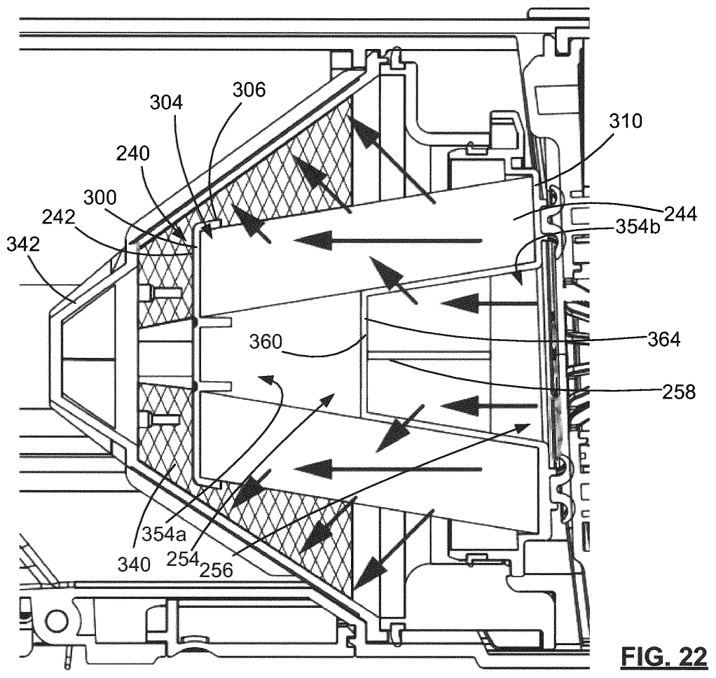

Referring to FIG. 22, when the holder 242 overlies the filter media 244 in a direction of air flow, the overlain portion 304 of the media 244 is not used efficiently. Overlying the filter media in a direction of airflow may reduce the effective size of the filter media. In some embodiments, an overlain portion 304 can become a dirt trap. Dirt may become trapped between an end member 300 and an axially extending wall, e.g., an axially extending flange 306. Dirt may be driven into the overlain portion 304 during normal operation of the apparatus 100 or when airflow direction is reversed (e.g., during an evacuation mode).

Referring now to FIG. 2, keeping the media open at the upstream side in a direction 314 of air flow through the media allows the media to work more effectively. This may be done by, e.g., omitting a portion of the media holder 242 that overlies the media 244 in the direction of airflow (e.g., removing the axially extending wall). The direction 314 may be reversable (e.g., between a normal operating mode and an evacuation mode), and the upstream side during normal operation may be kept open. Optionally, the filter media 244 is also kept open at the downstream side in one or both modes.

Referring still to FIG. 2, the media holder 242 of the filter 240 includes a first end member 300. The end member 300 may be air impermeable (e.g., formed of hard plastic). The end member 300 may be an end cap closing the end of the filter media and/or closing the end of the filter as a whole. The end member 300 includes an axially inward side 300a and an axially outer side 300b. The first end 244a of the filter media 244 is located at the first end member 300. In some embodiments, the first end 244a abuts and/or is secured to the first end member 300. The filter media 244 extends axially inward from the first end member towards the second end 244b. The filter media 244 includes an upstream surface. The exemplary filter 240 of FIG. 2 is a donut filter, and the upstream surface in normal operation of the apparatus 100 is a radially outer surface 308. The radially outer surface 308 is generally open at the first end. The holder 242 does not overly the radially outer surface 308 at the first end 244a. The end member 300 includes an axially inward side 300a and an axially outer side 300b. In some embodiments, the axially inward side 300a and/or the axially outward side 300b is generally planar. In some embodiments, the axially inward side 300a terminals axially outward of the media 244.

In some embodiments, the holder 242 also includes a second end member 310. The end member 310 may be air impermeable (e.g., formed of hard plastic). The second end member may be an end cap closing the end of the filter media and/or closing the end of the filter as a whole. The second end cap may include an aperture opening into the central cavity of a donut filter. The second end 244b of the media 244 is located at the second end member 310. In some embodiments, the second end 244b abuts and/or is secured to the second end member 310. The media 244 extends axially inward from the second end member 310 towards the first end member 300. The upstream outer surface of the media 244 is open at the second end 244b. The media holder 242 does not overly the outer surface 308 at the second end 244b. The second end member 310 has an axially inner side 310a and an axially outer side 310b. In some embodiments, the axially inward side 310a and/or the axially outward side 310b is generally planar. In some embodiments, the axially inward side 310a terminals axially outward of the media 244.

Referring to FIG. 25, the media 244 may be a pleated porous filter media. The pleated porous filter media has a plurality of generally axially extending recesses 320 positioned between opposed generally axially extending sidewalls 322. At the position of the first end member 300 and/or the second end member 310, the generally axially extending recesses 320 are radially open. In some embodiments, the axially inward side 300a of first end member 300 terminals axially outward of the recesses 320. In some embodiments, the axially inward side 310a of second end member 310 terminals axially outward of the recesses 320.

Referring again to FIG. 2, in some embodiments the media 244 is secured to the holder 242. The media 244 may be secured in any suitable way, such as by mechanical or magnetic fasteners. The media 244 may be glued to the holder 242. FIG. 2 illustrates an exemplary glue layer 330 between an end of the media and the adjacent end member of the holder 242. Optionally, both of opposite ends of the media are secured to the holder 242. However, it will be appreciated that in some embodiments the holder 242 may hold the media 244 without being secured thereto, such as if the media is held between members of the holder 242 in a friction fit.

The downstream face of the media 244 may also be generally open. Referring to FIG. 2, the radially inner surface 316 is generally open at the second end 244b. The holder 242 does not overly the inner surface 316 at the second end 244b. The holder 242 includes connecting members 334 (e.g., struts) joining the first and second end members 300, 310. The connecting members 334 extend down to the second end 244b, but otherwise the media 244 is open. The exemplary holder 242 does overly the media 244 in a direction of a reversed air flow (e.g., the direction of the evacuation air flow 400 of FIG. 7) at the first end 244a. It will be appreciated that in some embodiments this portion of the media 244 may also be open. Where the holder 242 does overly a portion of the media 244 is a direction of air flow, it may only when the direction is reversed (e.g., not during normal operation when maximum filter media efficiency is needed) and/or at the end of the media farthest from the end of the filter housing at which the air enters the filter housing.

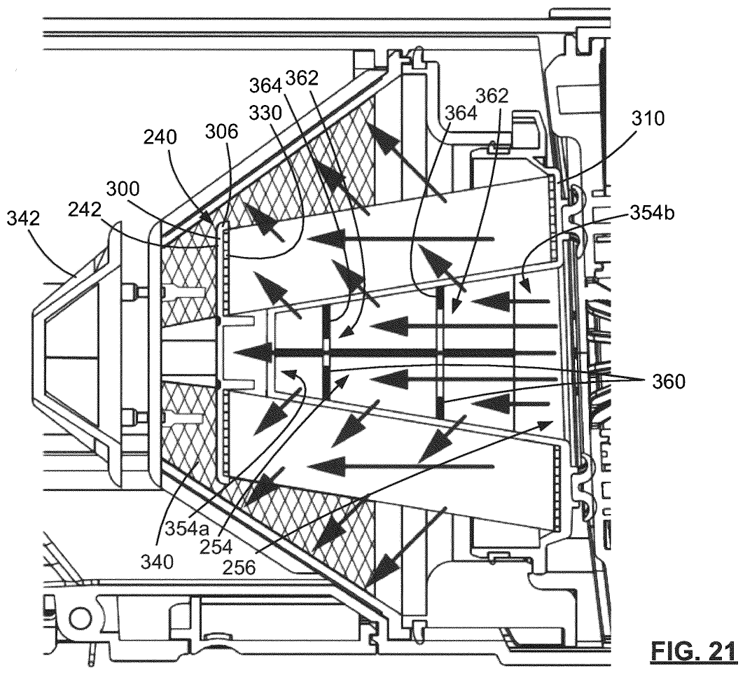

In some embodiments, an end member of the holder 242 does include a small axially extending wall overlying the media in a direction of air flow, e.g., for greater mechanical support. Referring to FIG. 21, in some embodiments, a glue-saturated portion 332 of the filter media 244 is overlain by the holder 242, e.g., for greater mechanical support. The axially extending wall 306 may extend no further than the glue-saturated portion 332. Additionally, or alternatively, the axially extending wall 306 may extend over the media 244 less than 10%, less than 5%, or less than 3% of the axial length of the body of filter media and/or less than 5 mm, less than 4 mm, or less than 3 mm.

Filter Holder with Radially Spaced Sidewalls

A hand vacuum cleaner using any one or more aspects discussed herein, including one or more of the other aspects set out herein in the general description and/or the detailed discussion, may have a filter holder wherein the filter holder is configured to provide an open volume immediately overlying the upstream side of the filter material. As such, during a cleaning operation, dirt may collect on the upstream side of the pre-motor filter. If the pre-motor filter is corrugated, then dirt may accumulate in the valleys between the peaks of the pleated filter media. During an evacuation mode in which air is passed in a reverse direction through the pre-motor filter, the air will pass from the cleaning mode downstream side of the pre-motor filter media (the evacuation mode upstream side) through the pre-motor filter media to the cleaning mode upstream side of the pre-motor filter media (the evacuation mode downstream side). If any portion of the filter holder is located adjacent the cleaning mode upstream side, e.g., a flange extending along a portion of the filter media, then dirt that has collected on a portion of the filter media, e.g., a portion of a valley, underlying the flange of the filter holder, may tend to be retained on the filter during the evacuation mode.

In accordance with this aspect of the disclosure, a filter housing 246 that is provided to house a filter, such as a donut filter 240, or a filter holder 242 for holding the filter, when the apparatus 100 is in use is shaped to provide a minimum radial clearance between the radially outer (upstream during a cleaning mode) face of the filter media and a directly overlying wall of the housing 240 (or holder 242) . . . . A minimum radial clearance encourages an evacuation (reverse) air flow through that portion of the filter by providing a volume through which air on the evacuation mode downstream side of the filter media may pass to assist in removing dirt that has accumulated on that portion of the filter media.

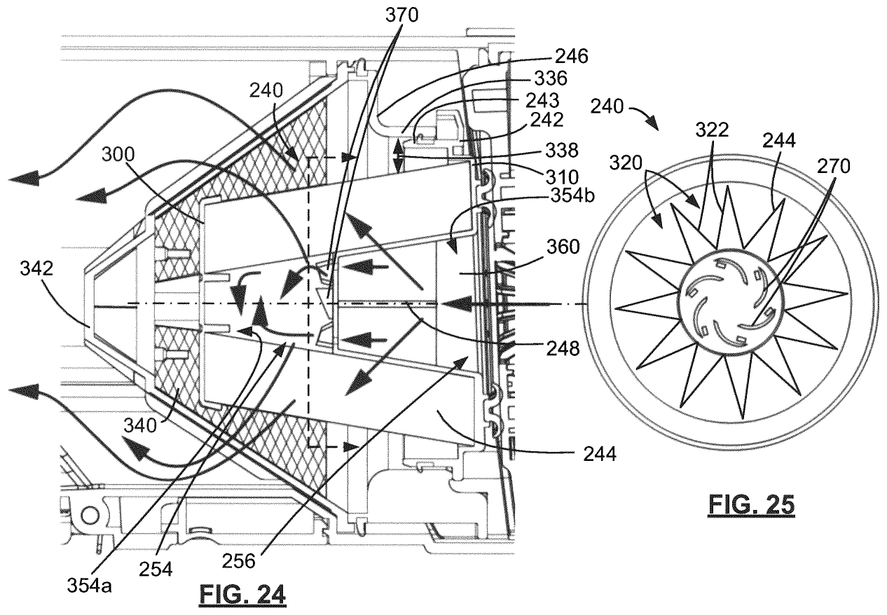

Referring to FIGS. 24-27, The filter is a frusto-conical pleated filter with peaks and valleys each extending in the direction of filter axis 248. The filter housing 246 has a sidewall 336 radially outward of the filter 240 relative to the filter axis 248. The filter 240 includes a filter media 244 and a media holder 242. A portion of the media 244 at the end 354b that is at an upstream end of the central opening in the filter media when evacuation air flow 400 enters the central opening in an evacuation mode of operation may be directly overlain by a portion of the holder 242, such as exemplified in FIG. 24. For example, the holder 242 may have an axially extending flange 243 extending over radially outer surface of the media 244 from the end 354b. Beyond the holder 242, however, the sidewall 336 of the filter housing 246 overlies the media 244 directly (i.e., with no intervening walls).

Referring to FIGS. 24, 26 and 27, the sidewall 336 directly overlying the filter media 244 is spaced by a minimum spacing 338 from the media 244 at the end 354b. Similarly, the flange 243 is also spaced about the same distance from the filter media. The spacing 338 may be at least the radial thickness of the media 244. The spacing 338 may be at least half the minimum cross sectional air flow area of the opening 256.

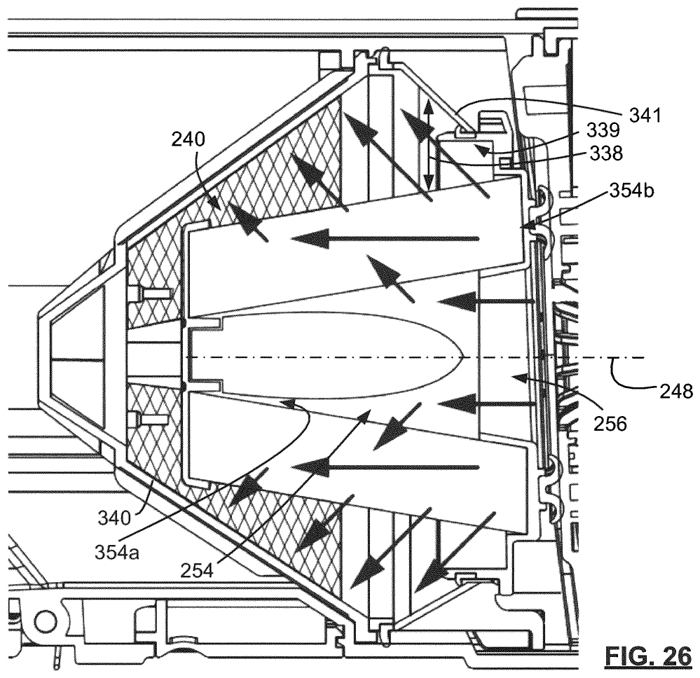

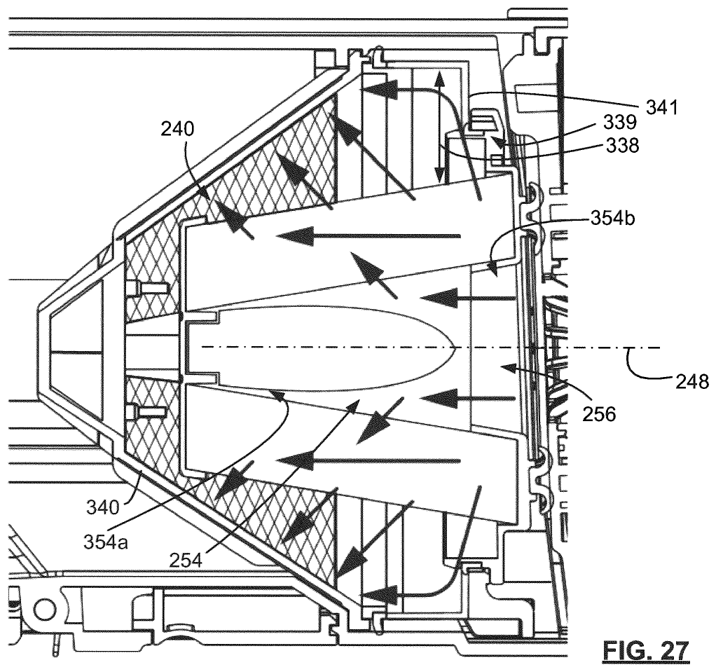

As exemplified in FIG. 24, the spacing 338 may be relatively small where the sidewall 336 extends generally axially from a mounting point 339 at which the filter 240 is mounted to the housing 246. Referring to FIGS. 26 and 27, in some embodiments, the housing 246 includes a portion 341 between the mounting point 339 and the point directly overlying the media 244 that extends in a direction that includes a radial component. In some embodiments, this portion 341 extends radially (e.g., FIG. 27) or at an angle to the filter axis 248 (e.g., FIG. 26). It will be appreciated that the portion 341 may be planar or curved.

Accordingly, air passing through the filter media during an evacuation process may pass through all portions of the filter media at end 354b and thereby assist in removing dirt from the rear end of the filter media.

It will be appreciated that alternately, or in addition, the opposed (front end) of the filter holder and/or filter housing may be similarly shaped.

### Selectively Bypassed Porous Member

A hand vacuum cleaner using any one or more aspects discussed herein, including one or more of the other aspects set out herein in the general description and/or the detailed discussion, may be operable to enable some or all of an evacuation air flow to travel through the filter housing without passing through a porous member, e.g., a filter media such as a pre-motor filter and/or a screen, during part or all of an evacuation mode of operation.

In accordance with this aspect of the disclosure, the apparatus 100 includes an air treatment chamber outlet covered by a porous member (e.g., a screen), and the outlet is selectively openable to allow air to bypass the porous member during part or all of an evacuation operation. The selectively openable outlet may be closed during a first portion, e.g., a first portion, of an evacuation mode of operation to force air to pass through the porous member, and opened during a second portion of the evacuation mode of operation to reduce backpressure on airflow by allowing air to bypass the porous member.

In a normal cleaning operation, the selectively openable outlet is closed and the air flow path 150 extends through the porous member. In an evacuation mode, the selectively openable outlet is opened so that air can bypass the porous member. In some embodiments, the apparatus 100 includes two evacuation modes, a first in which the selectively openable outlet is closed so that the reversed air flow blows dirt off the porous member and a second in which the selectively openable end is opened so that the reversed air flow bypasses the porous member.

Referring to FIG. 2, the outlet 204 comprises a porous member 340 that overlies an outlet port in the rear end wall of the air treatment chamber. During a cleaning mode of operation, the air flow path 150 extends through the porous member 340 to remove any large dirt that may otherwise be carried out of the air treatment chamber. The exemplary porous member 340 is a screen. A portion of the air outlet 204 is selectively openable. As exemplified, the porous member 340 has a valve member 342 that is moveable between a closed position (FIG. 2) and an open position (FIG. 21). In the open position, a portion of the porous member 340 is open to allow airflow to bypass the porous member 340.

In use, the porous member 340 is closed in a normal surface cleaning mode to require air flow out through the porous member 340. In an evacuation mode, the porous member 340 is open. The apparatus 100 may include multiple modes of evacuation, including a first mode of evacuation in which the airflow direction through the outlet 204 is reversed relative to the surface cleaning mode but the porous member 340 remains closed, and a second mode of evacuation in which the airflow direction through the outlet 204 is reversed relative to the surface cleaning mode and the porous member 340 is open.

The portion 342 may be a portion of the porous member itself, or another portion of the air outlet (for example, a passage enables air to enter the air treatment chamber during part or all of an evacuation operation with passing through the porous member 340, such as an openable port in the rear end wall of the air treatment chamber that the porous member 340 does not overlie).

The exemplary openable portion 340 is an air-impermeable portion of the porous member 340, which may be located at the forward end of the porous member 340. The openable portion, which as exemplified is the valve 342, may form any suitable part of the air outlet 204 or a wall of the air treatment chamber. If the air outlet 204 extends into the air treatment chamber (e.g., including a vortex finder comprising a screen), in some embodiments the openable portion 342 is on an axially inward (forward) end of the air outlet 204 (e.g., vortex finder). In the open position, the openable portion 342 may be downstream from the closed position of the openable portion 342 relative to the evacuation air flow direction. In some embodiments, in the open position, the openable portion 342 is spaced from the open position, the openable portion 342 in the closed position axially (e.g., parallel to the air treatment chamber axis 188). The portion 342 may move between the open and closed positions in any suitable path (e.g., an arc about a hinge point). In some embodiments, the portion 342 moves linearly (e.g., translationally) between the open and closed positions.

In some embodiments, the air flow entering the air treatment chamber through the porous member moves the openable portion to an open position. The portion 342 may be biased by a biasing member 344 (e.g., by a coil spring or resilient fastener) to the closed position. The air flow force may act in a direction opposite to the direction in which the portion 342 moves between the open and closed positions (e.g., opposite to the direction of the biasing force). In some embodiments, the apparatus 100 includes a first evacuation mode in which the force of the air flow is not sufficient to overcome the biasing force and a second evacuation mode in which the force of the air flow is greater and sufficient to overcome the biasing force. In some embodiments, the air moving member 220 is operable at a first power level in which the openable portion 242 is in the closed position and at a second higher power level in which the openable portion 242 is in the open position.

Alternatively, the portion 342 may be moved independently of the force of air flow (e.g., to allow for a strong air flow to blow dirt off the porous member 340). The portion 342 may be opened in any suitable way, such as by an actuator as described elsewhere herein. In some embodiments, the openable portion 242 is moved selectively between open and closed positions without a biasing member biasing the portion to either.

### Air Directing Structure in the Filter Internal Cavity

A hand vacuum cleaner using any one or more aspects discussed herein, including one or more of the other aspects set out herein in the general description and/or the detailed discussion, has an annular filter (e.g., cylindrical, frusto-conical) wherein a flow directing member is associated with the internal cavity of the annular filter (e.g., partially or fully nested therein) to alter a characteristic of the air flow (e.g., one or more of a direction of the air flow in the internal cavity and/or through the filter media, a velocity of the air flow in the internal cavity and/or through the filter media and the distribution of the air along the inner side (upstream side in the evacuation mode) of the filter media) during an evacuation operation.

In accordance with this aspect of the description, a filter 240 with an internal cavity 254 includes a directing member in the cavity to guide air flow within the cavity. The filter 240 is in the surface cleaning mode air flow path 150 and in the air flow path when the direction of air flow is reversed in an evacuation mode. When the direction of air flow is reversed, air flows, e.g., axially into the filter cavity 254 through an opening 256 and radially out of the filter cavity through the filter media. In the evacuation mode the directing member may direct at least some of the air flow entering the open interior of the filter media outwardly through the filter media.

The directing member may be configured to direct the air to improve the removal of dirt from the outer side (upstream side during a cleaning operation) of the filter media. Accordingly, the velocity of the air that reaches part or all of the inner side (upstream side during an evacuation operation) of the filter media may be increased. Alternately, or in addition, the distribution of air over the inner surface may be more even thereby resulting is the evacuation air flow being able to remove dirt more evenly from all parts of the outer surface of the filter media. Accordingly, the directing member may be arranged to more evenly distribute air flow through more, most or all of the axial extent of the filter media.

The directing member may be supported by any part of the hand vacuum cleaner such as by the filter housing, by the motor housing or by the filter holder 242, such as by the first end member 300, the second end member 310, and/or by the internal support frame 258 of the holder 242 (as exemplified). The directing member may comprise a portion of the filter holder 242, such as the internal support frame 258 (e.g., struts joining the first and second members 300, 310).

In the absence of a directing member, air directed into the internal cavity of the filter during an evacuation operation would tend to flow to the inner end of the internal cavity (i.e., as exemplified the forward end of the filter) before being forced outwardly through the filter material. The directing member 360 may include a surface, such as a baffle or vane, which will direct some, most or all of the air at an angle to the filter axis 248 (e.g., outwardly at an acute angle to axis 248 or generally radially outwardly). Alternately, or in addition, the directing member 360 may include one or more baffles restricting the cross-sectional air flow area in a plane transverse to axis 148 in the internal cavity at a choke point 362 between the first end 354a and the second end 354b to encourage the evacuation air flow to exit the internal cavity upstream of the choke point. It will be appreciated that a series of baffles may be provided axially through the internal cavity. The baffles may be of different sizes so as to provide a larger cross-sectional air flow area towards the end of the internal cavity distal end 354b.

As exemplified in FIG. 21, the directing member 360 includes two axially spaced apart transverse walls 364 partially blocking the internal cavity between the first end 354a and the second end 354b (e.g., a transverse wall with an opening to allow air to pass through). Partially blocking the internal cavity encourages the evacuation air to exit the internal cavity 254 upstream of the transverse wall.

As exemplified in FIG. 22, the directing member 360 is a single transverse wall 364 extending across the cavity 254 and separating one end 354a from the other end 354b to prevent air from moving from one end to the other through the internal cavity.

It will be appreciated that the transverse wall 364 may be planar as exemplified or it may be non-planar, e.g., concave or convex shaped. The transverse wall may block part or all of an outer annular band of the internal cavity. In such a case, the radially inner portion of the transverse wall may be hollow (e.g., a single central opening as exemplified in FIG. 21) to enable air to flow through the open interior of the transverse wall. In such a case, the transverse wall may be an annular wall with a central opening. Alternately, or in addition, the transverse wall may have a plurality of openings therethrough. Alternately, or in addition, the transverse wall may have a solid centre and the outer perimeter of the transverse wall may be spaced from the inner side of the filter to provide a partially of fully annular air flow band between the transverse wall and the inner side of the filter media.

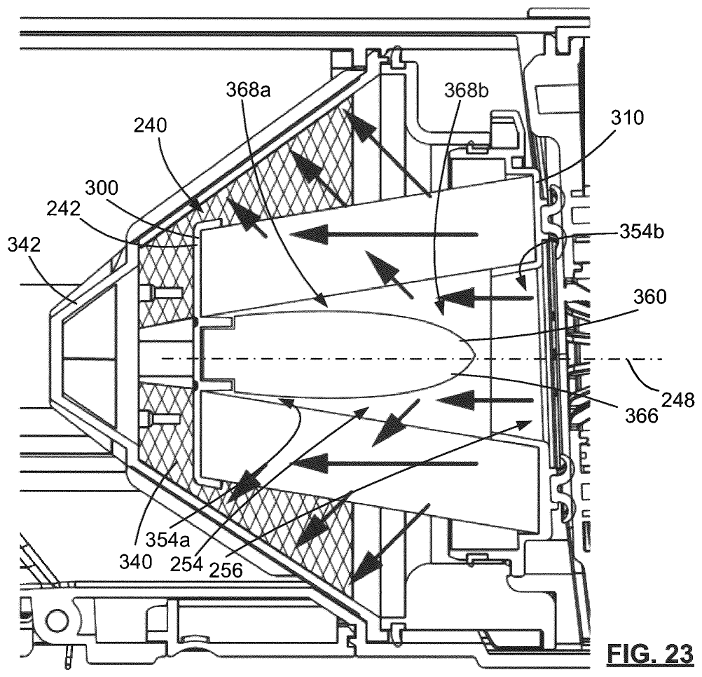

Alternately, or in addition, referring to FIG. 23, in some embodiments the directing member 360 in the central cavity includes one or more obstruction bodies 366 in the internal cavity occupying a volume of the internal cavity to reduce the free volume of the internal cavity available for evacuation air flow. The obstruction body 366 may occupy a first volume of a first segment 368a of the internal cavity and a second, lesser, volume of a second segment 368b of the internal cavity spaced from the first segment towards the second end 254b, to reduce the transverse air flow area in the first segment relative to the second segment to direct air out of the internal cavity upstream of the first segment. Optionally, the obstruction body is secured to the first end member 300 and extends into the internal cavity from the first end 354a. In such an embodiment, the obstruction body reduces, e.g., continuously reduces, the cross-sectional flow area in the internal volume as the amount of air travelling through the interior volume decreases during an evacuation operation. Therefore, moving in the axial direction towards closed end 354a, as air exits the interior volume through the filter media, the cross-sectional flow area may be reduced forcing air through the filter media, preferably at about the same velocity along the axial length of the filter media.

Alternately, or in addition referring to FIGS. 24 and 25, in some embodiments the directing member 360 includes an angled surface 370 angled relative to the filter axis 248 and arranged between the first and second ends to direct the evacuation air flow along a cyclonic path within the internal cavity downstream of the angled surfaces 370.

In some embodiments, the directing member 360 is moveable between a first position (e.g., a surface cleaning mode position) and a second position (e.g., an evacuation position). In the first position, the directing member 360 may be moved to provide a lesser impact on the air flow within the internal volume 254. For example, in a cleaning mode, the directing member 360 may be partially or fully withdrawn from the internal cavity (or collapsed) so as to reduce the degree to which the directing member 360 is in the air flow path during the cleaning mode.

The directing member 360 may be moved in any suitable way, such as by collapsing and expanding (e.g., an inflatable wall or obstructing body), translating (e.g., towards or away from an end of the cavity), rotating (e.g., relative to the axis 248), or rising (e.g., opening or closing an aperture in a transverse wall).

### Concentrated Evacuation Air Stream on Dirt Bearing Member

A hand vacuum cleaner using any one or more aspects discussed herein, including one or more of the other aspects set out herein in the general description and/or the detailed discussion, concentrates an evacuation air flow into a stream directed at a portion of a dirt bearing member. The dirt bearing member may be an air permeable member through which the air flow path extends in a cleaning mode (such as a screen, filter media or the like). The concentrated air stream may be used to drive dirt off some or all of the dirt bearing member by moving the air stream and/or the dirt bearing member while the stream of concentrated evacuation air flow is directed at a portion of the dirt bearing member.

In some examples, the dirt bearing member may be rotated during an evacuation operation and, optionally, a stream (jet) of air may be directed at part of the inner or downstream surface (in the cleaning mode of operation) of the dirt bearing member. Accordingly, the air traveling in the reverse direction during an evacuation operation may impact only a portion of the inner surface of the porous member thereby causing a higher volume and/or velocity of air to travel through that impacted portion of the inner surface. By moving (e.g., rotating, translating) the porous member, the portion at which the air is directed is changed. Accordingly, the jet of air may be directed sequentially at different portions of the dirt bearing member thereby, e.g., treating all of the upstream surface of the dirt bearing member. Alternatively, or additionally, the stream of air may be redirected at different portions of the upstream surface of the dirt bearing member, e.g., by moving an air outlet of a member producing the stream of air (e.g., a nozzle) to, e.g., sequentially treat most or all of the upstream surface. The member producing the stream of air may itself be rotated and/or translated longitudinally through the dirt bearing member. Optionally, the member producing the stream of air to be directed generally downwardly during part or all of the operation of the member producing the stream of air (e.g., stationary or moved along an axis of the dirt bearing member while continuing to direct the stream of air generally downwardly), allowing the force of gravity to assist in removing dirt.

In some examples, the dirt bearing member may rotate or not rotate, and a target of the stream of air may be changed by rotating the member producing the stream of air (e.g., without rotating the dirt bearing member, or rotating the dirt bearing member and the member producing the stream of air at different rates). Therefore, along the axial length of the inner surface of the porous member, the air may be directed at a sector of the inner surface. As the porous member rotates, the air is directed at different sectors until the stream of air has been directed at all of the inner surface. Alternately, the steam of air may be directed in an annular band (e.g., an annular member having openings directed outwardly) and the band may be translated axially through the inner volume of the porous member.

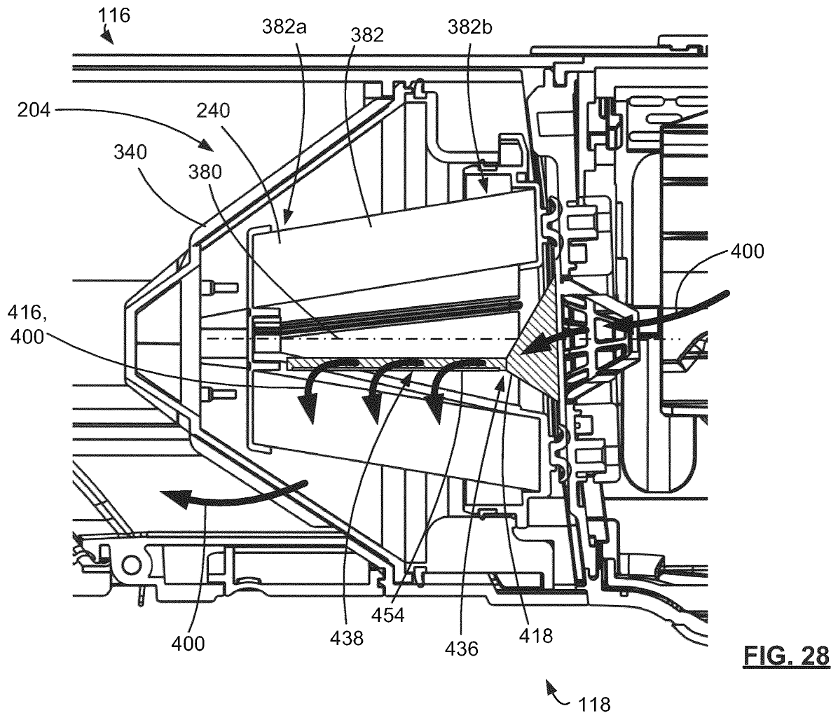

In accordance with this aspect of the description, the evacuation air flow in the evacuation air flow path 400 is concentrated into a stream directed at a portion of dirt bearing member 382. As exemplified in FIG. 28, the dirt bearing member 382 may include the filter 240 (e.g., a donut or annular filter). It will be appreciated that the dirt bearing member 382 may be another air permeable dirt bearing member 382 through which the air flows during a cleaning mode (e.g., the porous member 340 of the air outlet 204 and/or a filter 240 such a donut or annular filter). In the evacuation mode, the stream of air may blow through the air permeable dirt bearing member to drive dirt out and/or off an opposite surface (the upstream surface in the cleaning mode) of the air permeable dirt bearing member.

As exemplified, the dirt bearing member 382 extends between a first end 382a and a second end 382b along a central axis 380. Further, as exemplified, the dirt bearing member 382 has a generally open central region through which air flows generally along the central axis 380 in a cleaning mode (e.g., a donut or annular filter or a screen of a dirt outlet). The stream of air may be directed at an inner surface of the dirt bearing member 382.

Also, or alternatively, it will be appreciated that a stream of evacuation air may be used to drive dirt off of any other dirt bearing member, such as a non-air permeable wall of an air treatment chamber or a dirt collection chamber.

A member 418 may produces the air stream 416. Any suitable member 418 may be used to concentrate the evacuation air flow to produce the air stream 416. As exemplified in FIG. 28, the member 418 may include an air flow passage 436 and an air outlet 438, one or both of the passage 436 and the outlet 438 being sized and/or shaped to produce the stream of air 416.

It will be appreciated that the member 418 may produce a stream of air having any particular pattern. For example, the member 418 may produce an annular band of air (when view in a plane transverse to a central axis (e.g., axis 380) of the dirt bearing member, a circular stream (when viewed in a plane transverse to a direction of air exiting the member 418) or an axially extending stream (when viewed in a plane transverse to a direction of air exiting the member 418). It will be appreciated that member 418 may have one or more air outlets 438, each of which has one or more ports 454.

As exemplified in FIG. 28, the air outlet 438 has a slot-shaped port 454. As exemplified, a long dimension of the slot-shaped port extends generally parallel to a central axis 380 of the open interior of the dirt bearing member 382. Alternatively, as discussed previously, the slot may be an annular slot which may be directed generally radially outward relative to axis 380 (e.g., the slot may encircle the axis 380 within a central cavity of member 382). In any such case, the slot may be continuous or it may optionally be interrupted, e.g., by supports to maintain a desired width of the slot. It will be appreciated that the dirt outlet 438 and/or ports 454 thereof may be of any suitable shape, such as a generally circular nozzle or a set of openings arranged in a desirable pattern such as a line, annular ring, or cluster.

In use, the air stream 416 targets (is directed at) different portions of the dirt bearing member at different times. The target of the air stream 416 may be changed by moving the member 418 producing the air stream 416 and/or by moving the dirt bearing member 382. It will be appreciated that any suitable movement may be used. The member 418 that produces the air stream 416 and/or the dirt bearing member 382 may move by rotating about an axis, such as about the central axis 380 of the dirt bearing member 382 (e.g., if the outlet 438 is generally linear extending along the axis 380). Alternately, the member 418 that produces the air stream 416 and/or the dirt bearing member 382 may move (translate) along an axis, such as the central axis 380 of the dirt bearing member 382 (e.g., if the outlet 438 is an annular outlet directed radially outward relative to the axis).

The dirt bearing member 382 may rotate about an off-vertical axis. As exemplified in FIG. 28, the off-vertical axis may be the central axis 380. Rotation about an off-vertical axis brings an upward facing surface of the rotatable member 382 to a downward facing position to benefit from the force of gravity in removing dirt from the surface. As exemplified in FIG. 28, the stream of air 416 may be directed generally downwardly throughout the rotation of the dirt bearing member 382 to allow the air flow and gravitational effect to combine to remove dirt from the rotatable dirt bearing member 382. The stream of air 416 may be directed in a generally constant direction as the dirt bearing member 382 moves (e.g., the member 418 producing the stream is generally stationary), or the stream of air 416 may move as well (e.g., rotating about axis 380 at a slower rate, or moving along the axis 380). The axis about which the member 418 producing the air stream and/or the dirt bearing member 382 rotates (e.g., axis 380) may be generally horizontally extending when the inlet conduit axis extends horizontally. The axis may extend in a forwardly-rearwardly direction.

The rotatable dirt bearing member 382 may extend into the air treatment chamber. For example, the dirt bearing member may be a filter media in an air outlet of the air treatment chamber (e.g., a vortex finder) or it may be the air outlet of the air treatment chamber. For example, the dirt bearing member 382 may be the porous member 340 of the air outlet 204 and/or the pre-motor filter 240.

The rotatable dirt bearing member 382 may extend generally along the air treatment chamber axis 188. The axis about which the member 418 producing the air stream and/or the dirt bearing member 382 rotates (e.g., axis 380) and the treatment chamber axis 188 may be generally parallel and optionally coaxial.

Movement of the member 418 producing the air stream and/or the dirt bearing member 382 may be actuated in any suitable way, such as by the main operating system 252 automatically in response to a mode selection or in response to a dedicated user input. An actuator 270 may be used to move the member 418 producing the air stream and/or the dirt bearing member 382.

It will be appreciated that the stream of air as discussed herein may be operated during part or all of an evaluation operation and/or prior to or subsequent to an evacuation operation.

### Mode-Dependent Bleed Upstream of Brush Motor

A hand vacuum cleaner using any one or more aspects discussed herein, including one or more of the other aspects set out herein in the general description and/or the detailed discussion, has a bleed valve whereby a supplemental source of air is admitted into the air flow path to adjust the air flow based on the type of surface being cleaned.

In accordance with this aspect of the description, the surface cleaning apparatus may include one or more bleed valves which provide a variable volume of bleed air based on the mode of operation of the surface cleaning apparatus. In operation, the bleed valve is automatically adjusted between, e.g., a first low flow mode and a high flow mode based on the type of surface being cleaned. The bleed valve may be varied to achieve a desired air watts or air flow for a given mode.

For example, if a surface cleaning head is being used to clean deep pile carpet, the brush motor loading is highest and the brush motor cooling requirements are greatest. Therefore, providing bleed air reduces the suction produced by a suction motor without the need to adjust the power provided to the suction motor. Providing the bleed air enables to surface cleaning head to travel across high pile carpet while enabling good push/pull force. The bleed air enables the air flow rate to the air treatment chamber (e.g., cyclone) to remain, e.g., relatively constant, and therefore not affect the separation efficiency of the air treatment chamber. This bleed air may be partially or fully directed through a brush motor to cool the brush motor.

Similarly, if a surface cleaning head is being used to clean a shallow pile deep carpet, the brush motor loading is moderate and the brush motor cooling requirements are moderate. In this case the amount of bleed air may less compared to cleaning a high pile carpet, and therefore the suction power may only be moderately reduced while still enabling good push/pull force. Similarly, less coiling of the brush motor is required as the loading on the brush motor is reduced.

Similarly, if a surface cleaning head is being used to clean a hard floor, the brush motor loading is low and the motor cooling requirements are low. Hard floor typically requires a higher suction level then short pile carpet. Therefore, the amount of bleed air may be less than the amount used for short pile carpet and, optionally, no bleed air may be provided.

Accordingly providing a bleed valve in a surface cleaning head that automatically increases the amount of bleed air that passes by or over a brush motor as the pile of a carpet increases may be used to adjust the suction level and cooling of the brush motor based on the type of surface being cleaned. The position of the bleed valve may be automatically adjusted using a sensor that detects the type of surface being cleaned or a pressure sensor which directs a signal to an electromechanical member (e.g., stepper motor or solenoid). Alternately, the biasing force that closes the bleed valve may enable the bleed valve to open or closed based on a pressure differential between the ambient exterior to the surface cleaning head and the pressure in the air flow path through the surface cleaning head.

A bleed valve 390 may be provided in the base 102, such as in the wand or surface cleaning head. Referring to FIG. 19, the bleed valve 390 may be provided in the surface cleaning head 104. The surface cleaning head 104 may include a brush 392 associated with the dirty air inlet 152. The brush 392 may be a rotatably mounted brush. The brush may be operated when the bleed 390 is in one or more modes. The brush 392 may be rotatably driven by a brush motor 391. The bleed valve 390 is provided to allow a bleed air flow path between the air flow path 150 and ambient. The bleed valve 390 may be upstream of the brush motor 391. The bleed air flow may be used to provide a supplementary air flow to the air flow path 150, and optionally to the brush motor 391, when, e.g., air flow through the dirty air inlet is reduced (e.g., obstructed by high pile carpet) or a mode selector is set to, e.g., a high pile carpet setting or a medium pile carpet setting. The bleed air may be used to allow the brush motor 391 to operate consistently or more consistently across operating modes.

In some embodiments, the first low flow mode for the bleed 390 is used when the surface being cleaned is a carpet having a first pile height, and the high flow mode is used when the surface being cleaned is a carpet having a second pile height, and the second pile height is greater than the first pile height.

In some embodiments, the bleed valve 390 is also operable in a second low flow mode wherein, in the first low flow mode, a first bleed air stream provides a first volume of air per unit time and, in the second low flow mode, a second bleed air stream provides a second volume of air per unit time that is greater than the first bleed air stream. In some embodiments, the bleed valve 390 is automatically adjusted between the first low flow mode when the surface being cleaned is a hard floor, the second low flow mode when the surface being cleaned is a carpet having a first pile height, and the high flow mode when the surface being cleaned is a carpet having a second pile height, and the second pile height is greater than the first pile height.

In some embodiments, the apparatus 100 includes a rotatably mounted carpet cleaning brush 394b operated when the bleed valve 390 is in the high flow mode, the first low flow mode, and/or the second low flow mode. The brush may be operated differently between the modes, such as at different speeds. In some embodiments, the surface cleaning apparatus 100 further comprises a hard floor cleaning brush 392b, and the rotatably mounted carpet cleaning brush 392a is operated when the bleed valve is in the high flow mode and the second low flow mode, and the hard floor cleaning brush is a rotatably mounted brush 392b that is operated when the bleed valve is in the first low flow mode.

One or more brush may be disengaged from a surface to be cleaned (e.g., lifted away or blocked off by a movable member) when not needed (e.g., when not operated). In some embodiments, the rotatably mounted carpet cleaning brush is disengaged from the surface or raised above the surface when the bleed valve is in the first low flow mode and the hard floor cleaning brush is disengaged from the surface or raised above the surface when the bleed valve is in the high flow mode and the second low flow mode.

Alternatively, the surface cleaning apparatus 100 may include a single brush that is operated differently between different modes. For example, a single brush may be operated at a first speed during one mode and a second, different speed in another mode. In some embodiments, the surface cleaning apparatus is operated in one or more modes in which no brush is operated (e.g., a hard floor cleaning mode in which the carpet cleaning brush is disengaged from the surface to be cleaned).

In some embodiments, the surface cleaning apparatus includes a surface type detector 394. Any suitable surface type detector may be used such as an air flow monitor within the air flow path 150 to detect changes in air flow indicative of an obstruction of the dirty air inlet (e.g., by carpet). In some embodiments, the surface type detector 394 includes an optical sensor. In some embodiments, in operation, the surface type detector 394 sends a signal to a controller (e.g., main control system 252) which sends a signal to adjust the mode of the bleed valve 390 and/or one or more brushes based on the signal from the surface type detector. However, it will be appreciated that a user may also select a surface type, such as by manually switching from a hard floor cleaning mode to a carpet cleaning mode or between carpet cleaning modes.

### Dock Evacuation Air Flow Returns Through Docked Apparatus

A hand vacuum cleaner using any one or more aspects discussed herein, including one or more of the other aspects set out herein in the general description and/or the detailed discussion, is dockable with a docking station and, when docked, has a return air flow path from the docking station that extends through a portion of the hand vacuum cleaner. Optionally, the suction motor of the hand vacuum cleaner is operable during the evacuation mode and may supplement a motor and fan assembly (e.g., a suction motor) in the docking station or be the sole motor and fan assembly used in the evacuation mode.

The air flow path through the hand vacuum cleaner is reconfigured between a cleaning mode of operation and an evacuation mode of operation. In order to reconfigure the hand vacuum cleaner from the cleaning mode to the evacuation mode and enable the suction motor of the hand vacuum cleaner to be used in the evacuation mode, the air flow path from the air treatment chamber to the suction motor or the pre-motor filter to the suction motor is closed and an air flow path is opened between the ambient and the pre-motor filter and/or the air treatment chamber. Further, an air flow path from the docking station air outlet to the suction motor of the hand vacuum cleaner is opened.

Accordingly, in accordance with this aspect of the description, the air flow path within the surface cleaning apparatus 100 is reconfigurable between a surface cleaning mode air flow path 150 and an evacuation air flow path. Reconfiguring the air flow path includes blocking the air flow path between the pre-motor filter or the air treatment member and the suction motor so as to provide a first or upstream portion of the evacuation air flow path in the hand vacuum cleaner that extends through an air treatment assembly (e.g., at least one air treatment chamber and/or dirt collection chamber) to an air inlet of the docking station and a second downstream portion of the evacuation air flow path in the hand vacuum cleaner leading from a docking station air outlet to the suction motor of the hand vacuum cleaner, and subsequently to, e.g., the clean air outlet. Once docked at a docking station, the first and second portions of the evacuation air flow path are joined by a docking station air flow path. Accordingly, the air moving member 220 of the surface cleaning apparatus may be used to move air through the evacuation air flow path.

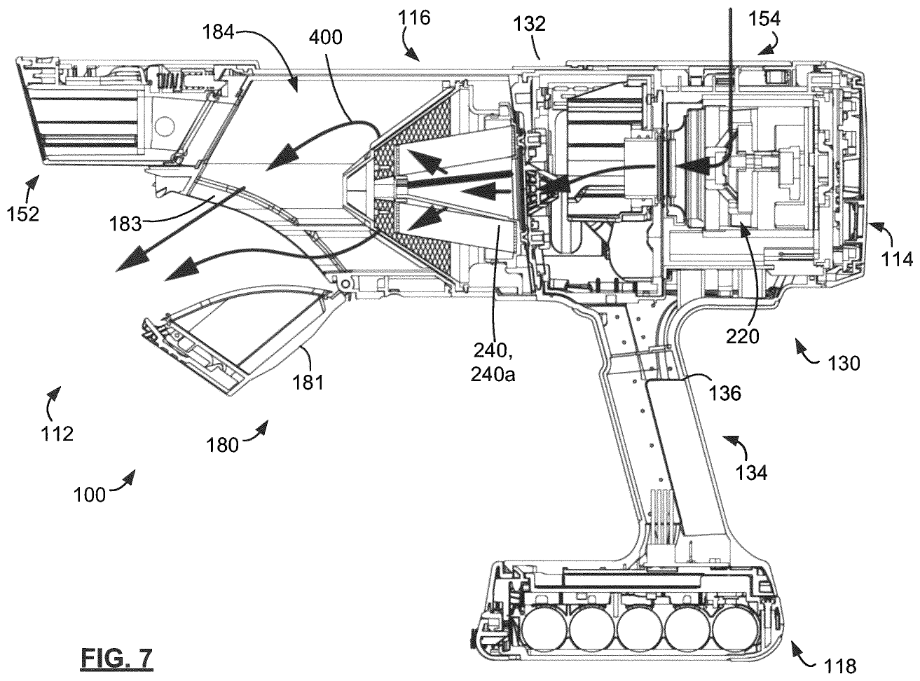

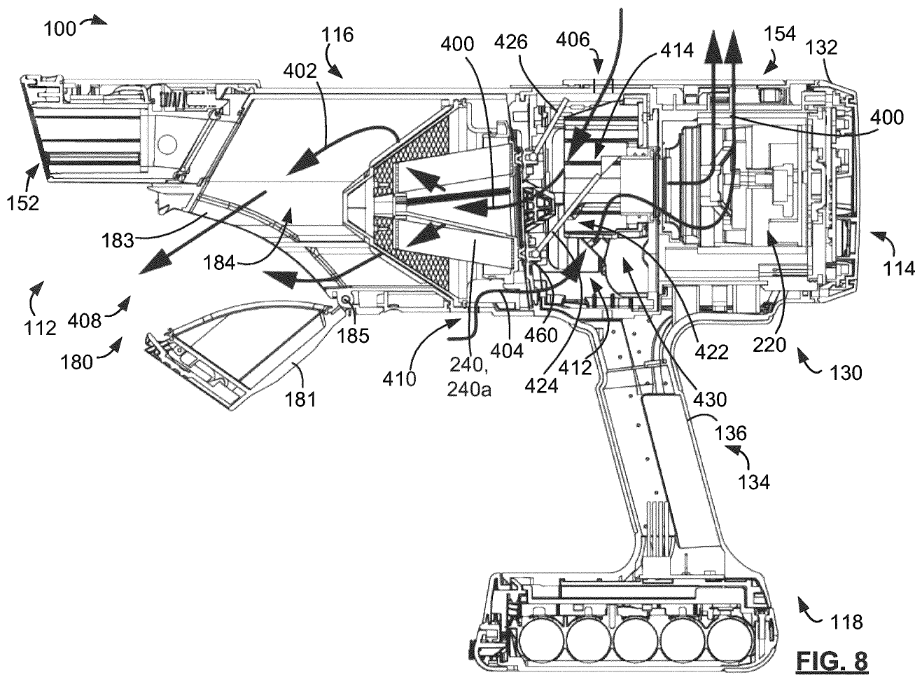

Referring to FIG. 8, illustrated is an exemplary evacuation air flow path 400. The evacuation air flow path 400 includes a first portion 402 and a second portion 404. The first portion 402 extends from, e.g., an ambient air inlet port 406 and/or the air inlet 202 to an evacuation air outlet 408. The evacuation air outlet 408 may include the air inlet 202 to the treatment chamber and/or the separate evacuation port 183 formed, e.g., by opening a portion of the air treatment assembly, as discussed further elsewhere herein. The second portion 404 extends from a docking station return air inlet port 410 to the clean air outlet 154. It will be appreciated that the air inlet 202 may be blocked during the evacuation mode by closing a valve associated with the air inlet 202 or dead ending the air inlet 202 when the hand vacuum cleaner is docked at the docking station.

The evacuation air flow path 400 may be formed by selectively blocking the surface cleaning mode air flow path 150 between the air outlet of the air treatment member 184 and the air moving member 220. If a pre-motor filter is provided and the first portion 402 of the evacuation air flow path extends through the pre-motor filter, then the air flow path 150 is blocked between the pre-motor filter 240 and the air treatment member 184 (e.g., at the outlet of the air treatment member 184). Referring to FIG. 20, when the surface cleaning apparatus 100 is docked at the docking station 110, the first and second portions 402, 404 of the evacuation air flow path 400 are joined by the docking station air flow path 442. When the surface cleaning apparatus 100 is docked at a docking station 110, the surface cleaning apparatus 100 is operable in an evacuation mode wherein air enters through the ambient air inlet port 406, travels through the docking station 110 and subsequently enters the surface cleaning apparatus 100 through the docking station return air inlet 410.

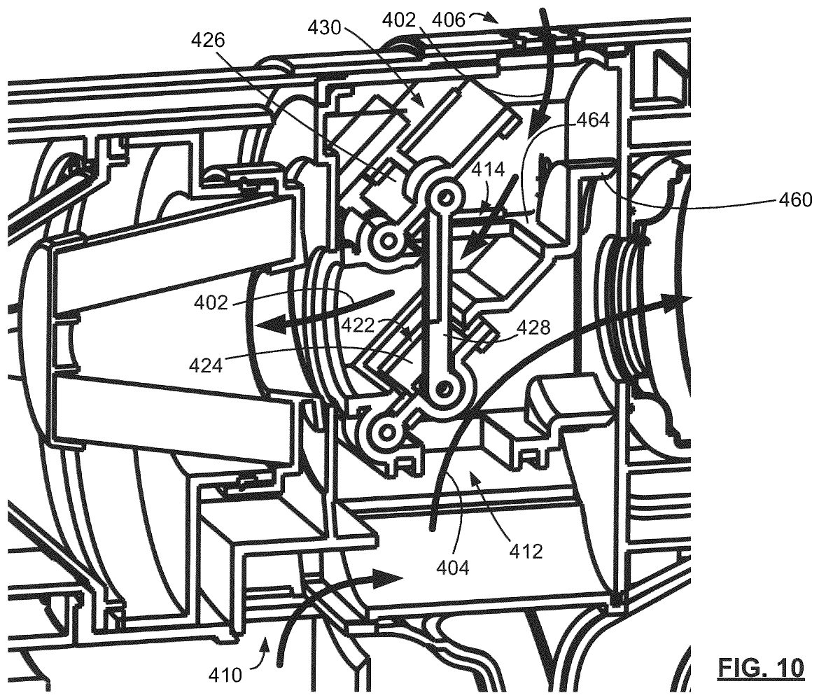

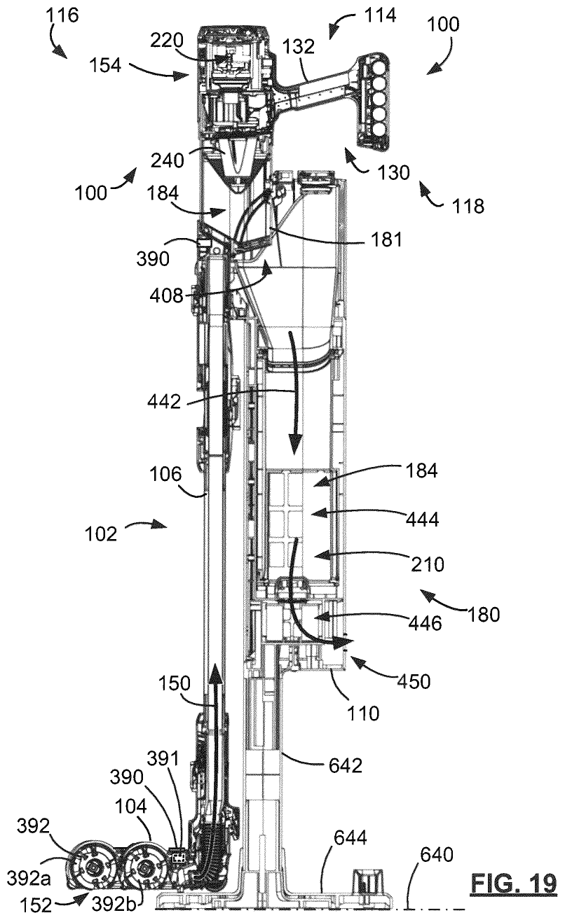

Referring now to FIGS. 2, 9 and 10, and 11-18, the surface cleaning mode air flow path 150 comprises a downstream portion 420 (FIGS. 2 and 12) that extends from the air treatment member 184 to the air moving member 220. The downstream portion 420 is selectively openable so as to be open during a surface cleaning mode and closed during an evacuation mode. The downstream portion 420 may be opened and closed in any suitable way. In some embodiments, the downstream portion 420 includes a downstream port 422 through which the surface cleaning air flow path 150 extends. The downstream port 422 is selectively openable. The apparatus 100 includes a door member 424 to selectively close the port 422.

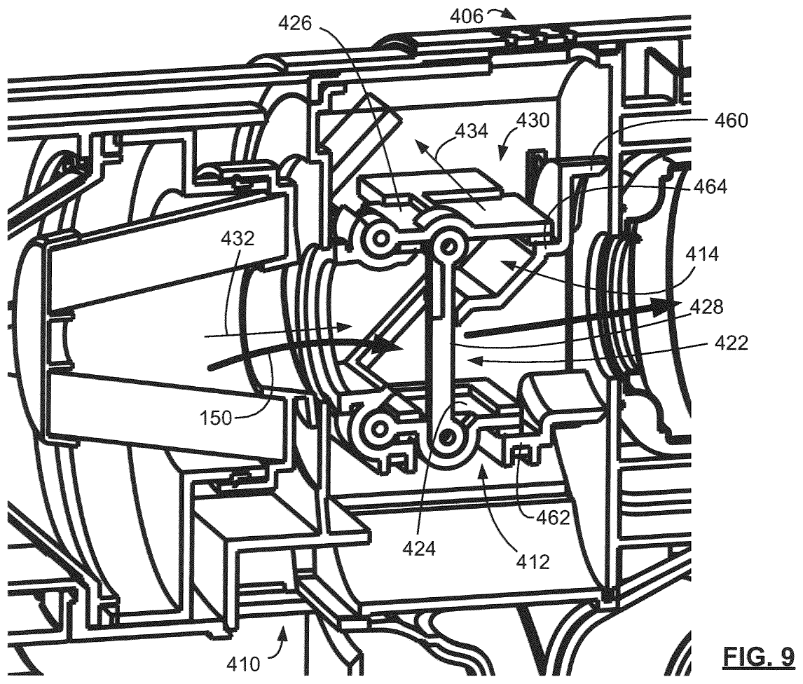

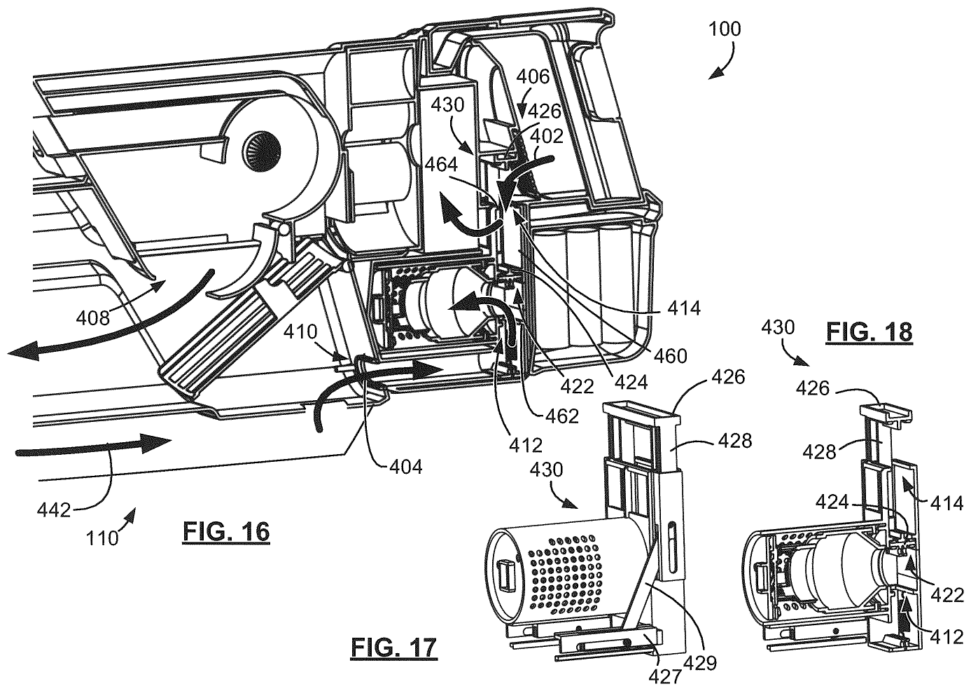

As exemplified, the door member 424 may be a first valve member of a part of a valve assembly 430 that is operable to concurrently open the ambient air inlet port 414 of the ambient air inlet 408 and the docking station return air inlet port 412 and also concurrently close the downstream port 422. Accordingly, the first valve member 424 is moveable between a first valve member surface cleaning mode position (FIG. 9, FIG. 12) in which the first valve member closes the docking station return air inlet port 412 and the downstream port 422 is open and a first valve member evacuation mode position (FIG. 10, FIG. 16) in which the first valve member 424 closes the downstream port 422 and the docking station return air inlet port 412 is open.

Further, a second valve member 426 is moveable between a second valve member surface cleaning mode position (FIG. 9, FIG. 12) in which the ambient air inlet port 414 is closed and a second valve member evacuation mode position (FIG. 10, FIG. 16) in which the ambient air inlet port 414 is open. The second valve member 426 may also be part of the valve assembly 430.

As exemplified, the valve assembly 430 may comprise a linking member 428 drivingly connecting one of the first and second valve members to the other of the first and second valve members. In some examples, the valve assembly 430 includes a single linking member 428. In some examples, the linking member extends generally parallel to the vertical axis 122. In other examples, the linking member extends generally parallel to the forward-rearward direction.

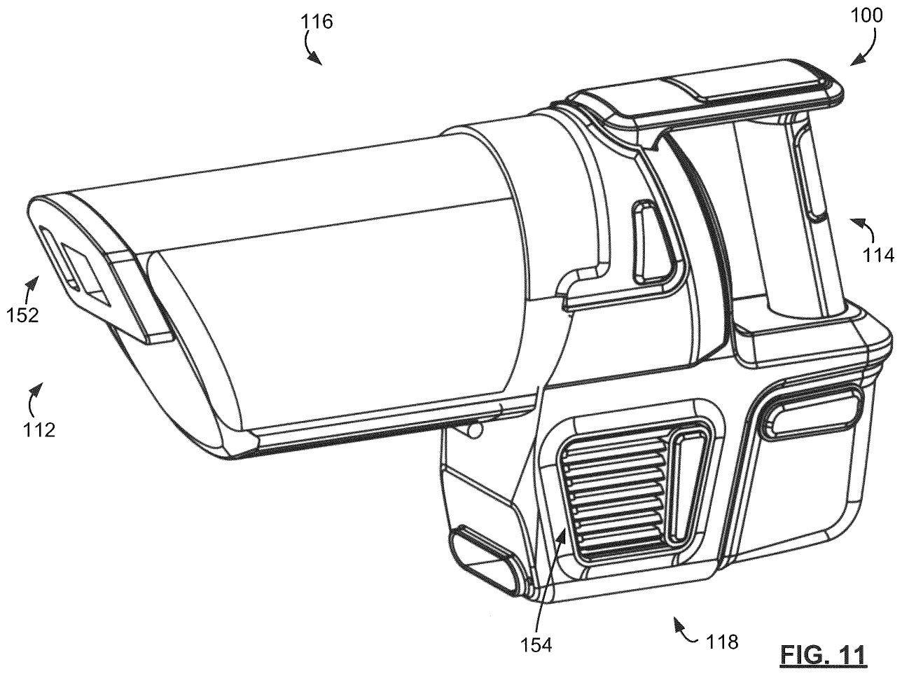

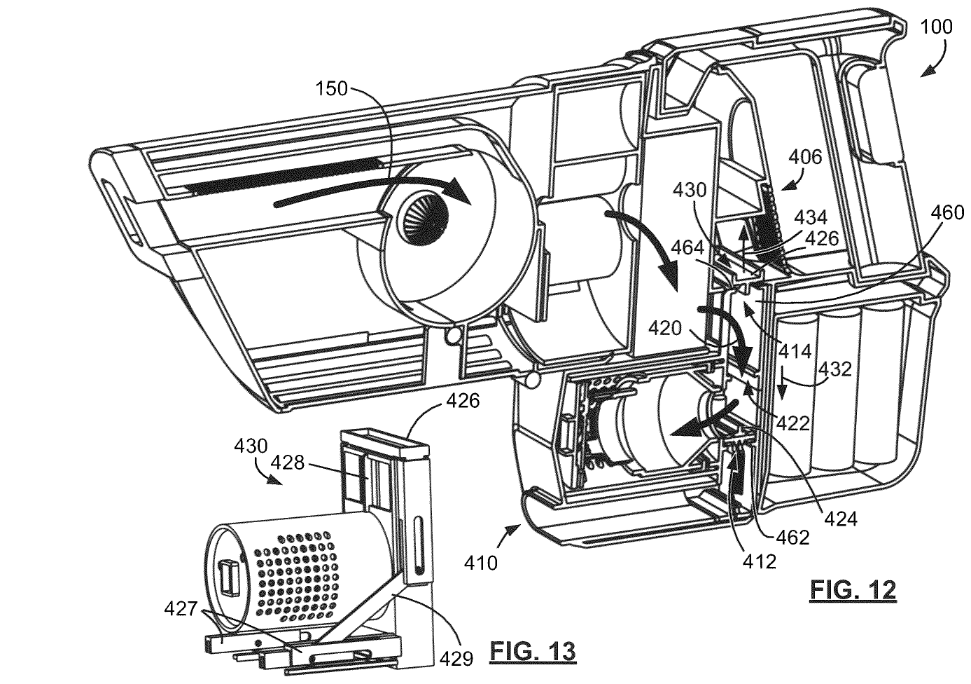

Accordingly, in operation in the surface cleaning mode, air flows in a direction 432 through a section 420 of the air flow path 150 having the first and second valve members and the linking member extends generally transverse to the direction 432, as exemplified in FIG. 9. Alternatively, the linking member 428 extends generally parallel to the direction 432 of air flow through the valve assembly, as exemplified in FIGS. 12 and 13.

The valve assembly 430 may include a housing 460 having the ambient air inlet port 414 and the docking station return air inlet port 412. The downstream portion 420 of the surface cleaning mode air flow path 150 extends through the housing 460. When the first valve member 424 is in the first valve member surface cleaning mode position (FIG. 9), the first valve member 424 abuts an outer wall 462 of the housing 460. When the second valve member 426 is in the second valve member surface cleaning mode position (FIG. 9), the second valve member 426 abuts an outer wall 462 of the housing 460. In some embodiments, when one or both of the first and second valve members 424, 426 is in the surface cleaning mode position it abuts an outer surface 464 of the housing 460.

Each valve member 424, 426 may be mounted in any suitable way. In some examples, as exemplified in FIGS. 9 and 10, one or each of the first and second valve members 424, 426 is pivotally mounted. Alternatively, as exemplified in FIGS. 11 to 18, one or each of the first and second valve members 424, 426 may be slidably (translatable) mounted.

The first and second valve members may be secured together to move together, e.g., in a common direction. The first valve member 424 moves (e.g., pivots as in FIGS. 9 and 10 or translates as in FIGS. 11 to 18) in an opening direction 434 when the first valve member moves from the first valve member surface cleaning mode position to the first valve member evacuation mode position, and the second valve member moves in a direction common with the opening direction 434 when the second valve member moves from the second valve member surface cleaning mode position to the second valve member evacuation mode position.

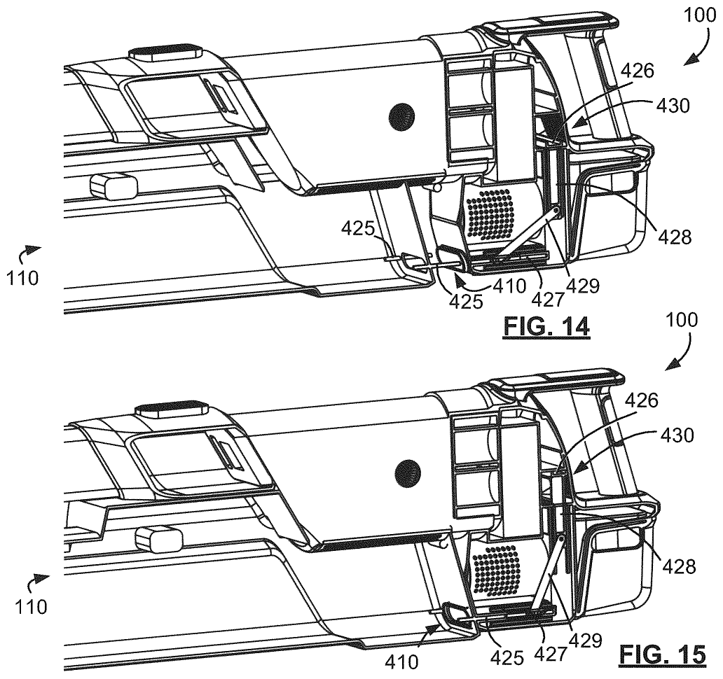

Accordingly, it will be appreciated that, as exemplified, two valve members are moveable to selectively open and close ports to reconfigure the air flow path between the cleaning and evacuation modes. The valve members may be linked together to move concurrently by one or more linking members. Movement of the valve members may occur automatically on docking. As exemplified in FIGS. 14 and 15, the docking station may have a member 425 (an abutment member) that drives one or both of the valve members and/or one or more linking member upon docking. For example, mating the air outlet of the docking station with the docking station return air inlet port 410 may drive the door member 424 (e.g., via slide 427 and mechanical linkage 429 as exemplified in FIGS. 14 and 15) which, in turn, drives the linking member 428 which drives the second valve member 426.

It will be appreciated that undocking the hand vacuum cleaner may automatically close the valves. For example, one or both of the valves and/or the linking member may be biased to the closed position. Alternately, or in addition, the docking station may have a member that mechanically drives the valves to a closed position (e.g., an abutment member pulls an actuator that moves the valve assembly to the close position).

It will also be appreciated that an electromechanical system may be used whereby a contact, which may be closed on docking and/or undocking, sends a signal that causes one or more electromechanical members (e.g., a solenoid, stepper motor, etc.) to move one or both valves and/or linking member.

The valve members may move in the same direction and they may be rotatable mounted. It will be appreciated that, in alternate embodiments, the valve members may translate (e.g., vertically in the orientation of FIG. 2).

It will be appreciated that, as exemplified the valving mechanism is located internal of the hand vacuum cleaner and may be located in the volume between the pre-motor filter and the suction motor.

### Unlocking by Docking

A hand vacuum cleaner using any one or more aspects discussed herein, including one or more of the other aspects set out herein in the general description and/or the detailed discussion, is dockable with a docking station and, as the hand vacuum cleaner is docked, an openable portion of the air treatment assembly is unlocked to enable the air treatment assembly to be emptied during an evacuation operation.

In accordance with this aspect of the description, an evacuation outlet 408 of the surface cleaning apparatus 100 is held closed by a lock which is moved from the locked position to the unlocked position by a portion of the dock 110 impinging on an actuator 270 when the surface cleaning apparatus 100 is docked. The dock moves the actuator rearwardly when the surface cleaning apparatus is docked.

As discussed subsequently, the actuator may move in a common axis with the axis of movement of the hand vacuum cleaner when being docked at the docking station. Accordingly, if the hand vacuum cleaner is docked in a downward direction as exemplified, then the actuator may also move in the vertical direction. The direction of movement is in a common direction (vertical) but in an opposite direction (upwardly as exemplified) to the downward docking direction.

Alternately, or in addition, as discussed subsequently, the actuator may be on the front wall of the hand vacuum cleaner (e.g., a front wall of the air treatment assembly. It will be appreciated that the actuator 270 may be driven by a lock engaging member 498 that is provided on the docking station and which is optionally a rigid stationary member.

As exemplified in FIGS. 29 to 31, the apparatus 100 includes a lock assembly 472. The lock assembly 472 includes first and second engagement members 476, 478. When first and second engagement members 476, 478 are engaged with one another, the door 181 is held closed by the lock assembly 472. When the first and second engagement members 476, 478 are disengaged from one another the lock assembly 472 does not hold the door in place (e.g., the door 181 is openable if there are no other locks).

The lock assembly 472 includes an actuator 270. The actuator 270 is moveable between a locked position (FIG. 29) and an unlocked position (shown in phantom at 490 in FIG. 29). The actuator 270 is operably connected to one of first and second engagement members 476, 478 to move the connected member in and/or out of engagement with the other member.

Any suitable actuator 270 may be used. In some embodiments, the actuator 270 of the lock assembly 472 is a push button. As exemplified, the actuator 270 is translatable, e.g., it moves between the locked and unlocked positions in a forwardly-rearwardly direction. In some embodiments, the actuator 270 moves rearwardly (i.e., generally in direction 492) from the locked position to the unlocked position. In some embodiments, such as exemplified in FIG. 29, the actuator 270 is provided on a front wall 496 of the surface cleaning apparatus 100.

The actuator 270 may be biased into one or the other of the locked and unlocked positions. The actuator may be biased by a biasing member (e.g., a spring or elastic). As exemplified in FIG. 30, a biasing member 494 (e.g., a compression coil spring) biases the actuator into the locked position.

As discussed elsewhere herein, the actuator 270 may be coupled to one or both of members 476, 478 in any suitable way to move one or both of members 476, 478 whereby the lock assembly is unlocked. The lock assembly 472 may include a mechanical linkage joining the actuator 270 to the connected one of members 476, 478. In some embodiments, the lock assembly 472 includes a mechanical driving member 274 between the actuator and the connected one of members 476, 478. In some embodiments, the lock assembly 472 includes a mechanical driving member 274a (FIG. 30) which is rearwardly moveable (i.e., generally in direction 492) when the actuator 270 moves from the locked position to the unlocked position.

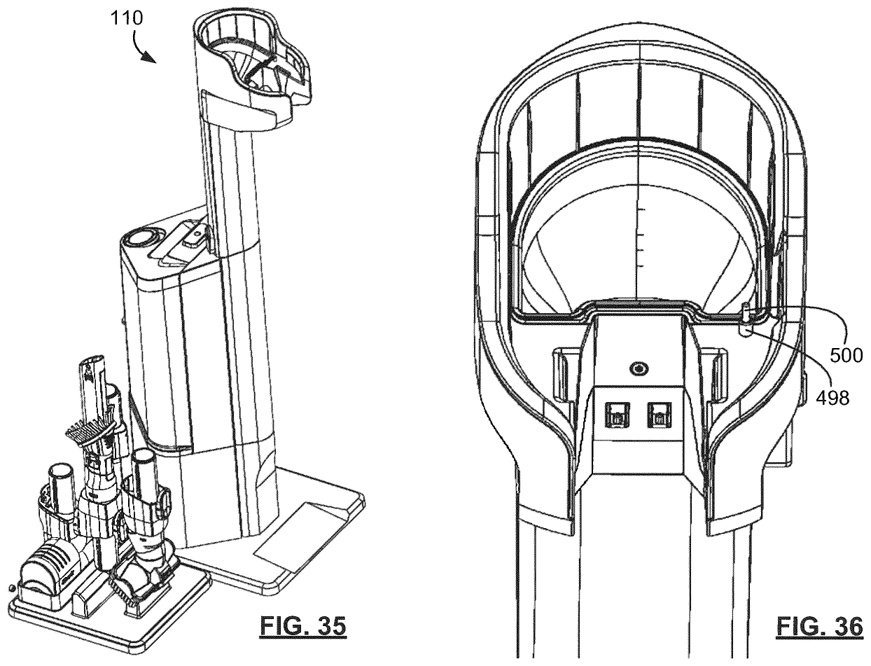

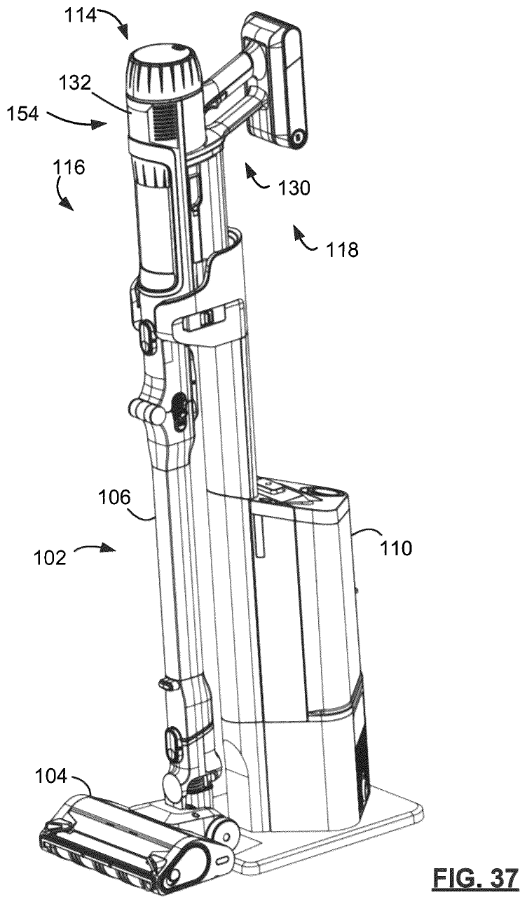

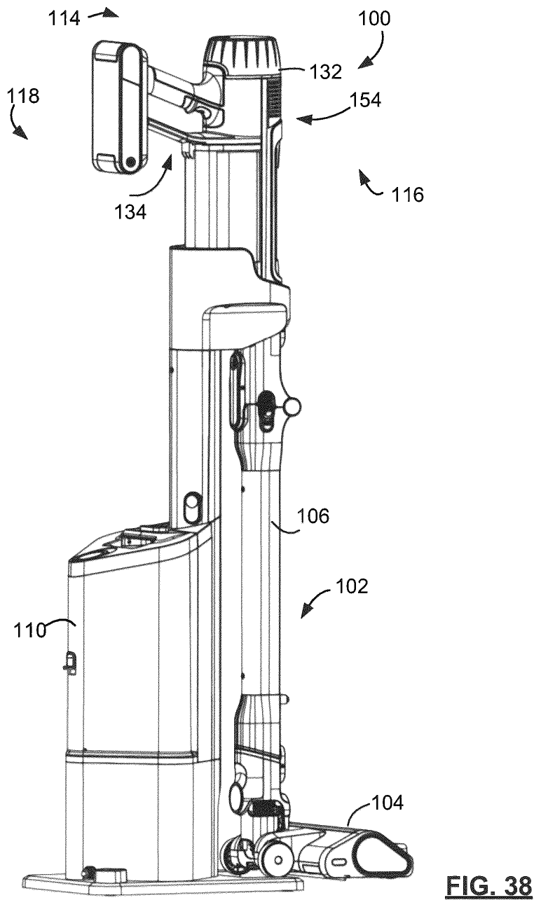

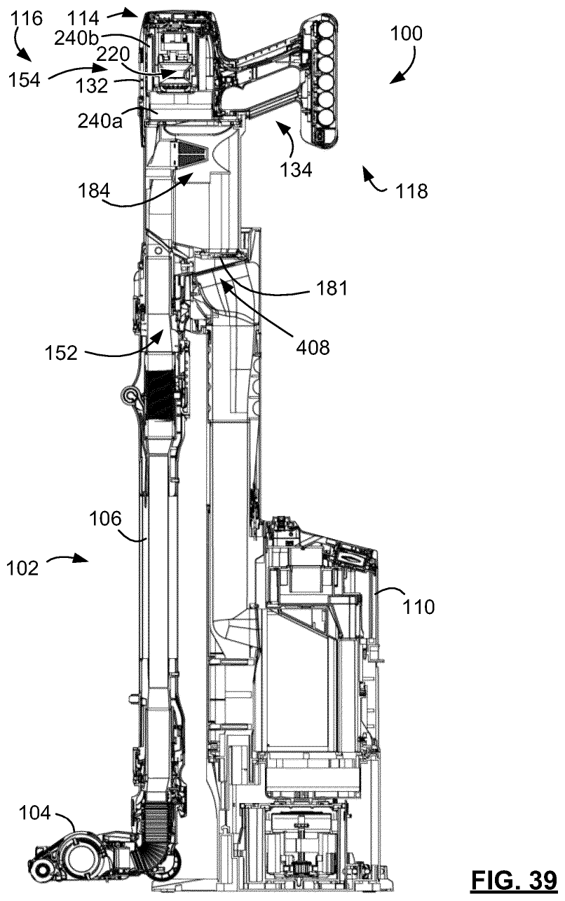

The actuator 270 is engaged by the dock 110 when the apparatus 100 is docked. Referring to FIGS. 35 and 36, the dock 110 includes a lock engaging member 498. The lock engaging member 498 is a projecting member to engage with the actuator 270 and drive the actuator from the locked position to the unlocked position when the surface cleaning apparatus 100 is docked with the dock 110. The lock engaging member may be a rigid member (e.g., hard plastic) in fixed relation to, e.g., a support surface of the dock 110 on which the apparatus 100 rests when docked, such that the actuator 270 is forced out of the locked position when the apparatus 100 is moved to rest on the support surface. In some embodiments, such as exemplified in FIG. 36, the lock engaging member 498 is an upwardly extending member. The surface cleaning apparatus 100 may be brought into a docked position generally downwardly relative to gravity, and the upwardly extending lock engaging member 498 drives the actuator 270 of the lock assembly 472 upwardly with respect to gravity (rearwardly with respect to the longitudinal axis 120 of the apparatus 100). In some embodiments, the engaging member 498 includes a guide member 500 received into a recess 502 of the actuator 270, e.g., to ensure a stable connection.

The lock 472 may be used with any suitable door 181 of the surface cleaning apparatus 100. The door 181, when the lock 472 is disengaged, may be openable in any suitable way, such as a removable door 181 separable from the rest of the apparatus 100 or a pivoting door pivoting about a hinge joining the door to the assembly 180 or main body 130. The door 181 may be of any suitable shape, such as a panel, a lid, or an alligator opening door. As exemplified in FIG. 29, the door 181 may be a generally planar panel. As exemplified in FIGS. 8 and 51, the door 181 may comprise a lower end of the air treatment assembly 180 (e.g., a bottom wall, with or without a portion of the front wall 496, such as an alligator opening). A door 181 comprising a lower end of the air treatment assembly 180 may have a rear end having a pivot mount 185.

### Evacuation Burst

A hand vacuum cleaner using any one or more aspects discussed herein, including one or more of the other aspects set out herein in the general description and/or the detailed discussion, is operable in an evacuation mode, e.g., when docked with a docking station and, during an evacuation operation that rate of air flow through the air treatment chamber and/or the pre-motor filter is varied. Accordingly, a higher rate of air flow may be passed through the air treatment chamber and/or the pre-motor filter to assist in removing dirt from the upstream side (during a cleaning operation) of one or both of the pre-motor filter and a porous member (e.g., screen) in the air treatment chamber and/or to remove dirt from the air treatment chamber and/or an external dirt collection chamber.

In accordance with this aspect of the description, pressure may be allowed to build up in part of the first or upstream portion of the evacuation air flow path prior to enabling air to pass therethrough. In this wat a burst or air may be provided when the first or upstream portion of the evacuation air flow path is opened for air flow therethrough.

Accordingly, the evacuation outlet 408 of the surface cleaning apparatus may be selectively openable, and the outlet 408 may be timed to open when a pressure differential is established between the inside and the outside of the outlet 408. When the outlet 408 opens after a pressure differential has been established, initial air movement out of the outlet 408 moves in a burst. A burst of air assists in carry debris, and helps to ensure that the door 181 is pushed open quickly and fully. Alternately, the burst may be created by opening a portion of the air flow path upstream of the air treatment chamber, such as by opening port 414.

It will be appreciated that, if suction is used to draw air out of the air treatment chamber, then opening outlet 408 once a desired negative pressure has built up in the docking station, will cause a sudden rush of air, e.g., through port 414 into and through the air treatment assembly to thereby draw dirt out of the air treatment assembly. Alternately, if pressure is used to drive dirt out of the air treatment assembly during an evacuation operation, then opening outlet 408 after a sufficient positive pressure has built up, e.g., in the air treatment assembly, will cause a sudden decompression that will push dirt out of the air treatment assembly.

In some embodiments, the opening of the outlet 408 (e.g., release of door 181) is delayed by a lock which opens only after a predetermined triggering event happens. The event may be, e.g., an elapsing of a predetermined length of time since an initiation event (e.g., docking, runtime of an air moving member, etc.), a sensed pressure outside the door, a sensed pressure inside the door, and/or a sensed pressure differential across the door.

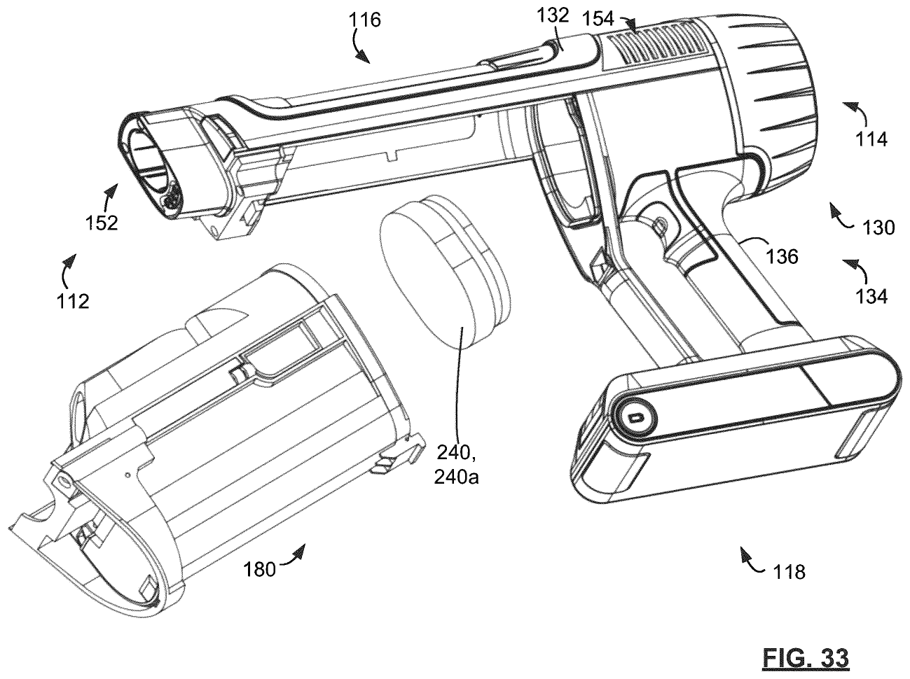

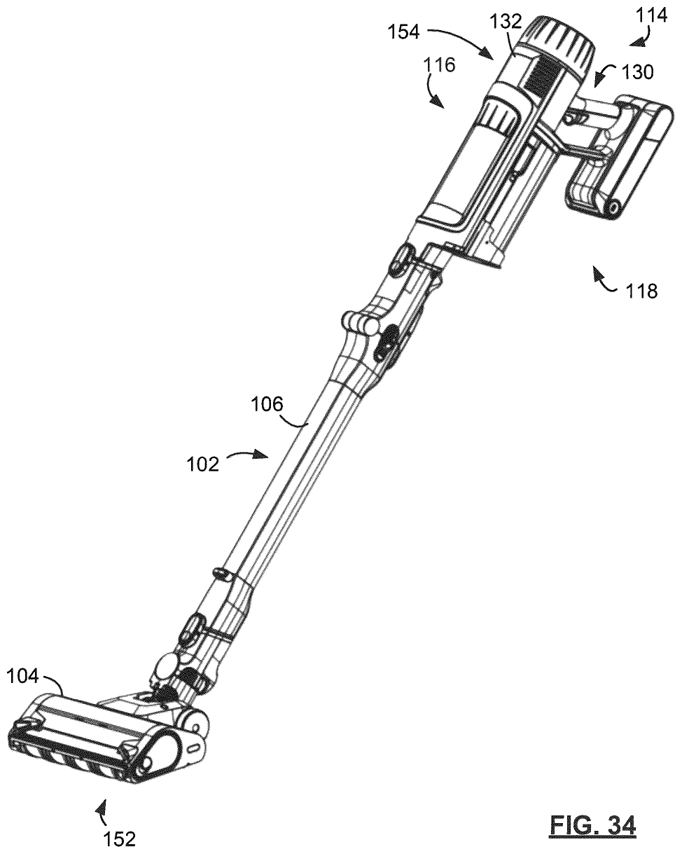

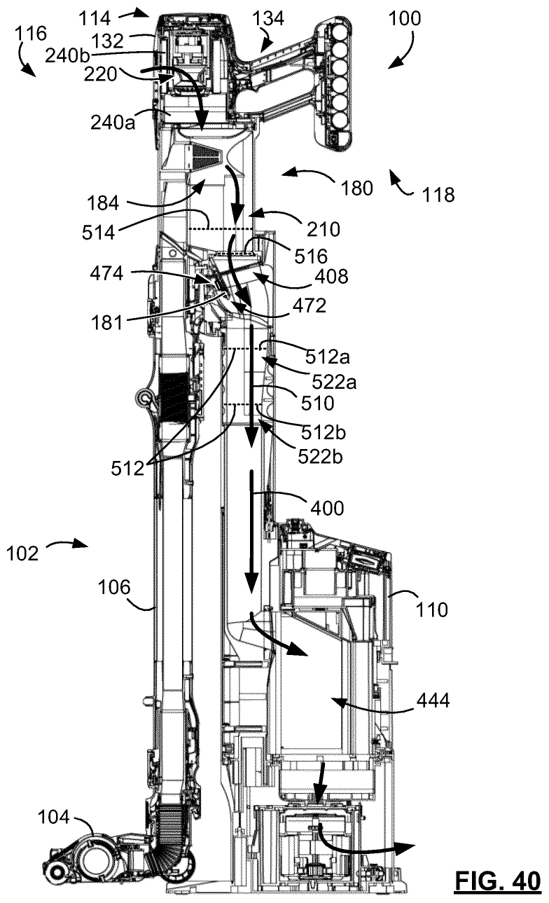

Referring to FIGS. 29-31, the apparatus 100 includes an event lock 474 operable between a locked position and an unlocked position in response to a triggering event. When the event lock 474 is in the locked position, the door 181 is maintained in the closed position (FIGS. 29-32). When the event lock 474 is in the unlocked position, the door 181 is not held by the lock 474 (e.g., free to open, such as to the open position shown in FIG. 40, if no other locks hold it in place).

In some embodiments, the triggering event comprises a period of time during which the air moving member of the apparatus 100 and/or the dock 110 (e.g., a motor and fan assembly) is operated during an evacuation cycle when the surface cleaning apparatus is docked at a docking station 110. Alternatively, subsequent to the surface cleaning apparatus 100 being docked at a docking station 110, the air moving member of the apparatus 100 and/or the dock 110 is actuated, and the event comprises a period of time subsequent to the commencement of operation of the motor and fan assembly after the surface cleaning apparatus 100 is docked at a docking station 110.

Alternatively, the event comprises a pressure level in the dirt collection region of the surface cleaning apparatus 100 exceeding a preset pressure. In some embodiments, subsequent to the surface cleaning apparatus 100 being docked at a docking station, the air moving member of the apparatus 100 and/or the dock 110 is actuated, and the event comprises a pressure in the dirt collection region 210 exceeding the preset pressure. Alternatively, the event comprises a pressure exterior to the door 181 being below a pre-set pressure. In some embodiments, subsequent to the surface cleaning apparatus 100 being docked at a docking station, the air moving member of the apparatus 100 and/or the dock 110 is actuated, and the event comprises a pressure in the docking station 110 at a location adjacent the exterior of the openable portion of the apparatus 100 being below a pre-set pressure.

In some embodiments, a controller (e.g., the main controller 252 or a separate controller) is operably connected to the second lock 474 and, after the triggering event occurs, the controller issues a signal whereupon the second lock is moved to the unlocked position of the second lock. In some embodiments, the second lock 474 comprises first and second engagement members 476, 478 and an electromechanical member 480 that is drivingly connected to the first engagement member 476. The first engagement member 476 is moveable from a locked position in which the first engagement member 476 engages the second engagement member 478 and an unlocked position in which the first engagement member 476 is disengaged from the second engagement member 478. When the controller issues the signal, the electromechanical member 480 moves the first engagement member 476 to the disengaged position.

In some embodiments, the apparatus 100 includes a system 470 of multiple locks. The system 470 may include, e.g., two locks. Referring to FIGS. 29-31, the system 470 includes the event lock 474 and another lock. In some embodiments, the event lock 474 is moveable to the unlocked position upon occurrence of an event that occurs subsequent to the other lock (e.g., lock assembly 472) moving to the unlocked position. The other lock may be opened in any suitable way, e.g., manually or by docking the surface cleaning apparatus 100 (e.g., to an auto-empty dock). The first and second locks may independently secure the door such that both must be released before the door will open.

It will also be appreciated that the event lock 474 may be operably connected to the lock 472 whereby upon the occurrence of an event, the event lock is unlocked and that, in turn, causes the lock 472 to be unlocked. For example, the event lock may be mechanically linked to the lock 472 to drive the lock to an unlocked position. For example, event lock 474 may be driving connected to engaging member 498 to move engaging member 498 to unlock lock 472. Alternately, the event lock 474 may issue a signal to a controller that unlocks lock 472. For example, lock 472 may use an electromechanical member that is moveable to unlock the outlet 408 or drives a linking member that moves the lock 472 to an unlocked position.

It will also be appreciated that a lock 472 may not b provided and the event lock 474 unlocks the outlet 408 enabling the outlet 408 to open.

Small Air Flow Path into Dock

A hand vacuum cleaner using any one or more aspects discussed herein, including one or more of the other aspects set out herein in the general description and/or the detailed discussion, is operable in an evacuation mode, e.g., when docked with a docking station and, an upstream portion of the evacuation air flow path from the air treatment assembly to the air treatment member of the docking station air flow path has a smaller cross-sectional flow area than a downstream section.

For example, the size of outlet 408 and/or the conduit from the outlet 108 to the air treatment member of the docking station may have a smaller cross-sectional flow area than a downstream section, e.g., the conduit from the outlet 108 to the air treatment member of the docking station. When the outlet 108 opens, an initial rush of air from opening of the outlet 108 may not be sufficient to dislodge dirt and transport the dirt to the air treatment member of the docking station

Using a tapered outlet from the air treatment assembly of the hand vacuum cleaner and/or and a smaller conduit, a higher velocity of air may be maintained upstream of the air treatment member of the docking station. If the dirt (e.g., a wrap of hair) gets stuck, e.g., in the conduit, it causes the suction pressure to increase thereby exerting additional force on the dirt clog. The small cross-sectional flow area maintains a higher velocity which assist is moving the clog downstream to the air treatment member of the docking station. Accordingly, the air flow produced by the suction motor combined with the opportunity for a suction head pressure if needed enables enhanced emptying.

A dock 110 and docked apparatus 100 form an evacuation air flow path 400 during an evacuation apparatus, including a dirt transfer section between the dirt collection region 210 of the apparatus 100 and the air treatment member 444 of the dock. In accordance with this aspect of the description, at least a portion of the dirt transfer section has a smaller transverse cross sectional area than a downstream portion thereof. A smaller transverse cross sectional area results in an improved velocity of air, to carry dirt to the treatment member 444. If dirt gets stuck in the duct, the suction pressure increases causing additional force on the dirt to move the dirt to the treatment member 444.

Referring to FIG. 40, a dock 110 and docked apparatus 100 form an evacuation air flow path 400 when the evacuation outlet 408 is open. The evacuation air flow path 400 extends through the dirt collection region 210 of apparatus 100 and through an air treatment member 444 of the dock 110. A dirt transfer section 510 of the evacuation path 400 extends between the dirt collection region 210 and the treatment member 444.

At least a portion of the dirt transfer section 510 has a smaller transverse air flow cross sectional area 512 relative to the dirt collection region 210 and/or the dirt outlet 408. The transverse cross sectional area 512 of at least a portion of the section 510 is smaller than an average transverse air flow cross sectional area 514 (relative to air flow direction of the evacuation path 400) of the dirt collection region 210. The transverse cross sectional area 512 of at least a portion of the section 510 (e.g., at 512b) may be smaller than a minimum transverse air flow area 516 of the outlet 408.

In some embodiments, the transverse cross sectional area 512 at each point along the dirt transfer section 510 is smaller relative to the dirt collection region 210 and/or the dirt outlet 408. The transverse air flow area 512 of the section 510 may be smaller at each point than the average transverse air flow cross sectional area 514 of the dirt collection region 210. The transverse air flow area 512 of the section 510 may be smaller at each point than the minimum transverse air flow area 516 of the outlet 408.

In some embodiments, the dirt transfer section 510 includes an expansion portion 520 immediately downstream of the dirt outlet 408 in which the transverse air flow area increases. The increased transverse area may, e.g., accommodate the door 181. In some embodiments, the transverse cross sectional area 512 of the dirt transfer section 510 downstream of the expansion portion 520 is smaller at every point than the average transverse air flow area 514 of the dirt collection region 210 and/or the minimum transverse air flow area 516 of the dirt outlet 408.

It will be appreciated that only an upstream portion of the conduit from the expansion portion 520 to the air treatment member 444 may have the smaller cross sectional flow area. The downstream section may increase in cross sectional flow area.

It will be appreciated that this aspect may be used in particular with using a burst of air.

### Dirt Transfer Section of Decreasing Size

A hand vacuum cleaner using any one or more aspects discussed herein, including one or more of the other aspects set out herein in the general description and/or the detailed discussion, is operable in an evacuation mode, e.g., when docked with a docking station and, the evacuation air flow path from the air treatment assembly of the hand vacuum cleaner to the air treatment member of the docking station air flow path decreases in the downstream direction along part or all of the air flow path.

In accordance with this aspect of the description, the transverse air flow area of the dirt transfer section 510 decreases towards the treatment member 444. The transverse air flow area may decrease in any suitable way, such as a tapered or stepped decrease. In some embodiments, the transverse air flow area at each position of the dirt transfer section 510 is equal to or smaller than the transfers air flow area of each preceding upstream portion of the dirt transfer section 510 (i.e., it continuously decreases and is may continually decrease at a constant rate).

Referring to FIG. 40, the transverse air flow area at a first portion 522a of the docking station air flow path 400 upstream of the docking station air treatment member 444 has a first cross-sectional area 512a in a first plane transverse to a direction of flow through the first portion. A second portion 522b of the docking station air flow path 400 upstream of the docking station air treatment member 444 and downstream of the first portion 522a has a second cross-sectional area 512b in a second plane transverse to a direction of flow through the second portion. The second cross-sectional area 512b is less than the first cross-sectional area 512a. in some embodiments, the inlet end of the section portion 522b is located at the outlet end of the first portion 522a.

The transverse cross sectional area 512 may decrease in any suitable way, such as tapering or step-wise. In some embodiments, the air flow path 400 tapers between the areas 512a and 512b. The first and second portions 522a and 522b may comprise a tapered section of the docking station air flow path.

### Second Stage Collection Region Evacuation Door

A hand vacuum cleaner using any one or more aspects discussed herein, including one or more of the other aspects set out herein in the general description and/or the detailed discussion, is operable in an evacuation mode, e.g., when docked with a docking station. The hand vacuum cleaner has a second stage air treatment member that has its own openable door that is openable to evacuation the second stage air treatment member during an evacuation operation.

In accordance with this aspect of the description, the surface cleaning apparatus includes a first stage dirt collection region with a first stage dirt outlet and a second stage dirt collection region with a second stage dirt outlet separate from the first stage dirt outlet. The first and/or second stage dirt outlets may be selectively openable. The second stage dirt outlet may be openable independently from the first stage dirt outlet. Alternatively, the first and second stage dirt outlets may open concurrently, e.g., actuated by a common actuator.

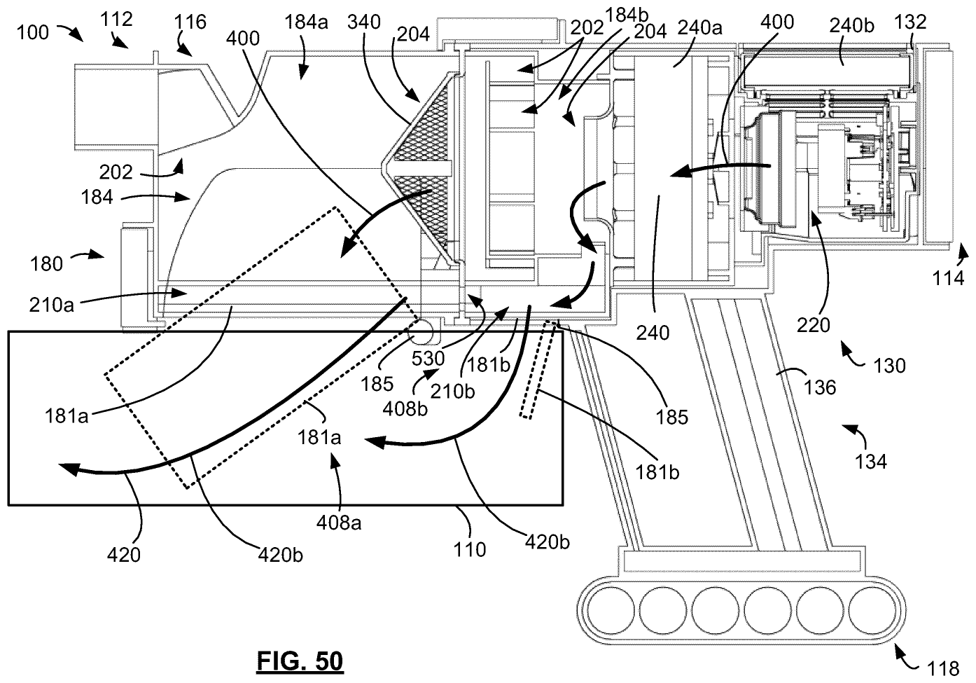

Referring to FIG. 50, the surface cleaning apparatus 100 may include a first and second air treatment stages 184a, 184b. The first and second treatment stages each have a separate dirt collection region. The apparatus 100 includes a first stage dirt collection region 210a to receive dirt from the first stage and a second stage dirt collection region 210b to receive dirt from the second stage. The first and second dirt collection regions 210a, 210b may be isolated from one another to prevent dirt transfer between them. Alternatively, the first and second dirt collection regions 210a, 210b may be in communication with one another for movement of dirt between them. In some examples, the first and second dirt collection regions 210a, 210b may be in a common chamber or communicating via a dirt transfer path or port 530 between different chambers.

Referring to FIG. 50, the surface cleaning apparatus 100 with first and second stage dirt collection regions 210a, 210b includes a first stage dirt outlet 408a with a door 181a and a second stage dirt outlet 408b with a door 181b. Each door 181a, 181b is moveable between a closed position (FIG. 50) in which the associated dirt collection region is closed and an open position (each shown in phantom in FIG. 50) in which the associated dirt collection region is emptiable. Separate doors 181a 181b allows the user to selectively dump the first stage dirt collection region 210a or the second stage dirt collection region 210b or both. Separate doors 181a 181b provides for removal of dirt without requiring a dirt transfer path or port 530 between the dirt collection regions.

In some embodiments, the first and second stage doors 181a, 181b are concurrently openable. The first and second stage doors 181a, 181b may be concurrently unlocked so as to be openable when the apparatus 100 is docked (e.g., during an evacuation operation) and/or when the surface cleaning apparatus 100 is to be manually emptied by a user (e.g., dumped into a garbage can). Concurrently opening the doors allows for a more rapid emptying of the dirt.

In some embodiments, the first and second stage doors 181a, 181b are sequentially openable. The first and second stage doors 181a, 181b may be sequentially openable when the apparatus 100 is docked (e.g., during an evacuation operation) and/or when the surface cleaning apparatus 100 is manually emptied by a user (e.g., dumped into a garbage can). Sequentially opening the doors allows for a more selective handling of the dirt (e.g., courser dirt from the first stage and finer dirt from the second stage). Further, in the case of an evacuation operation, selectively opening a door causes all of the evacuation air to travel through only one of the air treatment stages.

In some embodiments, the first and second stage doors 181a, 181b are provided on a common side of the surface cleaning apparatus. The common side may be a lower side 116. Providing the doors on a common side may improve the emptying experience of a user. Doors on the same side can be opened to a common receptacle without moving the apparatus 100. Doors on the same side allow a portion of a docking station air flow path from one door to merge with a portion of the path from the other door.

When the apparatus 100 is docked with a docking station 110, the docking station air flow path 420 is connectable in air flow communication with each of the first and second stage evacuation outlets 408a, 408b. When the surface cleaning apparatus 100 is docked at the docking station 110 and each of the first and second stage doors 181a 181b are in the open position (shown in phantom in FIG. 50), the docking station air flow path 420 comprises a first portion 420a that extends downstream from the first door 181a and a second portion 420b that extends downstream from the second door 181b and the second portion 420b merges with the first portion 420a.

It will be appreciated that the first and second stage doors 181a, 181b may be concurrently unlocked when the hand vacuum cleaner is docked or they may be selectively unlocked or opened. If both the first and second stage doors 181a, 181b are concurrently unlocked, actuating an evacuation operation may open the first and second stage doors 181a, 181b. If the air treatment stages are to be separately opened, then the doors may be selectively unlocked or selectively opened, e.g., by an electromechanical member.

### Rearwardly Extending Dirt Collection

A hand vacuum cleaner using any one or more aspects discussed herein, including one or more of the other aspects set out herein in the general description and/or the detailed discussion, may have part or all of an external dirt collection chamber positioned rearward of its associated air treatment chamber (e.gf. towards the suction motor)

As exemplified in FIG. 52, in accordance with this aspect of the description, the dirt collection chamber 212 extends rearward of the air treatment chamber 184. The rearwardly extending dirt collection chamber 212 extends above the pre-motor filter 240. The rearwardly extending dirt collection chamber 212 may extend above the air moving member 220.

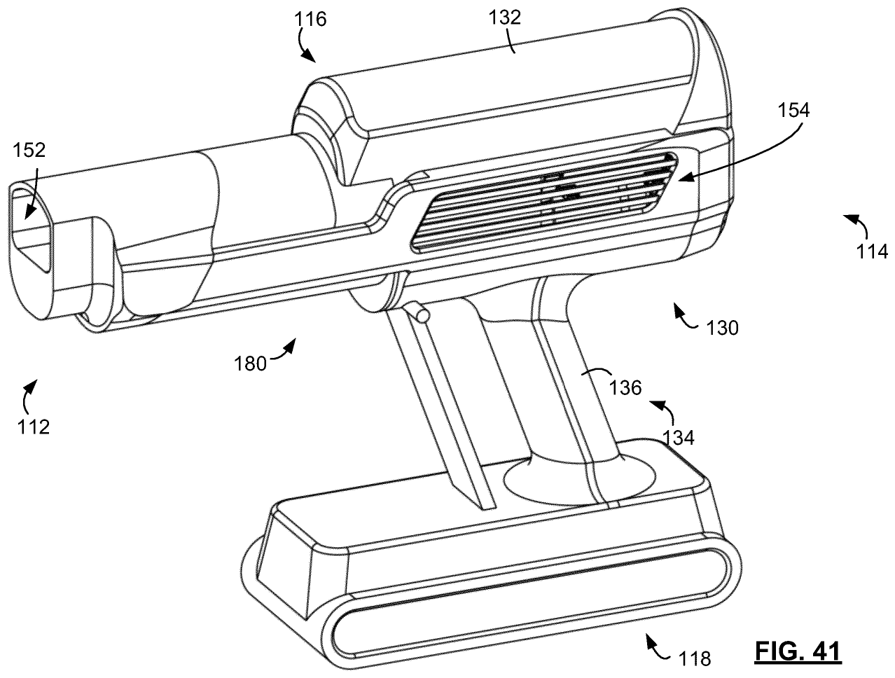

Referring to FIGS. 41 to 46, the dirt collection chamber 212 extends rearwardly from the air treatment chamber 184. In some examples, a plane 550 that is transverse to the longitudinal axis 120 extends through the dirt collection chamber 210, and one or both of the air moving member 220, a filter media of a filter 240. The filter 240 may be a premotor filter (e.g., intersected by plane 552) and/or a post motor filter (e.g., intersected by plane 550). In some examples, the rearwardly extending dirt collection chamber 212 extends rearwardly over two or more of the premotor filter 240a, the air moving member 220 and the post motor filter 240b. In some examples, the dirt collection chamber 212 is spaced from the air treatment chamber air outlet 204 in a direction transverse to the longitudinal axis 120.

The rearwardly extending dirt collection chamber 212 may be part of a rotatable housing. Referring to FIGS. 43 and 44, the surface cleaning apparatus 100 includes the main body 132 and a rotatable housing 180. The rotatable housing 180 is rotatably mounted to the main body 132 about a rotational axis 554. The rotation axis 554 is the axis of a hinge 555. The axis 554 may extend generally parallel to the transverse axis 124. The rotatable housing 180 has a first end 560 and a second end 562 longitudinally spaced from the first end 560. The rotatable housing 180 includes the air treatment chamber 184 and the dirt collection chamber 210, 212.

The rotatable housing is moveable between an in use position (FIG. 43) in which the air treatment chamber 184 is closed and an emptying position (FIG. 44) in which the air treatment chamber 184 has been rotated and may be open. For example, as exemplified in FIG. 44, as the rotatable housing rotates to the open position, the front wall of the air treatment chamber remains in place thereby opening a forward side of the rotatable housing (e.g., the forward side of the air treatment chamber). The rotatable housing rotates about the rotatable axis 554 between the in use and emptying positions.

The axis 554 may be at any suitable location between the front end 112 and the rear end 114. In some embodiments, when the rotatable housing is in the emptying position, the first end is located on one side of the rotational axis and the second end is located on an opposite side of the rotational axis. The axis 554 may be generally between the first and second ends 560, 560 such that the first end 560 rotates downwardly and the second end 562 rotates upwardly into the emptying position. The axis 554 may be more than ⅓ of the length of the housing 180 from each end. The axis 554 may be generally vertically aligned with the rear end of the air treatment chamber 184. The axis 554 may be generally vertically aligned with the front end of the collection chamber 210. The first end 560 of the housing 180 may have an open end of the air treatment chamber 184. The open first end 560 rotates generally downwardly to the emptying position.

The position of the dirt collection chamber 210 encourages dirt flow out of the dirt collection chamber 210 and into the treatment chamber 184 during an emptying operation when the open forward end of the rotatable housing is directed downwardly. The dirt collection chamber 210 extends between a first end 564 and a second end 566. The first end 564 is a forward end and the second end 566 is a rearward end. As exemplified, the dirt outlet 214 from the treatment chamber to the collection chamber 210 may be provided at the first end 564 of the dirt collection chamber 184.

The dirt outlet 214 may be in any suitable part of the first end 564 of the dirt collection chamber. In some embodiments, the dirt collection chamber 210 is generally at an elevation above the treatment chamber 184, and the dirt outlet 214 may be at a lower end of the dirt collection chamber. The dirt outlet may be an opening through a lower bounding wall 570 of the dirt collection chamber, such as exemplified in FIG. 43. The dirt outlet 214 may extend to the forward end wall 568 of the dirt collection chamber 210. The forward end wall 568 may extend generally downwardly and forward towards the dirt outlet 214. In some embodiments, in dirt collection chamber 210 is generally above the dirt collection chamber 184 when the housing 180 is in the emptying position, to encourage dirt flow out of the dirt collection chamber 210 and into the treatment chamber 184 to be emptied from the treatment chamber 184 through the first end 560.

Accordingly, in a cleaning mode, air flow through the air treatment chamber (e.g., a cyclone) may cause dirt to travel, e.g., upwardly through the dirt outlet into the dirt collection chamber 210, 212.

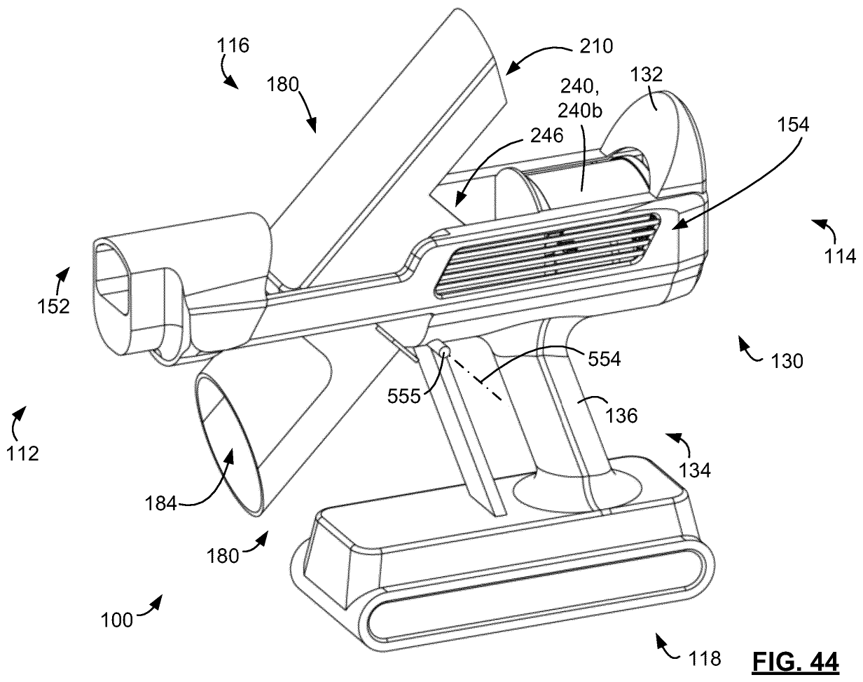

In some embodiments, the filter housing 246 of the pre-motor filter 240a housing is opened when the rotatable housing is in the emptying position. The pre-motor filter media 240 may be moved with the rotatable housing. A first end 560 of the rotatable housing 180 may have an open end of the air treatment chamber 184 when the rotatable housing is in the emptying position and a second end 562 of the rotatable housing 180 longitudinally spaced from the first end 560 of the rotatable housing 180 may have the pre-motor filter media when the rotatable housing is in the emptying position. In some embodiments, the second end 562 of the rotatable housing 180 has an open end of the pre-motor filter media housing when the rotatable housing is in the emptying position. Referring to FIG. 45, the premotor filter 240 may be removable through the open end when the rotatable housing is in the emptying position.

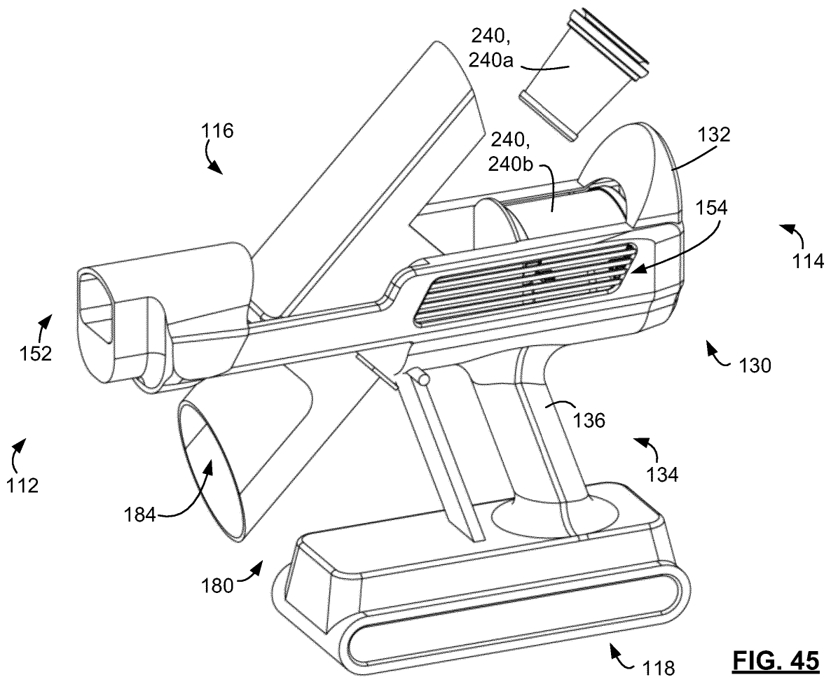

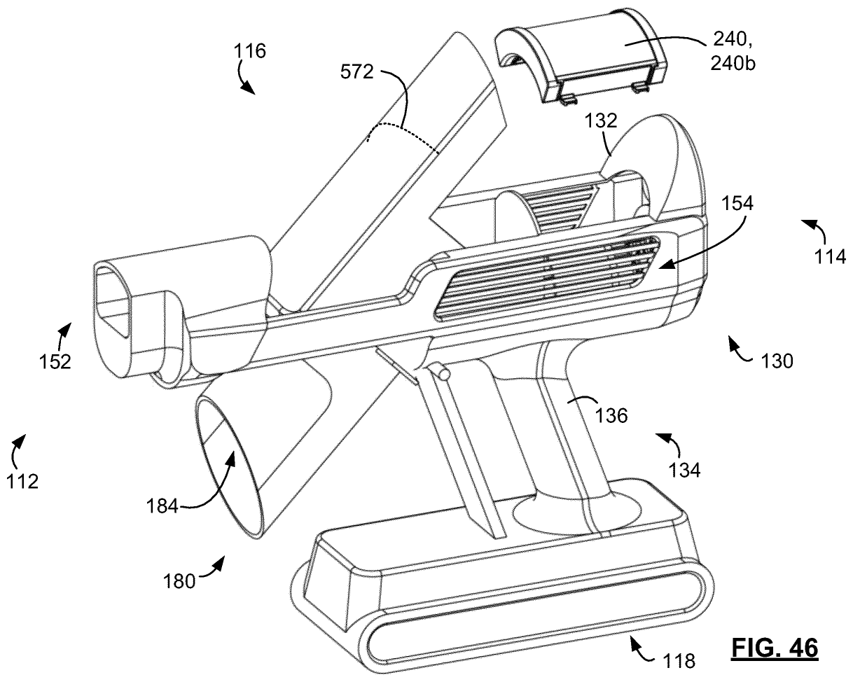

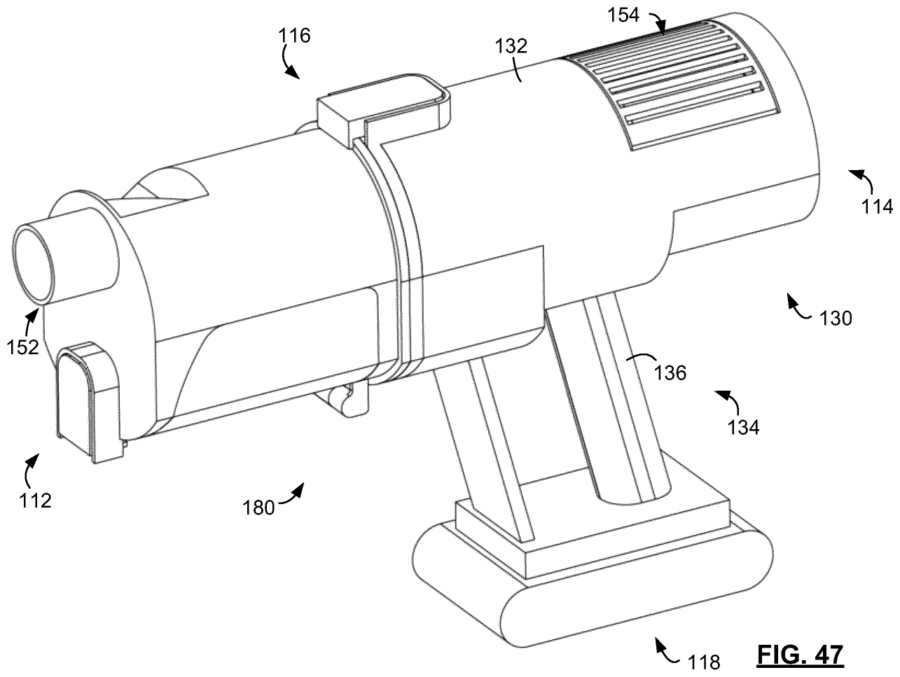

In some embodiments, the filter housing 246 of the post-motor filter 240b housing is opened when the rotatable housing is in the emptying position. The post-motor filter 240b may remain in the main body 132 when the rotatable housing is in the emptying position. A wall of the housing may form a wall (e.g., a top wall) of the post-motor filter 240b. Referring to FIG. 46, the post-motor filter 240b may be removeable from the post-motor filter housing when the rotatable housing is in the emptying position.

The rearwardly extending collection chamber 210 may be in any suitable shape, such as generally rectangular or circular in a plane transverse to the longitudinal axis 120 (e.g., in plane 550 or 552). In some embodiments, an outer perimeter 572 (FIG. 46) of the dirt collection chamber in a plane transverse to the longitudinal axis 120 (e.g., in plane 550 or 552) is arcuate.

### Expandable Dirt Outlet

A hand vacuum cleaner using any one or more aspects discussed herein, including one or more of the other aspects set out herein in the general description and/or the detailed discussion, may have a dirt outlet 214 that is expandable for ease of emptying.

In accordance with this aspect, the dirt outlet 214 is an opening having a perimeter which is defined by walls, and at least one of the walls is moved between a first configuration in which the dirt outlet has a first cross sectional area transverse to a direction of dirt passage therethrough and a second configuration in which the dirt outlet has a second, larger cross sectional area in the direction of dirt passage. The dirt outlet 214 may be expanded by flexing of at least a portion of a wall forming the dirt outlet and/or by moving apart first and second walls that define the dirt outlet 214 to shift the position of at least one wall relative to at least one other wall forming the dirt outlet.

In some embodiments, at least a portion of a wall defining a portion of the dirt outlet is made of a flexible material. The flexible material is deformed between a first in-use position and a second emptying position. In the emptying position, the dirt outlet has a greater cross sectional area in a plane transverse to the direction of dirt through the dirt outlet. Expanding the dirt outlet allows for more free movement of air and dirt through the dirt outlet. Expanding the dirt outlet may free larger dirt caught in the dirt outlet (e.g., hair extending between the treatment and collection chambers).

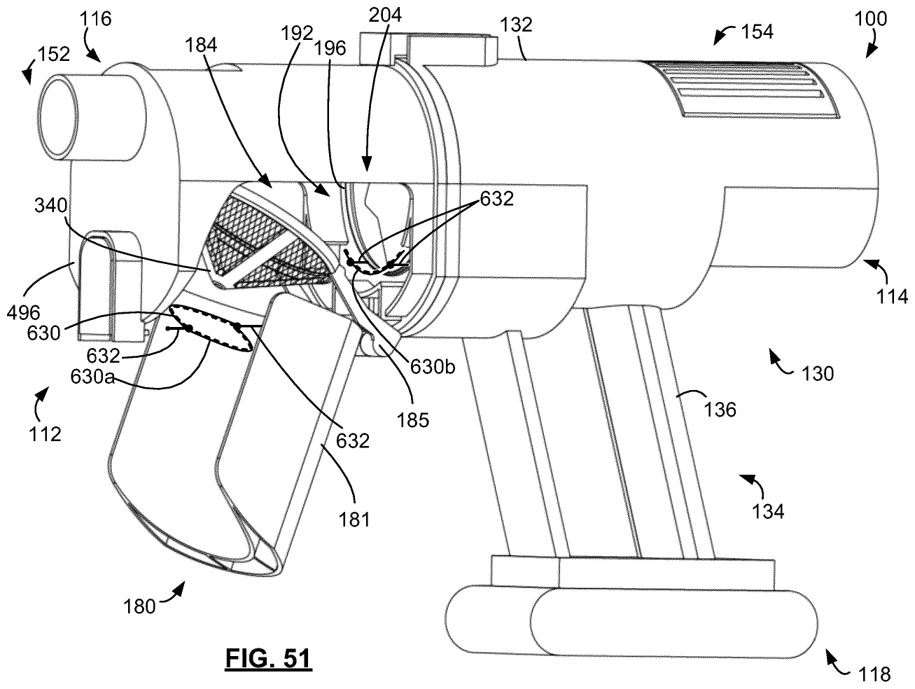

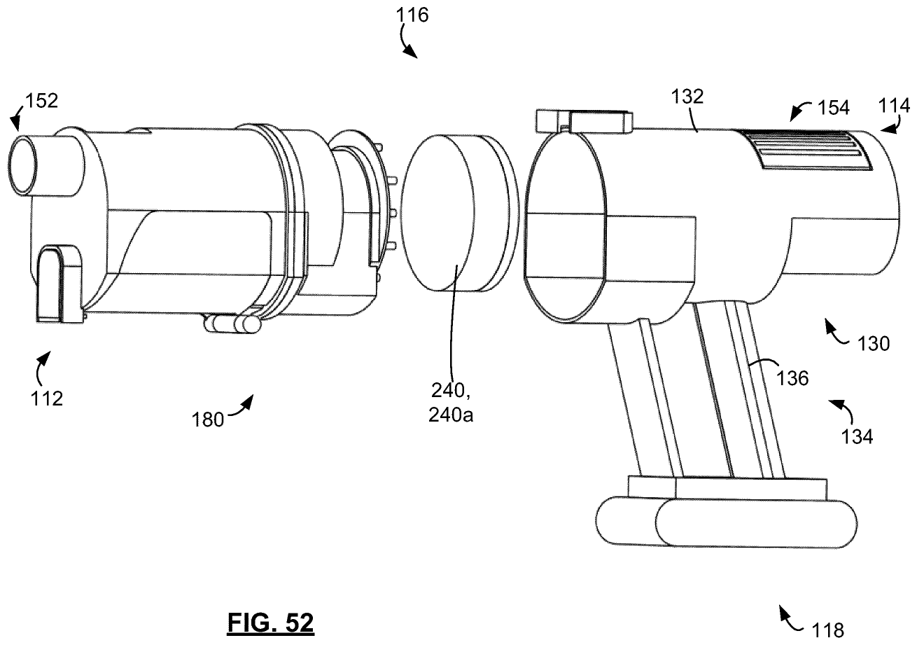

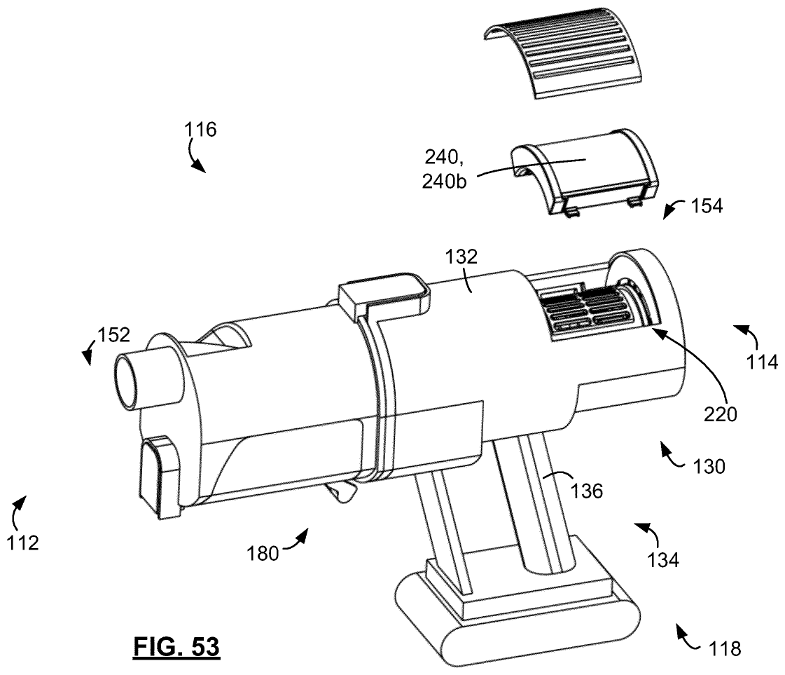

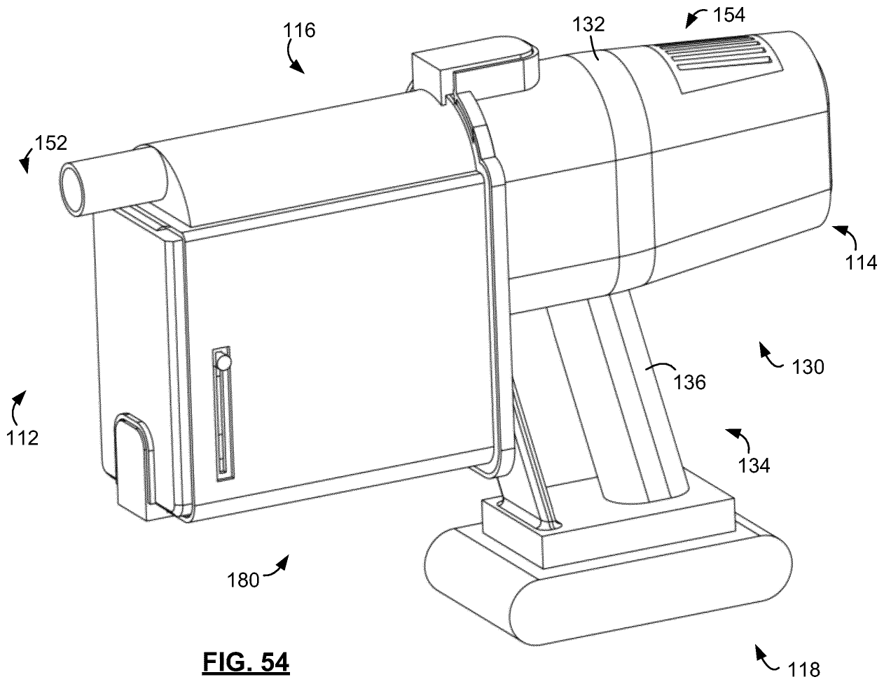

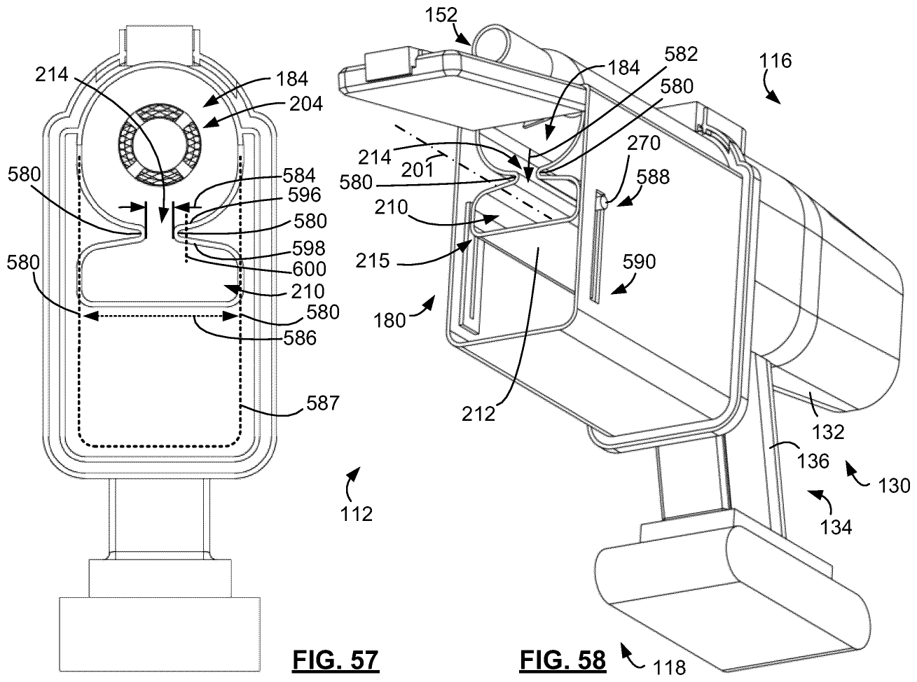

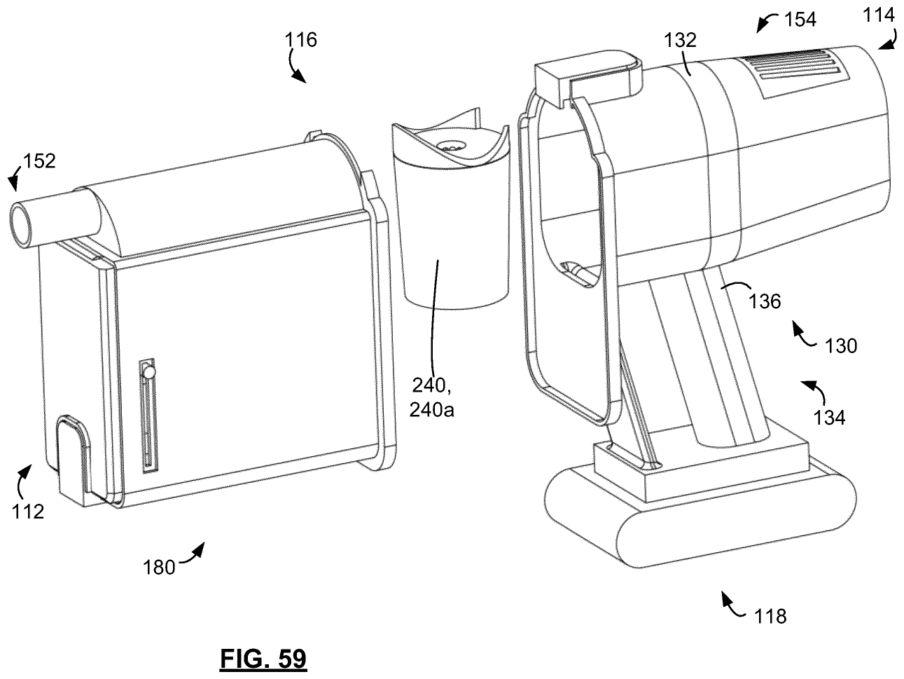

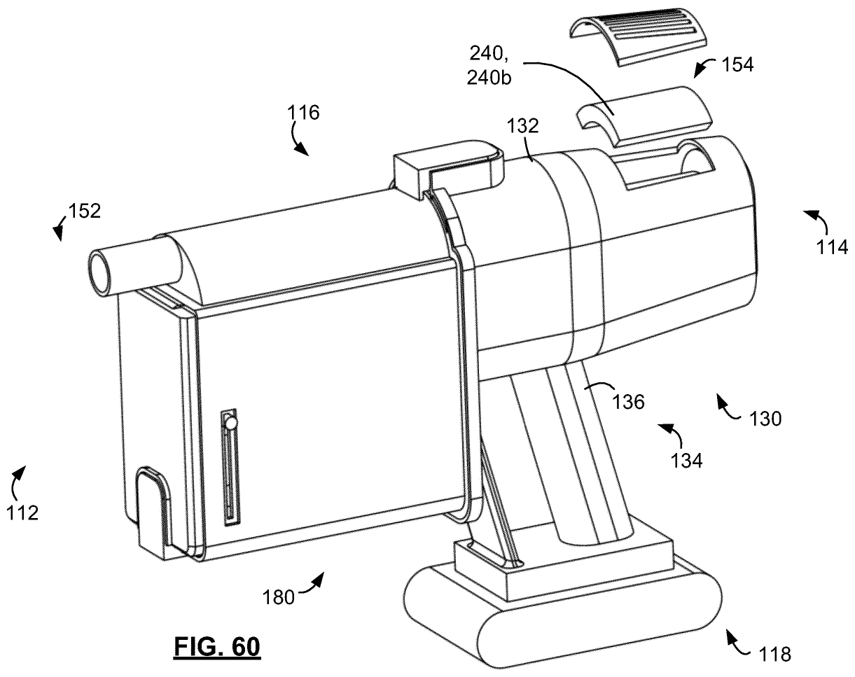

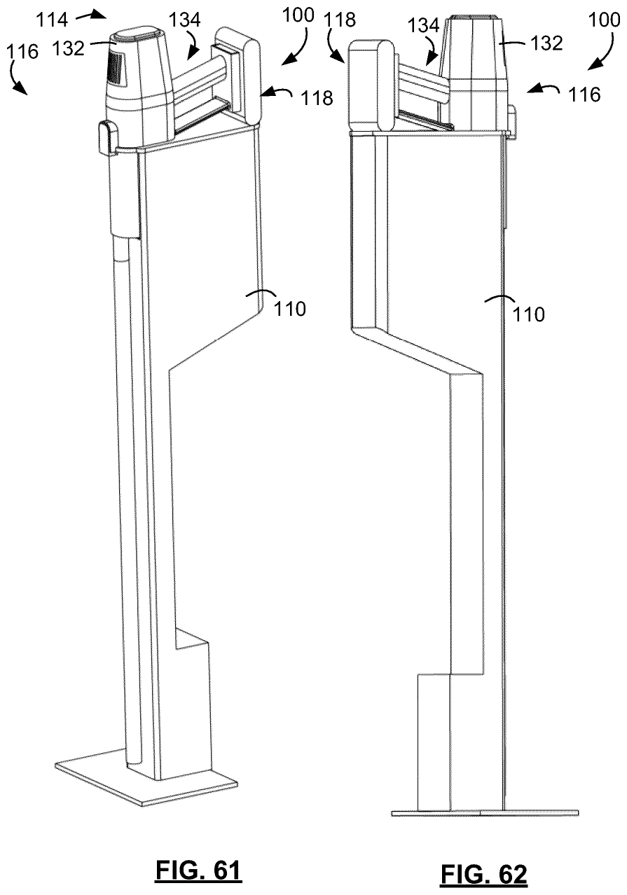

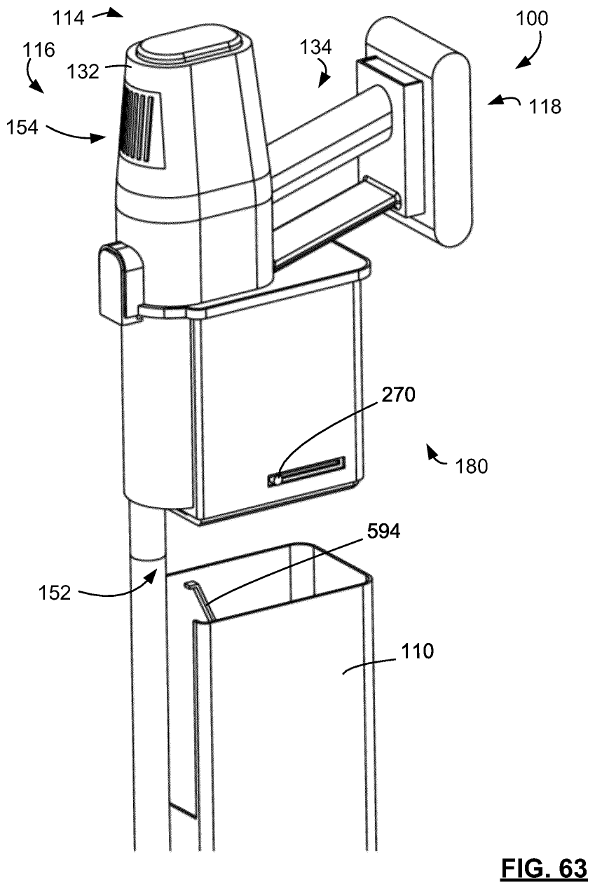

Referring to FIGS. 54 to 70, a surface cleaning apparatus 100 has a dirt collection chamber 210 in communication with a treatment chamber 184 via a dirt outlet 214. The dirt outlet 214 is formed by walls 580. In operation to clean a surface, dirt travels through the dirt outlet 214 from the air treatment chamber 184 to the dirt collection chamber 210 in a direction 582 (see e.g., FIGS. 57, 58).

The surface cleaning apparatus 100 is configurable between a first configuration (FIG. 57) in which the dirt outlet 214 has a first cross-sectional area in a plane transverse to the direction 582 and a second configuration (shown in phantom in FIG. 57) in which the dirt outlet 214 has a second, greater cross-sectional area in a plane transverse to the direction 582.

The cross-sectional area in a plane transverse to the direction 582 is increased by deforming at least a portion of one of the walls 580 defining the dirt outlet 214. At least a portion of one of the walls 580 may be formed of a flexible material. In some examples, the flexible material is an elastomeric material. The flexible material may deform between the first and second configurations to change the size of the dirt outlet 214 by moving away from at least one other of the walls 580. Movement of a wall or walls 580 may change the cross sectional area of the dirt outlet 214 in any suitable way, such as by widening and/or lengthening a slot-shaped outlet 214. Referring to FIG. 57, movement of the walls 580 changes the width of the slot-shaped outlet 214 from a first width 584 in the first configuration to a second, greater width 586 in the second configuration.

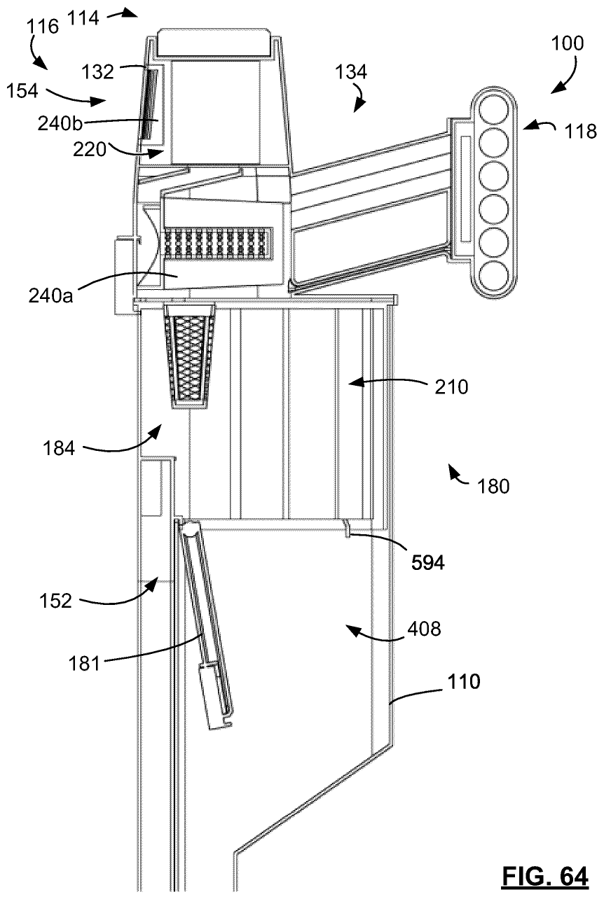

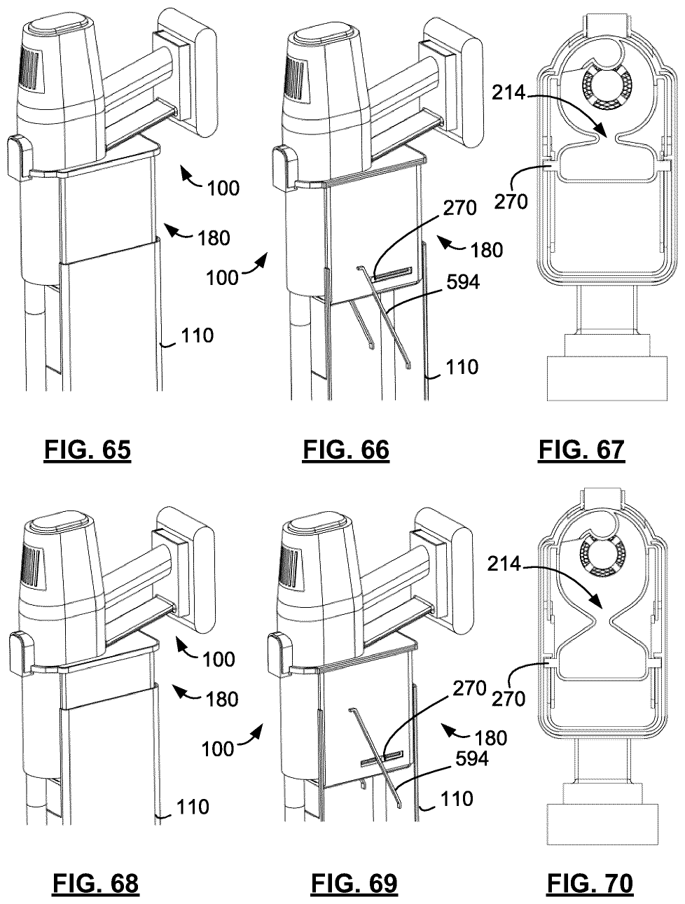

The flexible material may be deformed in any suitable way, such as by mechanical or pneumatic force pushing or pulling on the wall or by an electrical current running through the flexible material and changing properties of the flexible material (i.e., causing a controlled expansion or contraction). Referring to FIGS. 65-70, the exemplary surface cleaning apparatus 100 includes one or more actuators 270 operably coupled to at least one of the walls 580 to move the wall 580 away from another wall 580. As seen in FIG. 58, an actuator 270 is provided on each lateral side of the dirt collection chamber. Each actuator 270 is mechanically linked to the walls 580 via walls of the dirt collection chamber 210. For example, as exemplified, a slot is provided in each lateral wall of the dirt collection chamber and a drive member extends from the actuator 270 through the slot to a wall 580. Movement of the actuators 270 away from the dirt outlet 214 (downwardly as exemplified) draws the walls 580 apart by moving a portion thereof downwardly. Referring to FIG. 58, the exemplary actuators 270 are moved between a first position 588 and a second position 590. Moving the actuators 270 from the first position 588 to the second position 590 draws the lower end of the walls 580 downwardly. As a result, the inward recessed portion of the walls that define the opening move outwardly to enable the actuators 270 to draw the lower end of the walls downwardly and thereby move the walls 580 apart to the second distance 586.

The flexible material may be in any suitable configuration in the first configuration (FIG. 57) and second configurations (shown in phantom at 587 in FIG. 57) of the surface cleaning apparatus. In some examples, the flexible material is folded over itself in the first configuration. Accordingly, a wall 580 may be made of a dual wall structure having first wall portion 596 and a second wall portion 598. The first and second wall positions 596, 598 overlie each other. A plane 600 that is parallel to the direction 582 extends through the first and second wall portions 596, 598. it will be appreciated that the first and second wall portions 568, 569 may be hinged together at the dirt outlet 214. Alternately, as exemplified, the first and second wall portions 596, 598 may comprise an integrally formed flexible material. As exemplified, the first wall portion 596 is part of a wall of the air treatment chamber 184 and the second wall portion 598 is part of a wall of the dirt collection chamber 210. As exemplified, expansion of the dirt outlet 214 includes moving part of the first wall portion 596 away from part of the second wall portion 598. It will be apricated that the dual wall structure of first and second wall portions 596, 598 may be used without the wall 580 including a flexible portion, such as if the joint between the portions 596, 596 is a hinged joint and moving the portions 596, 598 apart draws the joint away from at least one other wall 580.

In an alternate embodiment, one or more second wall portions 598 may under lie one or more first wall portions 596 but not be connected thereto. Moving one or more second wall portions 598 relative to one or more first wall portions 596 (e.g., laterally and/or downwardly, may increase the size of the dirt outlet.

The walls 580 may be biased into the first configuration, such as by a biasing member. In some examples, the walls 580 are formed of a resilient material that returns to the first configuration.

In some examples, when the door 181 is moved to the open position, a cross-sectional area of the dirt outlet 214 in a plane transverse to the direction 582 is increased. Opening the door 181 may cause the expansion. The door 181 may be drivingly joined to the wall 580, such as mechanically joined, such that movement of the door away from the dirt outlet 214 moves the wall 580 away from one or more other wall 580. The door 181 may be, e.g., joined to the actuators 270 of FIG. 58 to move the actuators 270 between the first and second positions 588, 590 when the door 181 moves between open and closed positions. In some embodiments, the door 181 moves relative to another portion of the assembly 180 between open and closed positions, and the door 181 and other portion of the assembly 180 are joined to a wall 580 at different points causing the wall 580 to deform as the door 181 and other portion of the assembly are moved apart. For example, the door 181 may be joined to the other portion of the assembly 180 at the outlet end 192 (such as the door 181 of FIG. 51), e.g., at a pivot joint 185.

Alternatively, opening of the door 181 may cause the dirt outlet to expand 214 without the door 181 drivingly connected to the wall 580. For example, the control system 252 may sense the opening of the door 181 and responds by moving the wall 580 (e.g., through an electromechanically driving member).

Alternatively, the dirt outlet 214 may be expanded independently of the opening of the door 181 or by a common cause. Referring to FIGS. 61 to 70, docking the apparatus 100 may cause the door 181 to open and the dirt outlet 214 to expand. Docking the apparatus 100 may actuate an actuator 270 that releases the door 181 and actuate another actuator 270 that expands the dirt outlet 214. In some embodiments, the dock 110 includes slides 594 against which the actuators 270 drivingly coupled to the walls 580 are driven. As the apparatus 100 is moved into a docked position, the actuators 270 coupled to the walls 580 are guided by the slides from the first position 588 to the second position 590.

### Separately Movable Porous Member and Door

A hand vacuum cleaner using any one or more aspects discussed herein, including one or more of the other aspects set out herein in the general description and/or the detailed discussion, may have an air treatment chamber with a porous air outlet and air treatment assembly having an openable portion wherein the porous air outlet moves concurrently or subsequently to the openable portion of the air treatment assembly but moves less than the openable portion of the air treatment assembly.

In accordance with this aspect of the description, the porous member 340 may be moveable concurrently when the evacuation door 181 opens. The porous member 340 and the evacuation door 181 each move between operational positions for a cleaning operation and emptying positions for a dumping or evacuation operation. The porous member 340 moves a first distance between operational and emptying positions, and the door 181 moves a second distance between operational and emptying positions, the second distance being greater than the first distance. This opens up additional space between the porous member and the door 181 to allow for freer dirt movement from between the porous member and the door.

Referring to FIGS. 49 and 51, the air treatment assembly 180 comprises an openable portion (i.e., door 181) that is moveable between a closed position (FIG. 49) in which the apparatus 100 is operable to clean a surface and an open position (FIG. 51, also shown in phantom in FIG. 49) in which a dirt collection region of the air treatment assembly 180 is emptiable. The porous member 340 is moveable between an operating position (FIG. 49) in which the openable portion 181 is closed and the apparatus 100 is operable to clean a surface and a porous member cleaning position (FIG. 51, also shown in phantom in FIG. 49) in which the porous member is moved from its operating position. The open and cleaning positions allow for dirt emptying. Movement may also dislodge dirt that is adhered to a moving part or that is trapped between the moving part and another part.

In some embodiments, the door 181 moves a greater distance 609 as it moves to its open position than a distance 611 that the porous member travels as it moves to the porous member cleaning position. This provides a separation between the door 181 and the porous member 340. This separation may release dirt trapped between the two.

The door 181 and the porous member 340 may move in any suitable way, such as translationally or rotationally, as exemplified. In the open and cleaning positions, respectively, the door 181 and the porous member 340 may be secured to another component of the surface cleaning apparatus 100 (e.g., secured to a stationary wall of the assembly 180 by a hinge joint or other mechanical connection) or they may be secured to each other. For example, each may be moveably mounted (e.g., rotationally mounted) to a stationary portion of, e.g., the air treatment assembly, or one of the door 181 and the porous member 340 may be moveably mounted (e.g., rotationally mounted) to a stationary portion of, e.g., the air treatment assembly and the other of may be moveably mounted (e.g., rotationally mounted) to the one of the door 181 and the porous member 340 that is moveably mounted to a stationary portion.

Accordingly, the door 181 and the porous member 340 may each be rotatable about the same or a different rotational mount 614. The door 181 and the porous member 340 may be rotatable about a common rotational mount 614 or each may be mounted to a separate mount. In some embodiments in which the door 181 and porous member 340 are mounted to different rotational mounts, a plane that is transverse to the air treatment chamber axis 188 extends through both of the rotational mounts. Alternately one mount may be axially spaced from the other. The rotational mount or mounts may be provided at any suitable location on the assembly 180. In some embodiments, the rotational mount or mounts are provided at the rear end and/or dirt outlet end 192 of the assembly 180.

In some embodiments, the door 181 rotates a greater rotational angle 610 as it moves to its open position than the rotational angle 612 that the porous member 340 travels as it moves to the porous member cleaning position. For example, a clutch or the like may be used to limit the amount of rotation of the porous member relative to the door or the porous member 340 may have a limit of travel that is less than the limit of travel of the door.

The door 181 may have any suitable shape. Referring to FIG. 51, in some embodiments the door is U-shaped in a plane 620 (FIG. 49) that extends transverse to the air treatment chamber axis 188.

Optionally, a wiper 630 may travel over at least a portion of the porous member 340 as the porous member 340 and/or the door 181 moves between positions, or subsequent thereto. The wiper 630 may be mounted in any suitable way, such as a moveable mount to drive the wiper over the porous member 340 or a fixed mount to a member that moves relative to the porous member 340. In some embodiments, the wiper 630 is mounted to the door 181 and/or is part of the door 181, such as wiper 630a. In some embodiments, the wiper 630 is mounted to the rear wall 196 and/or is part of the rear wall 196, such as wiper 630b. The wiper 630 may be flexible and/or may be mounted via flexible mounting members 632. As the porous member 340 moves relative to the wiper, the wiper 630 and/or the mounting members 632 may bend to allow the porous member 340 to pass.

The wiper may be any suitable shape. In some embodiments, the wiper 630 is arcuate in shape, such as wiper 632b. In some embodiments, the wiper 630 is an annular member having an open interior, such as wiper 630a. In some examples, the porous member 340 is located radially inwardly of the annular member of the wiper when the surface cleaning apparatus 100 is in the in-use configuration.

### Dock Dirt Collection Region Supported Above a Floor

A dock 110 using any one or more aspects discussed herein, including one or more of the other aspects set out herein in the general description and/or the detailed discussion, includes a dirt collection region 210 which is raised above the surface on which the dock 110 rests. The collection region 210 is raised to provide easier access to the collection region for a user when emptying the dock collection region. The dock 110 may include an arm between a base and a treatment assembly to position the treatment assembly to the more accessible height. The arm may be a support (e.g., a strut) with the air flow path 420 of the dock entirely contained above the arm.

Referring to FIG. 19, the dock 110 includes an air treatment member 444 and a dirt collection region 210. The dirt collection region 210 may be within an air treatment chamber 184 of the member 444 or in a separate chamber. The dirt collection region 210 is raised above the floor 640 for easier user access, e.g., to open and remove the dirt collection member or to remove the air treatment member for emptying. The dirt collection region 210 may be raised by at least 1, 2 or 3 feet.

In some embodiments, the air flow path 420 of the dock and/or the treatment assembly 180 as a whole is raised above the floor 640. The air flow path 420 of the dock and/or the treatment assembly 180 as a whole may be raised above the floor 640 at least 1, 2 or 3 feet. The dock 110 may include an arm 642 extending from a base 644 to lift the air handling components of the dock 110 above the floor 640. The arm 642 may be a column or strut. In some embodiments, the arm 642 extends generally vertically and/or generally perpendicular to a bottom surface of the base 644.

### Horizontal Treatment Chamber and Vertical Pre-Motor Filter

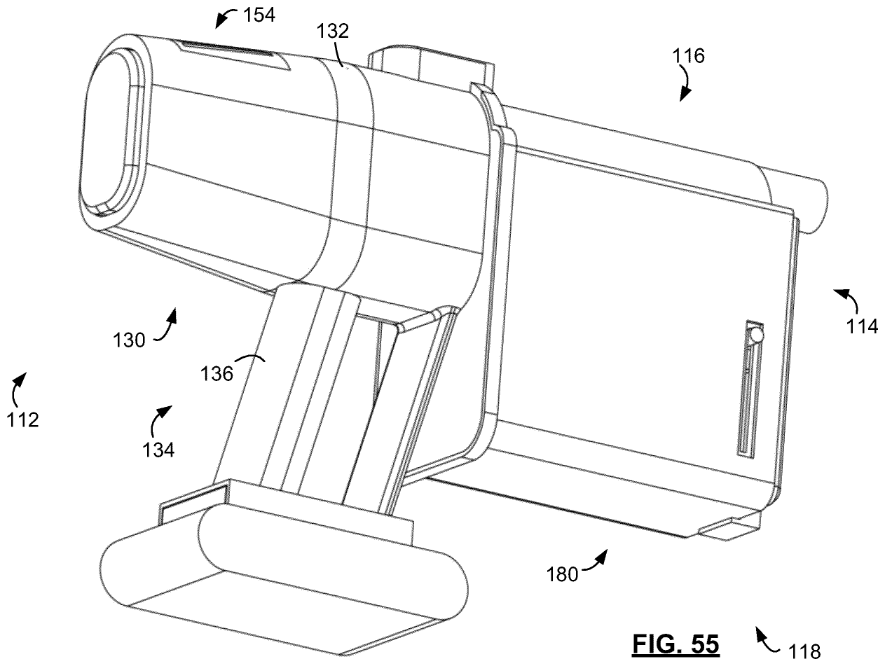

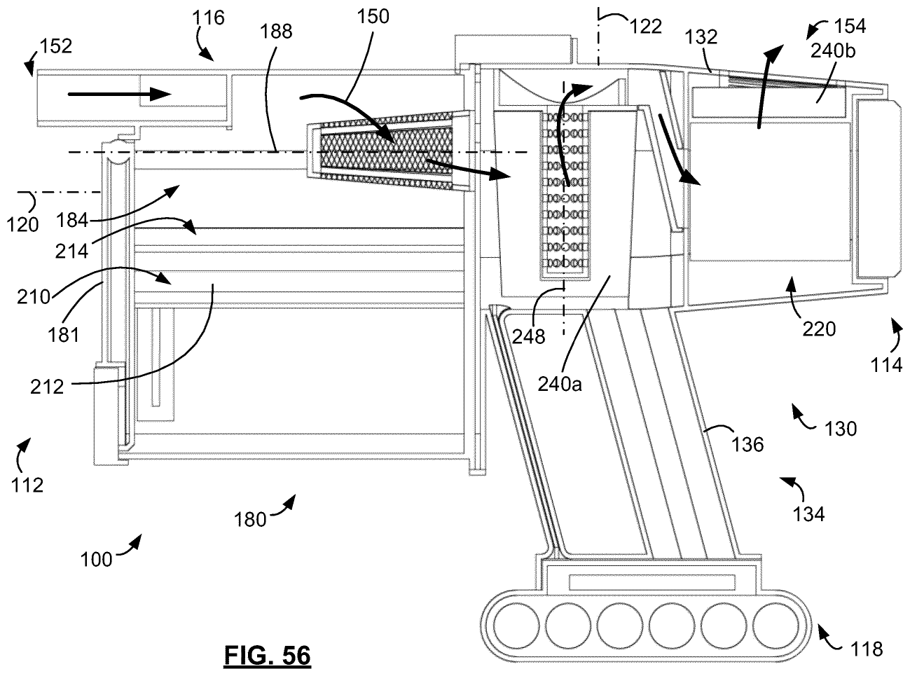

A hand vacuum cleaner using any one or more aspects discussed herein, including one or more of the other aspects set out herein in the general description and/or the detailed discussion, may have an air treatment chamber 184 with a generally forwardly-rearwardly extending axis 188 (e.g., cyclone axis of rotation) and a pre-motor donut filter 240a with a generally upwardly-downwardly extending axis 248 (in the orientation of FIG. 56). The treatment chamber axis 188 may be generally parallel to the longitudinal axis 120. The filter axis 248 may be generally parallel to the vertical axis 122 in the orientation of FIG. 56. The treatment chamber axis 188 and the filter axis 248 may be essentially perpendicular to one another.

Referring to FIG. 56, the surface cleaning apparatus 100 includes an air treatment chamber 184 with a generally forwardly-rearwardly extending axis 188 and a pre-motor filter 240a with a generally upwardly-downwardly extending axis 248. The pre-motor filter 240a is rearward of the air treatment chamber 184. The air treatment chamber 184 is a cyclone chamber. The air moving member 220 is rearward of the pre-motor filter 240a. In some embodiments, the handle 134 is below the pre-motor filter 240a.

In some embodiments, the treatment chamber 184 is selectively openable (e.g., via a door 181) and/or a dirt collection chamber 212 communicating with the chamber 184 via a dirt outlet 214 is selectively openable. A dock 110 may receive the apparatus 100, and the selectively openable chamber may be openable into an air flow path 420 of the dock 110.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. Accordingly, what has been described above is intended to be illustrative of the claimed concept and non-limiting. It will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

### Clause Set A

1. A surface cleaning apparatus comprising:
   (a) an air flow path extending from a dirty air inlet to a clean air outlet with a suction motor and an air treatment member provided in the air flow path; and,
   (b) a filter housing which, in operation of the surface cleaning apparatus, houses a filter, wherein the filter comprises a pleated porous filter media having a first end located at a first end member and a second axially opposed end at a second end member, the pleated filter media extends axially inwardly from the first end member towards the second end member and the pleated filter media also extends axially inwardly from the second end member towards the first end member, the radial outer surface of the pleated porous filter media has a plurality of generally axially extending recesses positioned between opposed generally axially extending sidewalls and, at the position of the first end member, the generally axially extending recesses are radially open.
2. The surface cleaning apparatus of clause 1 wherein, at the position of the second end member, the generally axially extending recesses are radially open.
3. The surface cleaning apparatus of clause 1 wherein the first end member has an axially outer side and an axially inner side, the pleated porous filter media extends inwardly from the axially inner side and the axially inner side terminates axially outwardly of the generally axially extending recesses.
4. The surface cleaning apparatus of clause 2 wherein the first end member has an axially outer side and an axially inner side, the pleated porous filter media extends inwardly from the axially inner side of the first end member and the axially inner side of the first end member terminates axially outwardly of the generally axially extending recesses and wherein the second end member has an axially outer side and an axially inner side, the pleated porous filter media extends inwardly from the axially inner side of the second end member and the axially inner side of the second end member terminates axially outwardly of the generally axially extending recesses.
5. The surface cleaning apparatus of clause 1 wherein the first end member is air impermeable.
6. The surface cleaning apparatus of clause 5 wherein the second end member is air impermeable.
7. The surface cleaning apparatus of clause 1 wherein the pleated porous filter media is frusto-conical.
8. The surface cleaning apparatus of clause 1 wherein the axially outer side of the first end member is generally planar.
9. The surface cleaning apparatus of clause 1 wherein the second end member is annular wherein, in operation, air passes generally radially inwardly through the pleated filter media to an open interior of the pleated filter media and then generally axially out a radial inner opening of the second end member.

### Clause Set B

1. A surface cleaning apparatus comprising:
   (a) an air flow path extending from a dirty air inlet to a clean air outlet with a suction motor provided in the air flow path; and,
   (b) an air treatment member provided in the air flow path, the air treatment member comprising an air treatment chamber having an air treatment chamber air inlet and an air treatment chamber air outlet, the air treatment chamber air outlet comprising a porous member having an openable portion,
   wherein the surface cleaning apparatus is operable in a surface cleaning mode in which air is drawn into the air treatment chamber through the air treatment chamber air inlet and air exits the air treatment chamber through the air treatment chamber air outlet, and
   wherein the surface cleaning apparatus is operable in an evacuation mode in which air is drawn into the air treatment chamber through the air treatment chamber air outlet and dirt is evacuated from the air treatment chamber through an evacuation door, and
   wherein, in the surface cleaning mode, the openable portion of the porous member is in a closed position and, in the evacuation mode, the air flow entering the air treatment chamber through the porous member moves the openable portion to an open position.
2. The surface cleaning apparatus of clause 1 wherein, in the evacuation mode, the suction motor is operable at a first power level in which the openable portion is in the closed position and at a second higher power level in which the openable portion is in the open position.
3. The surface cleaning apparatus of clause 2 wherein a biasing member provides a biasing force that biases the openable portion to the closed position and the second power level produces an air flow having an air flow force that is greater than the biasing force.
4. The surface cleaning apparatus of clause 3 wherein the biasing force acts in an axial direction and the air flow force acts in a direction opposite to the axial direction.
5. The surface cleaning apparatus of clause 1 wherein the suction motor is positioned downstream of the air treatment chamber.
6. The surface cleaning apparatus of clause 1 wherein the air treatment chamber comprises a cyclone.
7. The surface cleaning apparatus of clause 1 wherein a filter is at least partially nested in the porous member.
8. The surface cleaning apparatus of clause 1 wherein the porous member comprises a screen.
9. The surface cleaning apparatus of clause 8 wherein the openable portion comprises an axially inner end of the porous member.
10. The surface cleaning apparatus of clause 1 wherein the evacuation door is the air treatment chamber air inlet.
11. The surface cleaning apparatus of clause 1 wherein an evacuation port is opened when the evacuation door is in an open position, and the evacuation port is an additional port to an outlet port of the air treatment chamber air inlet.
12. The surface cleaning apparatus of clause 11 wherein the air treatment chamber air inlet has an associated closure member which closes the air treatment chamber air inlet in the evacuation mode.
13. A surface cleaning apparatus comprising:
   (a) an air flow path extending from a dirty air inlet to a clean air outlet with a suction motor provided in the air flow path; and,
   (b) an air treatment member provided in the air flow path, the air treatment member comprising an air treatment chamber having an air treatment chamber air inlet and an air treatment chamber air outlet, the air treatment chamber air outlet comprising a porous member having an openable portion,
   wherein the surface cleaning apparatus is operable in a surface cleaning mode in which air is drawn into the air treatment chamber through the air treatment chamber air inlet and air exits the air treatment chamber through the air treatment chamber air outlet, and
   wherein the surface cleaning apparatus is operable in an evacuation mode in which air is drawn into the air treatment chamber through the air treatment chamber air outlet and dirt is evacuated from the air treatment chamber through an evacuation door, and
   wherein, in the surface cleaning mode, the openable portion of the porous member is in a closed position and, in the evacuation mode, the openable portion is in an open position.
14. The surface cleaning apparatus of clause 13 wherein, in the evacuation mode, the suction motor is operable at a first power level in which the openable portion is in the closed position and at a second higher power level in which the openable portion is in the open position.
15. The surface cleaning apparatus of clause 14 wherein a biasing member provides a biasing force that biases the openable portion to the closed position.
16. The surface cleaning apparatus of clause 13 wherein the suction motor is positioned downstream of the air treatment chamber.
17. The surface cleaning apparatus of clause 13 wherein the air treatment chamber comprises a cyclone.
18. The surface cleaning apparatus of clause 13 wherein a pre-motor filter is downstream of the porous member.
19. The surface cleaning apparatus of clause 13 wherein the porous member comprises a screen and the openable portion comprises an axially inner end of the porous member.
20. The surface cleaning apparatus of clause 13 wherein the evacuation door is the air treatment chamber air inlet.
21. The surface cleaning apparatus of clause 13 wherein an evacuation port is opened when the evacuation door is in an open position, and the evacuation port is an additional port to an outlet port of the air treatment chamber air inlet.
22. The surface cleaning apparatus of clause 21 wherein the air treatment chamber air inlet has an associated closure member which closes the air treatment chamber air inlet in the evacuation mode.

### Clause Set C

1. A surface cleaning apparatus comprising:
   (a) an air flow path extending from a dirty air inlet to a clean air outlet with a suction motor provided in the air flow path;
   (b) an air treatment member provided in the air flow path, the air treatment member comprising an air treatment chamber having an air treatment chamber air inlet and an air treatment chamber air outlet, the air treatment chamber air outlet comprising a porous member; and,
   (c) in operation, a pre-motor filter media having an open interior,
   wherein the surface cleaning apparatus is operable in a surface cleaning mode in which air is drawn into the air treatment chamber through the air treatment chamber air inlet, air exits the air treatment chamber through the air treatment chamber air outlet and then air passes generally inwardly through the filter media to the open interior of the filter media and then generally axially out a radial inner opening of the filter media, and
   wherein the surface cleaning apparatus is operable in an evacuation mode in which air is drawn into the air treatment chamber through the air treatment chamber air outlet and dirt is evacuated from the air treatment chamber through an evacuation door, and
   wherein, in the evacuation mode, a directing member directs at least some of the air flow entering the open interior of the filter media outwardly through the filter media.
2. The surface cleaning apparatus of clause 1 wherein the directing member comprises at least one vane.
3. The surface cleaning apparatus of clause 1 wherein the directing member comprises at least one baffle.
4. The surface cleaning apparatus of clause 1 wherein the directing member is at least partially nested in the open interior of the filter media.
5. The surface cleaning apparatus of clause 1 wherein the directing member comprises an inner support frame of the filter media.
6. The surface cleaning apparatus of clause 1 wherein the air treatment chamber comprises a cyclone.
7. The surface cleaning apparatus of clause 1 wherein the pre-motor filter is at least partially nested in the porous member.
8. The surface cleaning apparatus of clause 1 wherein the porous member comprises a screen.
9. The surface cleaning apparatus of clause 1 wherein the evacuation door is the air treatment chamber air inlet.
10. The surface cleaning apparatus of clause 1 wherein an evacuation port is opened when the evacuation door is in an open position, and the evacuation port is an additional port to an outlet port of the air treatment chamber air inlet.
11. The surface cleaning apparatus of clause 1 wherein, in the surface cleaning mode, an openable portion of the porous member is in a closed position and, in the evacuation mode, the openable portion is in an open position.
12. The surface cleaning apparatus of clause 1 wherein the pre-filter comprises a pleated porous filter media having a first end located at a first end member and a second axially opposed end at a second end member, the pleated filter media extends axially inwardly from the first end member towards the second end member and the pleated filter media also extends axially inwardly from the second end member towards the first end member, the radial outer surface of the pleated porous filter media has a plurality of generally axially extending recesses positioned between opposed generally axially extending sidewalls and, at the position of the first end member, the generally axially extending recesses are radially open.

### Clause Set D

1. A surface cleaning apparatus comprising:
   (a) an air flow path extending from a dirty air inlet to a clean air outlet with a suction motor provided in the air flow path; and,
   (b) an air treatment member provided in the air flow path, the air treatment member comprising an air treatment chamber having a first end, a second end, an air treatment chamber axis that extends through a central portion of the air treatment chamber from the first end to the second end, an air treatment chamber air inlet and an air treatment chamber air outlet at an outlet end of the air treatment member, the air treatment chamber air outlet comprising a porous member that extends axially into the air treatment chamber from the outlet end of the air treatment member,
   wherein the surface cleaning apparatus is operable in a surface cleaning mode in which air is drawn into the air treatment chamber through the air treatment chamber air inlet, air exits the air treatment chamber through the air treatment chamber air outlet, and
   wherein the surface cleaning apparatus is operable in an evacuation mode in which air is drawn into the air treatment chamber through the air treatment chamber air outlet and dirt is evacuated from the air treatment chamber through an evacuation door, and
   wherein, during at least a portion of the evacuation mode, the porous member is rotated about the air treatment chamber axis.
2. The surface cleaning apparatus of clause 1 wherein the surface cleaning apparatus is a hand vacuum cleaner, the dirty air inlet is provided at a front end of the hand vacuum cleaner, the first end of the air treatment chamber is a front end of the hand vacuum cleaner and the second end of the air treatment chamber is a rear end of the air treatment chamber.
3. The surface cleaning apparatus of clause 2 wherein the air treatment chamber comprises a cyclone.
4. The surface cleaning apparatus of clause 1 wherein the air treatment chamber comprises a cyclone.
5. The surface cleaning apparatus of clause 1 further comprising, in operation, a pre-motor filter comprising a filter media downstream of the porous member.
6. The surface cleaning apparatus of clause 5 wherein the pre-motor filter is at least partially nested in the porous member.
7. The surface cleaning apparatus of clause 5 wherein, during at least a portion of the evacuation mode, the pre-motor filter is also rotated about the air treatment chamber axis.
8. The surface cleaning apparatus of clause 6 wherein, during at least a portion of the evacuation mode, the pre-motor filter is also rotated about the air treatment chamber axis.
9. The surface cleaning apparatus of clause 2 wherein the air treatment chamber comprises a cyclone.
10. The surface cleaning apparatus of clause 2 further comprising, in operation, a pre-motor filter comprising a filter media downstream of the porous member.
11. The surface cleaning apparatus of clause 10 wherein the pre-motor filter is at least partially nested in the porous member.
12. The surface cleaning apparatus of clause 10 wherein, during at least a portion of the evacuation mode, the pre-motor filter is also rotated about the air treatment chamber axis.
13. The surface cleaning apparatus of clause 11 wherein, during at least a portion of the evacuation mode, the pre-motor filter is also rotated about the air treatment chamber axis.
14. A surface cleaning apparatus comprising:
   (a) an air flow path extending from a dirty air inlet to a clean air outlet with a suction motor provided in the air flow path; and,
   (b) an air treatment member provided in the air flow path, the air treatment member comprising an air treatment chamber having a first end, a second end, an air treatment chamber axis that extends through a central portion of the air treatment chamber from the first end to the second end, an air treatment chamber air inlet and an air treatment chamber air outlet at an outlet end of the air treatment member, the air treatment chamber air outlet comprising a porous member that extends axially into the air treatment chamber from the outlet end of the air treatment member; and,
   (c) in operation, a pre-motor filter media having an open interior,
   wherein the surface cleaning apparatus is operable in a surface cleaning mode in which air is drawn into the air treatment chamber through the air treatment chamber air inlet, air exits the air treatment chamber through the air treatment chamber air outlet and then air passes generally inwardly through the filter media to the open interior of the filter media and then generally axially out a radial inner opening of the filter media, and
   wherein the surface cleaning apparatus is operable in an evacuation mode in which air is drawn into the air treatment chamber through the air treatment chamber air outlet and dirt is evacuated from the air treatment chamber through an evacuation door, and
   wherein, during at least a portion of the evacuation mode, the pre-motor filter is rotated about the air treatment chamber axis.
15. The surface cleaning apparatus of clause 14 wherein the surface cleaning apparatus is a hand vacuum cleaner, the dirty air inlet is provided at a front end of the hand vacuum cleaner, the first end of the air treatment chamber is a front end of the hand vacuum cleaner and the second end of the air treatment chamber is a rear end of the air treatment chamber.
16. The surface cleaning apparatus of clause 16 wherein the air treatment chamber comprises a cyclone.
17. The surface cleaning apparatus of clause 15 wherein the pre-motor filter is at least partially nested in the porous member.

### Clause Set E

1. A surface cleaning apparatus comprising:
   (a) an air flow path extending from a dirty air inlet to a clean air outlet with a motor and fan assembly and an air treatment member provided in the air flow path;
   (b) a surface cleaning head having an air flow path extending from a dirty air inlet to a surface cleaning head air outlet with a brush associated with the dirty air inlet; and,
   (c) a bleed valve having a bleed valve air inlet and a bleed valve air outlet,
   wherein, in operation, the bleed valve is automatically adjusted between a first low flow mode and a high flow mode based on the type of surface being cleaned.
2. The surface cleaning apparatus of clause 1 wherein, in operation, the bleed valve is automatically adjusted between the first low flow mode when the surface being cleaned is a carpet having a first pile height, and the high flow mode when the surface being cleaned is a carpet having a second pile height, and the second pile height is greater than the first pile height.
3. The surface cleaning apparatus of clause 2 wherein the brush is a rotatably mounted carpet cleaning brush and the rotatably mounted carpet cleaning brush is operated when the bleed valve is in the high flow mode and in the first low flow mode.
4. The surface cleaning apparatus of clause 1 wherein the bleed valve is also operable in a second low flow mode wherein, in the first low flow mode, a first bleed air stream provides a first volume of air per unit time and, in the second low flow mode, a second bleed air stream provides a second volume of air per unit time that is greater than the first bleed air stream.
5. The surface cleaning apparatus of clause 4 wherein, in operation, the bleed valve is automatically adjusted between the first low flow mode when the surface being cleaned is a hard floor, the second low flow mode when the surface being cleaned is a carpet having a first pile height, and the high flow mode when the surface being cleaned is a carpet having a second pile height, and the second pile height is greater than the first pile height.
6. The surface cleaning apparatus of clause 5 wherein the brush is a rotatably mounted carpet cleaning brush, the surface cleaning head further comprises a hard floor cleaning brush, and the rotatably mounted carpet cleaning brush is operated when the bleed valve is in the high flow mode and the second low flow mode, and the hard floor cleaning brush is a rotatably mounted brush that is operated when the bleed valve is in the first low flow mode.
7. The surface cleaning apparatus of clause 6 wherein the rotatably mounted carpet cleaning brush is disengaged from the surface or raised above the surface when the bleed valve is in the first low flow mode and the hard floor cleaning brush is disengaged from the surface or raised above the surface when the bleed valve is in the high flow mode and the second low flow mode.
8. The surface cleaning apparatus of clause 1 wherein, in operation, the bleed valve is automatically adjusted between the first low flow mode when the surface being cleaned is a hard floor, and the high flow mode when the surface being cleaned is a carpet.
9. The surface cleaning apparatus of clause 7 wherein the brush is a rotatably mounted carpet cleaning brush, the surface cleaning head further comprises a hard floor cleaning brush, and the rotatably mounted carpet cleaning brush is operated when the bleed valve is in the high flow mode, and the hard floor cleaning brush is a rotatably mounted brush that is operated when the bleed valve is in the first low flow mode.
10. The surface cleaning apparatus of clause 9 wherein the rotatably mounted carpet cleaning brush is disengaged from the surface or raised above the surface when the bleed valve is in the first low flow mode and the hard floor cleaning brush is disengaged from the surface or raised above the surface when the bleed valve is in the high flow mode.
11. The surface cleaning apparatus of clause 1 wherein the brush is a rotatably mounted brush.
12. The surface cleaning apparatus of clause 1 wherein the brush is a rotatably mounted carpet cleaning brush and the surface cleaning head further comprises a hard floor cleaning brush.
13. The surface cleaning apparatus of clause 1 further comprising a surface type detector.
14. The surface cleaning apparatus of clause 13 wherein the surface type detector comprises an optical sensor.
15. The surface cleaning apparatus of clause 13 wherein, in operation, the surface type detector sends a signal to a controller which sends a signal to adjust the mode of the bleed valve based on the signal from the surface type detector.
16. The surface cleaning apparatus of clause 14 wherein, in operation, the optical sensor sends a signal to a controller which sends a signal to adjust the mode of the bleed valve based on the signal from the optical sensor.

### Clause Set F

1. A surface cleaning apparatus comprising:
   (a) an air flow path extending from a dirty air inlet to a clean air outlet with a motor and fan assembly provided in the air flow path;
   (b) an air treatment member provided in the air flow path, the air treatment member comprising a dirt collection region having an openable portion;
   (c) a first lock comprising an actuator which is operable to move the first lock from a locked position of the first lock to an unlocked position of the first lock; and,
   (d) a second lock operable between a locked position of the second lock and an unlocked position of the second lock;
   wherein, when the first lock is in the unlocked position of the first lock, and when the second lock is in the locked position of the second lock, the openable portion is maintained in a closed position, and
   wherein the openable portion is moveable to an open position when the first lock is in the unlocked position of the first lock and when the second lock is in the unlocked position of the second lock, and
   wherein the second lock is moveable to the unlocked position of the second lock upon occurrence of an event that occurs subsequent to the first lock moving to the unlocked position of the first lock.
2. The surface cleaning apparatus of clause 1 wherein the actuator is manually actuatable by a user or by engagement with a docking station when the surface cleaning apparatus is docked at the docking station.
3. The surface cleaning apparatus of clause 1 wherein the event comprises a period of time during which the motor and fan assembly is operated during an evacuation cyclone when the surface cleaning apparatus is docked at a docking station.
4. The surface cleaning apparatus of clause 3 further comprising a controller that is operably connected to the second lock and, after the motor and fan assembly has been operated for the period of time, the controller issues a signal whereupon the second lock is moved to the unlocked position of the second lock.
5. The surface cleaning apparatus of clause 4 wherein the second lock comprises first and second engagement members and an electromechanical member that is drivingly connected to the first engagement member, the first engagement member is moveable from a locked position in which the first engagement member engages the second engagement member and an unlocked position in which the first engagement member is disengaged from the second engagement member and, when the controller issues the signal, the electromechanical member moves the first engagement member to the disengaged position.
6. The surface cleaning apparatus of clause 1 wherein, subsequent to the dirt collection region being docked at a docking station, the motor and fan assembly is actuated, and the event comprises a period of time subsequent to the commencement of operation of the motor and fan assembly after the surface cleaning apparatus is docked at a docking station.
7. The surface cleaning apparatus of clause 1 wherein the event comprises a pressure level in the dirt collection region exceeding a preset pressure.
8. The surface cleaning apparatus of clause 1 wherein, subsequent to the dirt collection region being docked at a docking station, the motor and fan assembly is actuated, and the event comprises a pressure in the dirt collection region exceeding a preset pressure.
9. The surface cleaning apparatus of clause 1 wherein the event comprises a pressure exterior to the openable portion being below a pre-set pressure.
10. The surface cleaning apparatus of clause 1 wherein, subsequent to the dirt collection region being docked at a docking station, the motor and fan assembly is actuated, and the event comprises a pressure in the docking station at a location adjacent the exterior of the openable portion being below a pre-set pressure.
11. A method of evacuating a dirt collection region of a surface cleaning apparatus, the surface cleaning apparatus having a first lock and a second lock and the dirt collection region having an openable portion, the method comprises:
   (a) docking the dirt collection region at a docking station whereupon a first lock is moved to an unlocked position of the first lock and the openable portion is maintained in a closed position by the second lock; and,
   (b) operating a motor and fan assembly until an event occurs whereupon a second lock is moved to an unlocked position of the second lock, whereupon the openable portion is moved to an open position.
12. The method of clause 11 wherein the event comprises the motor and fan assembly operating for a preset period of time.
13. The method of clause 11 wherein the event comprises a pressure level in the dirt collection region exceeding a preset pressure.
14. The method of clause 11 wherein the event comprises a pressure level in the docking station exterior to the openable portion being below a pre-set pressure.
15. The method of clause 11 wherein one of the surface cleaning apparatus and the docking station comprises a controller and, upon the occurrence of the event, the controller issues a signal whereby the second lock is moved to the unlocked position.
16. The method of clause 11 wherein one of the surface cleaning apparatus and the docking station comprises a controller that is operably connected to an electromechanical member, the electromechanical member is drivingly connected to the second lock and, upon the occurrence of the event, the controller issues a signal to the electrotechnical member which drives the second lock to the unlocked position.

### Clause Set G

1. An assembly comprising:
   (a) a surface cleaning apparatus comprising:
      (i) an air flow path extending from a dirty air inlet to a clean air outlet with a motor and fan assembly provided in the air flow path; and,
      (ii) an air treatment member provided in the air flow path, the air treatment member comprising a dirt collection region having an openable portion;
   (b) a docking station for the surface cleaning apparatus, the docking station comprising:
      (i) a docking station air flow path extending from a docking station air inlet to a docking station air outlet; and,
      (ii) a docking station air treatment member provided in the docking station air flow path,
      wherein a first portion of the docking station air flow path upstream of the docking station air treatment member has a first cross-sectional area in a first plane transverse to a direction of flow through the first portion, and
      wherein a second portion of the docking station air flow path upstream of the docking station air treatment member and downstream of the first portion has a second cross-sectional area in a second plane transverse to a direction of flow through the second portion and the second cross-sectional area is less than the first cross-sectional area.
2. The assembly of clause 1 wherein an inlet end of the second portion is located at the outlet end of the first portion.
3. The assembly of clause 2 wherein the first and second portions comprise a tapered section of the docking station air flow path.
4. The assembly of clause 1 wherein, during an evacuation cyclone when the surface cleaning apparatus is docked at the docking station, the motor and fan assembly is in flow communication with the docking station air outlet whereby the motor and fan assembly draws air from the dirt collection region into the docking station.
5. The assembly of clause 1 wherein the docking station has a suction motor and, during an evacuation cyclone when the surface cleaning apparatus is docked at the docking station, the suction motor draws air from the dirt collection region into the docking station.

### Clause Set H

1. A surface cleaning apparatus comprising:
   (a) an air flow path extending from a dirty air inlet to a clean air outlet with a suction motor provided in the air flow path; and,
   (b) a first stage air treatment member provided in the air flow path, the first stage air treatment member comprising a first stage dirt collection region and a first stage openable portion moveable between a closed position in which the first stage dirt collection region is closed and an open position in which the first stage dirt collection region is emptiable; and,
   (c) a second stage air treatment member provided in the air flow path downstream of the first stage air treatment member, the second stage air treatment member comprising a second stage dirt collection region and a second stage openable portion moveable between a closed position in which the second stage dirt collection region is closed and an open position in which the second stage dirt collection region is emptiable.
2. The surface cleaning apparatus of clause 1 wherein the first stage air treatment member comprises a first stage air treatment chamber having a first stage air treatment chamber air inlet and a first stage air treatment chamber air outlet and wherein the second stage air treatment member comprises a second stage air treatment chamber having a second stage air treatment chamber air inlet and a second stage air treatment chamber air outlet.
3. The surface cleaning apparatus of clause 2 wherein the first stage air treatment chamber comprises a first stage cyclone and the second stage air treatment chamber comprises a second stage cyclone.
4. The surface cleaning apparatus of clause 2 further comprising a pre-motor filter downstream of the second stage cyclone.
5. The surface cleaning apparatus of clause 2 further comprising a pre-motor filter downstream of the second stage air treatment chamber.
6. The surface cleaning apparatus of clause 1 wherein the first stage openable portion and the second stage openable portion are concurrently openable.
7. The surface cleaning apparatus of clause 1 wherein the first stage openable portion and the second stage openable portion are sequentially openable.
8. The surface cleaning apparatus of clause 1 wherein the first stage openable portion and the second stage openable portion are provided on a common side of the surface cleaning apparatus.
9. An assembly comprising:
   (a) a surface cleaning apparatus comprising:
      (i) an air flow path extending from a dirty air inlet to a clean air outlet with a suction motor provided in the air flow path; and,
      (ii) a first stage air treatment member provided in the air flow path, the first stage air treatment member comprising a first stage dirt collection region and a first stage openable portion moveable between a closed position in which the first stage dirt collection region is closed and an open position in which the first stage dirt collection region is emptiable; and,
      (iii) a second stage air treatment member provided in the air flow path downstream of the first stage air treatment member, the second stage air treatment member comprising a second stage dirt collection region and a second stage openable portion moveable between a closed position in which the second stage dirt collection region is closed and an open position in which the second stage dirt collection region is emptiable
   (b) a docking station for the surface cleaning apparatus, the docking station comprising:
      (i) a docking station air flow path extending from a docking station air inlet to a docking station air outlet; and,
      (ii) a docking station air treatment member provided in the docking station air flow path.
10. The assembly of clause 9 wherein, when the surface cleaning apparatus is docked at the docking station and each of the first stage openable portion and the second stage openable portion are in the open position, the docking station air flow path comprises a first portion that extends downstream from the first door and a second portion that extends downstream from the second door and the second portion merges with the first portion.
11. The assembly of clause 9 wherein, during an evacuation cyclone, the first stage openable portion and the second stage openable portion are concurrently openable.
12. The assembly of clause 11 wherein, when the surface cleaning apparatus is docked at the docking station and each of the first stage openable portion and the second stage openable portion are in the open position, the docking station air flow path comprises a first portion that extends downstream from the first door and a second portion that extends downstream from the second door and the second portion merges with the first portion.
13. The assembly of clause 9 wherein, during an evacuation cyclone, wherein the first stage openable portion and the second stage openable portion are sequentially openable.
14. The assembly of clause 13 wherein, when the surface cleaning apparatus is docked at the docking station and each of the first stage openable portion and the second stage openable portion are in the open position, the docking station air flow path comprises a first portion that extends downstream from the first door and a second portion that extends downstream from the second door and the second portion merges with the first portion.
15. The assembly of clause 9 wherein the first stage air treatment chamber comprises a first stage cyclone and the second stage air treatment chamber comprises a second stage cyclone.
16. The assembly of clause 15 further comprising a pre-motor filter downstream of the second stage cyclone.
17. The assembly of clause 9 further comprising a pre-motor filter downstream of the second stage air treatment chamber.
18. The assembly of clause 9 wherein the first stage openable portion and the second stage openable portion are provided on a common side of the surface cleaning apparatus.

### Clause Set I

1. A hand vacuum cleaner having a front end and a rear end and a longitudinal axis extending between the front and rear ends, the hand vacuum cleaner comprising:
   (a) an air flow passage extending from a dirty air inlet to a clean air outlet wherein a suction motor is provided in the air flow passage;
   (b) an air treatment chamber provided in the air flow path, the air treatment chamber having an air treatment chamber air inlet, an air treatment chamber air outlet and a dirt outlet, and
   (c) a dirt collection chamber exterior to the air treatment chamber and the dirt outlet connects the air treatment chamber in communication with the dirt collection chamber, wherein the dirt collection chamber extends rearwardly from the air treatment chamber.
2. The hand vacuum cleaner of clause 1 wherein a plane that is transverse to the longitudinal axis extends through the dirt collection chamber and the suction motor.
3. The hand vacuum cleaner of clause 1 wherein, in operation, the hand vacuum cleaner further comprises a filter media downstream of the air treatment chamber, wherein a plane that is transverse to the longitudinal axis extends through the dirt collection chamber and the filter media.
4. The hand vacuum cleaner of clause 1 further comprising a pre-motor filter housing which, in operation, houses a pre-motor filter media that is positioned downstream of the air treatment chamber, wherein a first plane that is transverse to the longitudinal axis extends through the dirt collection chamber and the pre-motor filter media.
5. The hand vacuum cleaner of clause 4 wherein a second plane that is transverse to the longitudinal axis plane, and which is positioned rearward of the first plane, extends through the suction motor.
6. The hand vacuum cleaner of clause 1 wherein, in operation, the hand vacuum cleaner further comprises a post-motor filter media downstream of the air treatment chamber, wherein a plane that is transverse to the longitudinal axis extends through the dirt collection chamber and the post-motor filter media.
7. The hand vacuum cleaner of clause 6 wherein the plane also extends through the suction motor.
8. The hand vacuum cleaner of clause 1 further comprising a main body and a rotatable housing rotatably mounted to the main body about a rotational axis, the rotatable housing comprising the air treatment chamber and the dirt collection chamber, wherein the rotatable housing is moveable between an in use position in which the air treatment chamber is closed and an emptying position in which the air treatment chamber is open.
9. The hand vacuum cleaner of clause 8 wherein the hand vacuum cleaner further comprises a pre-motor filter housing which, in operation, houses a pre-motor filter media that is positioned downstream of the air treatment chamber, wherein the pre-motor filter housing is opened when the rotatable housing is in the emptying position.
10. The hand vacuum cleaner of clause 9 wherein the pre-motor filter media is moved with the rotatable housing, a first end of the rotatable housing having an open end of the air treatment chamber when the rotatable housing is in the emptying position and a second end of the rotatable housing longitudinally spaced from the first end of the rotatable housing having the pre-motor filter media when the rotatable housing is in the emptying position.
11. The hand vacuum cleaner of clause 10 wherein, when the rotatable housing is in emptying position, the first end is located on one side of the rotational axis and the second end is located on an opposite side of the rotational axis.
12. The hand vacuum cleaner of clause 1 wherein an outer perimeter of the dirt collection chamber in a plane transverse to the longitudinal axis is arcuate.
13. The hand vacuum cleaner of clause 1 wherein the dirt collection chamber is spaced from the air treatment chamber air outlet in a direction transverse to the longitudinal axis.

### Clause Set J

1. A surface cleaning apparatus comprising:
   (a) an air flow passage extending from a dirty air inlet to a clean air outlet wherein a suction motor is provided in the air flow passage; and,
   (b) an air treatment assembly comprising an air treatment chamber and dirt collection chamber exterior to the air treatment chamber, the air treatment chamber is provided in the air flow path and comprises an air treatment chamber air inlet, an air treatment chamber air outlet at an outlet end of the air treatment chamber and a dirt outlet, wherein the dirt outlet connects the air treatment chamber in communication with the dirt collection chamber,
   wherein, the air treatment assembly comprises an openable portion that is moveable between a closed position in which the surface cleaning apparatus is useable to clean a surface and an open position in which the air treatment assembly is emptiable, and
   wherein at least a portion of a wall defining a portion of the dirt outlet is made of flexible material, and
   wherein, in operation to clean a surface, dirt travels through the dirt outlet from the air treatment chamber to the dirt collection chamber in a direction, and when the openable portion is moved to the open position, a cross-sectional area of the dirt outlet in a plane transverse to the direction is increased.
2. The surface cleaning apparatus of clause 1 wherein the flexible material is elastomeric.
3. The surface cleaning apparatus of clause 1 wherein the flexible material is folded over itself.
4. The surface cleaning apparatus of clause 3 wherein the flexible material is elastomeric.
5. The surface cleaning apparatus of clause 1 wherein the air treatment assembly has a stationary portion and the openable portion is moveably mounted to the stationary portion at the outlet end of the air treatment chamber.
6. The surface cleaning apparatus of clause 1 wherein the portion of a wall defining a portion of the dirt outlet is made of a dual wall structure having first and second wall portions that overlie each other and a plane that is parallel to the direction extends through the first and second wall portions, wherein, when the openable portion is moved to the open position, part of the first wall portion is moved away from part of the second wall portion.
7. The surface cleaning apparatus of clause 6 wherein the first wall portion is part of a wall of the air treatment chamber and the second wall portion is part of a wall of the dirt collection chamber.
8. The surface cleaning apparatus of clause 7 wherein the first and second wall portions are hinged together at the dirt outlet.
9. The surface cleaning apparatus of clause 8 wherein the first and second wall portions comprise an integrally formed flexible material.
10. The surface cleaning apparatus of clause 9 wherein the flexible material is elastomeric.
11. A surface cleaning apparatus comprising:
   (a) an air flow passage extending from a dirty air inlet to a clean air outlet wherein a suction motor is provided in the air flow passage; and,
   (b) an air treatment assembly comprising an air treatment chamber and dirt collection chamber exterior to the air treatment chamber, the air treatment chamber is provided in the air flow path and comprises an air treatment chamber air inlet, an air treatment chamber air outlet at an outlet end of the air treatment chamber and a dirt outlet, wherein the dirt outlet connects the air treatment chamber in communication with the dirt collection chamber,
   wherein, the air treatment assembly comprises an openable portion that is moveable between a closed position in which the surface cleaning apparatus is useable to clean a surface and an open position in which the air treatment assembly is emptiable, and
   wherein, in operation to clean a surface, dirt travels through the dirt outlet from the air treatment chamber to the dirt collection chamber in a direction, and at least a portion of a wall defining a portion of the dirt outlet is made of a dual wall structure having first and second wall portions that overlie each other and a plane that is parallel to the direction extends through the first and second wall portions, and
   wherein, when the openable portion is moved to the open position, part of the first wall portion is moved away from part of the second wall portion.
12. The surface cleaning apparatus of clause 11 wherein the first wall portion is part of a wall of the air treatment chamber and the second wall portion is part of a wall of the dirt collection chamber.
13. The surface cleaning apparatus of clause 12 wherein the first and second wall portions are hinged together at the dirt outlet.
14. The surface cleaning apparatus of clause 13 wherein the first and second wall portions comprise an integrally formed flexible material.
15. The surface cleaning apparatus of clause 14 wherein the flexible material is elastomeric.

### Clause Set K

1. A hand vacuum cleaner having an upper end, a lower end, a front end and a rear end, the hand vacuum cleaner comprising:
   (a) an air flow passage extending from a dirty air inlet provided on the front end of the hand vacuum cleaner to a clean air outlet positioned rearward of the dirty air inlet, wherein a suction motor is provided in the air flow passage; and,
   (b) an air treatment assembly provided in the air flow passage, the air treatment assembly comprising an air treatment chamber, a dirt collection region and an openable portion which is moveable between a closed position in which the surface cleaning apparatus is operable to clean a surface and an open position in which the dirt collection region is emptiable; and,
   (c) a lock assembly operable between a locked position in which the openable portion is secured in the closed position and an unlocked position in which the openable portion is openable, the lock assembly comprising first and second engagement members and an actuator, wherein the actuator is provided on a forward facing portion of the front end.
2. The hand vacuum cleaner of clause 1 wherein the actuator is operably connected to at least one of the first and second engagement members, the actuator is operable between a locked position in which the first and second engagement members inter-engage and an unlocked position in which the first and second engagement members are disengaged from each other and the actuator moves rearwardly from the locked position to the unlocked position.
3. The hand vacuum cleaner of clause 2 wherein the lock assembly further comprises a biasing member which biases the actuator to the unlocked position.
4. The hand vacuum cleaner of clause 3 wherein the lock assembly further comprises a mechanical driving member which is rearwardly moveable when the actuator moves from the locked position to the unlocked position.
5. The hand vacuum cleaner of clause 3 wherein the actuator comprises a push button.
6. The hand vacuum cleaner of clause 1 wherein the front end comprises a front wall and the actuator is provided on the front wall.
7. The hand vacuum cleaner of clause 6 wherein the actuator is operably connected to at least one of the first and second engagement members, the actuator is operable between a locked position in which the first and second engagement members inter-engage and an unlocked position in which the first and second engagement members are disengaged from each other and the actuator moves rearwardly from the locked position to the unlocked position.
8. The hand vacuum cleaner of clause 7 wherein the lock assembly further comprises a biasing member which biases the actuator to the unlocked position.
9. The hand vacuum cleaner of clause 8 wherein the lock assembly further comprises a mechanical driving member which is rearwardly moveable when the actuator moves from the locked position to the unlocked position.
10. The hand vacuum cleaner of clause 8 wherein the actuator comprises a push button.
11. The hand vacuum cleaner of clause 1 further comprising a handle provided on the lower end of the hand vacuum cleaner and the openable portion comprises a lower end of the air treatment air treatment assembly and the openable portion has a rear end having a pivot mount.
12. An assembly comprising:
   (a) hand vacuum cleaner having an upper end, a lower end, a front end and a rear end, the hand vacuum cleaner comprising:
      (i) an air flow passage extending from a dirty air inlet provided on the front end of the hand vacuum cleaner to a clean air outlet positioned rearward of the dirty air inlet, wherein a suction motor is provided in the air flow passage;
      (ii) an air treatment assembly provided in the air flow passage, the air treatment assembly comprising an air treatment chamber, a dirt collection region and an openable portion which is moveable between a closed position in which the surface cleaning apparatus is operable to clean a surface an open position in which the dirt collection region is emptiable; and,
      (iii) a lock assembly operable between a locked position in which the openable portion is secured in the closed position and an unlocked position in which the openable portion is openable, the lock assembly comprising first and second engagement members and an actuator which is moveable between a locked position and an unlocked position, wherein the actuator is provided on a forward facing portion of the front end,
   (b) a docking station for the surface cleaning apparatus, the docking station comprising:
      (i) a docking station air flow path extending from a docking station air inlet to a docking station air outlet; and,
      (ii) a docking station air treatment member provided in the docking station air flow path,
   wherein the docking station has an upwardly extending lock engaging member whereby, when the hand vacuum cleaner is moved in a downward direction to dock at the docking station, the lock engaging member engages the actuator and moves the actuator to the unlocked position.
13. The hand vacuum cleaner of clause 12 wherein the actuator moves rearwardly from the locked position to the unlocked position.
14. The hand vacuum cleaner of clause 13 wherein the lock assembly further comprises a biasing member which biases the actuator to the unlocked position.
15. The hand vacuum cleaner of clause 14 wherein the lock assembly further comprises a mechanical driving member which is rearwardly moveable when the actuator moves from the locked position to the unlocked position.
16. The hand vacuum cleaner of clause 14 wherein the actuator comprises a push button.
17. The hand vacuum cleaner of clause 12 wherein the front end comprises a front wall and the actuator is provided on the front wall.
18. The hand vacuum cleaner of clause 17 wherein the actuator moves rearwardly from the locked position to the unlocked position.
19. The hand vacuum cleaner of clause 18 wherein the lock assembly further comprises a biasing member which biases the actuator to the unlocked position.
20. The hand vacuum cleaner of clause 19 wherein the lock assembly further comprises a mechanical driving member which is rearwardly moveable when the actuator moves from the locked position to the unlocked position.
21. The hand vacuum cleaner of clause 19 wherein the actuator comprises a push button.
22. The hand vacuum cleaner of clause 12 further comprising a handle provided on the lower end of the hand vacuum cleaner and the openable portion comprises a lower end of the air treatment air treatment assembly and the openable portion has a rear end having a pivot mount.

### Clause Set L

1. A hand vacuum cleaner comprising:
   (a) an air flow passage extending from a dirty air inlet provided on the front end of the hand vacuum cleaner to a clean air outlet positioned rearward of the dirty air inlet, wherein a suction motor is provided in the air flow passage;
   (b) an air treatment assembly comprising an air treatment chamber, the air treatment chamber comprising a front end, a rear end comprising a rear end wall, an air treatment chamber air inlet, an air treatment chamber air outlet provided at the rear end of the air treatment chamber in the rear end wall, and an air treatment chamber axis extending between the front and rear ends of the air treatment chamber, wherein the air treatment chamber air outlet comprises a porous member that extends into the air treatment chamber from the rear end wall;
   wherein the air treatment assembly comprises an openable portion that is moveable between a closed position in which the hand vacuum cleaner is operable to clean a surface and an open position in which a dirt collection region of the air treatment assembly is emptiable, and
   wherein the porous member is moveable between an operating position in which the openable portion is closed and the hand vacuum cleaner is operable to clean a surface and a porous member cleaning position in the porous member is moved from its operating position, and
   wherein the openable portion moves a greater distance as it moves to its open position than a distance that the porous member travels as it moves to the porous member cleaning position.
2. The hand vacuum cleaner of clause 1 wherein the openable portion and the porous member are each rotatable about a rotational mount and the openable portion rotates a greater rotational angle as it moves to its open position than the rotational angle that the porous member travels as it moves to the porous member cleaning position.
3. The hand vacuum cleaner of clause 2 wherein the rotational mounts are provided at the rear end of the air treatment chamber.
4. The hand vacuum cleaner of clause 2 wherein a plane that is transverse to the air treatment chamber axis extends through both of the rotational mounts.
5. The hand vacuum cleaner of clause 1 wherein the openable portion is U-shaped in a plane that extends transverse to the air treatment chamber axis.
6. The hand vacuum cleaner of clause 1 further comprising a wiper that travels over at least a portion of the porous member as the openable portion moves from its closed position to its open position.
7. The hand vacuum cleaner of clause 6 wherein the wiper is arcuate in shape.
8. The hand vacuum cleaner of clause 6 wherein the wiper is an annular member having an open interior and the porous member is located radially inwardly of the annular member.
9. The hand vacuum cleaner of clause 7 wherein the wiper is part of the rear end wall.
10. A surface cleaning apparatus comprising:
   (a) an air flow passage extending from a dirty air inlet to a clean air outlet wherein a suction motor is provided in the air flow passage;
   (b) an air treatment assembly comprising an air treatment chamber, the air treatment chamber comprising a first end, an axially opposed second end comprising a second end wall, an air treatment chamber air inlet, an air treatment chamber air outlet provided at the second end of the air treatment chamber in the second end wall, and an air treatment chamber axis extending between the first and second ends of the air treatment chamber, wherein the air treatment chamber air outlet comprises a porous member that extends into the air treatment chamber from the second end wall;
   wherein the air treatment assembly comprises an openable portion that is moveable between a closed position in which the surface cleaning apparatus is operable to clean a surface and an open position in which a dirt collection region of the air treatment assembly is emptiable, and
   wherein the porous member is moveable between an operating position in which the openable portion is closed and the surface cleaning apparatus is operable to clean a surface and a porous member cleaning position in which the porous member is moved from its operating position, and
   wherein the openable portion moves a greater distance as it moves to its open position than a distance that the porous member travels as it moves to the porous member cleaning position.
11. The surface cleaning apparatus of clause 10 wherein the openable portion and the porous member are each rotatable about a rotational mount and the openable portion rotates a greater rotational angle as it moves to its open position than the rotational angle that the porous member travels as it moves to the porous member cleaning position.
12. The surface cleaning apparatus of clause 11 wherein the rotational mounts are provided at the second end of the air treatment chamber.
13. The surface cleaning apparatus of clause 12 wherein a plane that is transverse to the air treatment chamber axis extends through both of the rotational mounts.
14. The surface cleaning apparatus of clause 12 wherein the openable portion is U-shaped in a plane that extends transverse to the air treatment chamber axis.
15. The surface cleaning apparatus of clause 10 further comprising a wiper that travels over at least a portion of the porous member as the openable portion moves from its closed position to its open position.
16. The surface cleaning apparatus of clause 15 wherein the wiper is arcuate in shape.
17. The surface cleaning apparatus of clause 15 wherein the wiper is an annular member having an open interior and the porous member is located radially inwardly of the annular member.
18. The surface cleaning apparatus of clause 16 wherein the wiper is part of the rear end wall.

1. A surface cleaning apparatus comprising:
(a) a surface cleaning mode air flow path extending from a dirty air inlet to a clean air outlet with a suction motor and an air treatment member provided in the air flow path, wherein the surface cleaning mode air flow path comprises a downstream portion that extends from the air treatment member to the suction motor, the downstream portion including a downstream port;
(b) an evacuation air flow path comprising a first portion extending from an ambient air inlet port to an evacuation air outlet and a second portion extending from a docking station return air inlet port to the clean air outlet; and,
(c) a valve assembly operable to concurrently open the ambient air inlet port and the docking station return air inlet port and also concurrently close the downstream port, the valve assembly comprising a first valve member that is moveable between a first valve member surface cleaning mode position in which the first valve member closes the docking station return air inlet port and the downstream port is open and a first valve member evacuation mode position in which the first valve member closes the downstream port and the docking station return air inlet port is open,
wherein the surface cleaning apparatus is operable in a surface cleaning mode wherein air travels from the dirty air inlet, through the downstream port to the clean air outlet, and,
wherein, when the surface cleaning apparatus is docked at a docking station, the surface cleaning apparatus is operable in an evacuation mode wherein air enters through the ambient air inlet port, travels through the docking station and subsequently enters the surface cleaning apparatus through the docking station return air inlet port.

2. The surface cleaning apparatus of claim 1 further comprising a housing having the ambient air inlet port and the docking station return air inlet port, the downstream portion of the surface cleaning mode air flow path extends through the housing and, when the first valve member is in the first valve member surface cleaning mode position, the first valve member abuts an outer surface of the housing.

3. The surface cleaning apparatus of claim 2 further comprising a second valve member that is moveable between a second valve member surface cleaning mode position in which the ambient air inlet port is closed and a second valve member evacuation mode position in which the ambient air inlet port is open.

4. The surface cleaning apparatus of claim 3 wherein, when the second valve member is in the second valve member surface cleaning mode position, the second valve member abuts an outer surface of the housing.

5. The surface cleaning apparatus of claim 1 further comprising a second valve member that is moveable between a second valve member surface cleaning mode position in which the ambient air inlet port is closed and a second valve member evacuation mode position in which the ambient air inlet port is open and the valve assembly further comprises a single linking member drivingly connecting one of the first and second valve members to the other of the first and second valve members.

6. The surface cleaning apparatus of claim 1 further comprising a second valve member that is moveable between a second valve member surface cleaning mode position, in which the ambient air inlet port is closed, and a second valve member evacuation mode position, in which the ambient air inlet port is open, and the valve assembly further comprises a linking member drivingly connecting one of the first and second valve members to the other of the first and second valve members, wherein, in operation in the surface cleaning mode, air flows in a direction through a section of the air flow path having the first and second valve members and the linking member extends generally transverse to the direction.

7. The surface cleaning apparatus of claim 1 wherein the surface cleaning apparatus is a hand vacuum cleaner having a front end having the dirty air inlet and the clean air outlet is positioned rearward of the dirty air inlet and the hand vacuum cleaner further comprises a second valve member that is moveable between a second valve member surface cleaning mode position, in which the ambient air inlet port is closed, and a second valve member evacuation mode position, in which the ambient air inlet port is open, and the valve assembly further comprises a linking member drivingly connecting one of the first and second valve members to the other of the first and second valve members, and the linking member extends generally transverse to a forward/rearward direction.

8. The surface cleaning apparatus of claim 1 further comprising a pre-motor filter and the ambient air inlet port and the docking station return air inlet port are positioned downstream of the pre-motor filter.

9. The surface cleaning apparatus of claim 1 wherein each of the first and second valve members is pivotally mounted to the surface cleaning apparatus, the first valve member pivots in an opening direction when the first valve member moves from the first valve member surface cleaning mode position to the first valve member evacuation mode position, and the second valve member moves in a direction common with the opening direction when the second valve member moves from the second valve member surface cleaning mode position to the second valve member evacuation mode position.

10. A surface cleaning apparatus comprising:
(a) a surface cleaning mode air flow path extending from a dirty air inlet to a clean air outlet with a suction motor and an air treatment member provided in the air flow path, wherein the surface cleaning mode air flow path comprises a downstream portion that extends from the air treatment member to the suction motor;
(b) an evacuation air flow path comprising a first portion extending from an ambient air inlet port to an evacuation air outlet and a second portion extending from a docking station return air inlet port to the clean air outlet; and,
(c) a valve assembly operable to concurrently open an ambient air inlet port and a docking station return air inlet port, the valve assembly comprising:
(i) a first valve member the is moveable between a surface cleaning mode position in which the docking station return air inlet port is closed and an evacuation mode position in which the docking station return air inlet port is open; and,
(ii) a second valve member that is moveable between a surface cleaning mode position in which the ambient air inlet port is closed and an evacuation mode position in which the ambient air inlet port is open,
wherein, in operation, when the ambient air inlet port is closed and the docking station return air inlet port is closed and air is travelling through a section of the downstream portion which includes the valve assembly, air flows in a direction through the section and a plane that is transverse to the direction extends through the first valve member and the second valve member.

11. The surface cleaning apparatus of claim 10 further comprising a housing having the ambient air inlet port and the docking station return air inlet port, the downstream portion of the surface cleaning mode air flow path extends through the housing and, when the first valve member is in the first valve member surface cleaning mode position, the first valve member abuts an outer surface of the housing.

12. The surface cleaning apparatus of claim 11 wherein, when the second valve member is in the second valve member surface cleaning mode position, the second valve member abuts an outer surface of the housing.

13. The surface cleaning apparatus of claim 10 wherein the valve assembly further comprises a single linking member drivingly connecting one of the first and second valve members to the other of the first and second valve members.

14. The surface cleaning apparatus of claim 10 wherein the valve assembly further comprises a linking member drivingly connecting one of the first and second valve members to the other of the first and second valve members, wherein, in operation in the surface cleaning mode, air flows in a direction through a section of the air flow path having the first and second valve members and the linking member extends generally transverse to the direction.

15. The surface cleaning apparatus of claim 10 wherein the surface cleaning apparatus is a hand vacuum cleaner having a front end having the dirty air inlet and the clean air outlet is positioned rearward of the dirty air inlet, and the valve assembly further comprises a linking member drivingly connecting one of the first and second valve members to the other of the first and second valve members, and the linking member extends generally transverse to a forward/rearward direction.

16. The surface cleaning apparatus of claim 10 further comprising a pre-motor filter and the ambient air inlet port and the docking station return air inlet port are positioned downstream of the pre-motor filter.

17. The surface cleaning apparatus of claim 1 wherein each of the first and second valve members is pivotally mounted to the surface cleaning apparatus, the first valve member pivots in an opening direction when the first valve member moves from the first valve member surface cleaning mode position to the first valve member evacuation mode position, and the second valve member moves in a direction common with the opening direction when the second valve member moves from the second valve member surface cleaning mode position to the second valve member evacuation mode position.

18. A surface cleaning apparatus comprising:
(a) a surface cleaning mode air flow path extending from a dirty air inlet to a clean air outlet with a suction motor and an air treatment member provided in the air flow path, wherein the surface cleaning mode air flow path comprises a downstream portion that extends from the air treatment member to the suction motor;
(b) an evacuation air flow path comprising a first portion extending from an ambient air inlet port to an evacuation air outlet and a second portion extending from a docking station return air inlet port to the clean air outlet; and,
(c) a valve assembly operable to concurrently open an ambient air inlet port and a docking station return air inlet port, the valve assembly comprising:
(i) a first valve member that is moveable between a surface cleaning mode position in which the docking station return air inlet port is closed and an evacuation mode position in which the docking station return air inlet port is open; and,
(ii) a second valve member that is moveable between a surface cleaning mode position in which the ambient air inlet port is closed and an evacuation mode position in which the ambient air inlet port is open,
wherein each of the first and second valve members is pivotally mounted to the surface cleaning apparatus, the first valve member pivots in an opening direction when the first valve member moves from the first valve member surface cleaning mode position to the first valve member evacuation mode position, and the second valve member moves in a direction common with the opening direction when the second valve member moves from the second valve member surface cleaning mode position to the second valve member evacuation mode position.
